(19) United States
(12) Patent Application Publication
(10) Pub. No.: US 2026/0215885 A1
(43) Pub. Date: Jul. 30, 2026

(54) METHODS AND SYSTEMS FOR THE PRODUCTION AND USE OF ORTHODONTIC BRACKET PLACEMENT GUIDES

(71) Applicant: Mark Batesole, Ventura, CA (US)

(72) Inventors: Mark Batesole, Ventura, CA (US); Joseph Caruso, Morro Bay, CA (US); Kitichai Rungcharassaeng, Redlands, CA (US); Gemma Modell Hill, Fullerton, CA (US)

(21) Appl. No.: 19/149,085

(22) PCT Filed: Jan. 17, 2024
(86) PCT No.: PCT/US2024/011883

§ 371 Date: Jul. 17, 2025

Related U.S. Application Data
(60) Provisional application No. 63/480,255, filed on Jan. 17, 2023.

(51) Int. Cl. A61C 7/14; A61C 7/00; B33Y 80/00

(52) U.S. Cl. CPC A61C 7/146; A61C 7/002; B33Y 80/00

(57) ABSTRACT

Disclosed herein are methods of producing a bracket guide, such as an orthodontic bracket guide. The methods may include placing a bracket model on a tooth object of a dentition model, generating a bracket guide foundation volume such that the generating exposes at least a portion of the bracket model, and producing a physical bracket guide based, at least in part, on the bracket guide foundation volume. Also disclosed herein are a computer-readable storage medium comprising program instructions that perform the methods, and a computing system comprising one or more processors and the computer-readable storage medium.

### CROSS-REFERENCE TO RELATED APPLICATIONS

This application claims priority to U.S. Provisional Application No. 63/480,255, filed Jan. 17, 2023, which application is incorporated herein by reference in its entirety.

### TECHNICAL FIELD

The disclosure relates generally to the placement of orthodontic brackets and, more particularly, to embodiments of methods and systems for the production and use of an orthodontic bracket placement guide.

### BACKGROUND

Orthodontic treatment involves movement of misaligned teeth into desired positions in the oral cavity. One common type of orthodontic treatment involves the use of small, slotted orthodontic appliances known as brackets. Such brackets are affixed to a patient's teeth and an archwire is placed in the slot of each bracket. The archwire forms a track to guide movement of the teeth into desired positions. The ends of orthodontic archwires are often connected to small orthodontic appliances known as buccal tubes that are, in turn, secured to the patient's molar teeth. In many instances, a set of brackets, buccal tubes, and an archwire is provided for each of the patient's upper and lower dental arches. The brackets, buccal tubes and archwires are commonly and collectively referred to as a dental appliance (colloquially, “braces”).

Typically, a dental appliance applies forces appropriate to the repositioning of each tooth in the dental arch. A mainstay of orthodontics is the use of wires or elastic bands mounted to brackets adhered to the teeth to apply such forces. The wires or bands apply tensile forces between the brackets, gradually realigning the teeth. Although this method is effective and relatively easy to implement, traditional bracket and wire braces are difficult to clean, are uncomfortable in the patient's mouth, include a long time to install and periodically adjust, and may include a long treatment duration to achieve the desired alignment. The development of three-dimensional (3D) digital imaging has led to some improvements in orthodontics treatments. A mold of the patient's teeth, or the teeth themselves, is imaged to create a 3D digital model. This model may be adjusted using interactive computer software.

Unfortunately, the average force values and bracket positioning often fail to reposition each of the teeth to the averaged ideal position for a variety of reasons, including variation in tooth shape and size relative to the averaged tooth size, improper positioning of the bracket on the tooth, biological variation in tooth movement, and a difference in skeletal structure relative to the average patient. Further, such techniques also encounter difficulties resulting from an inability to visualize the bracket and the manner in which it interfaces with the tooth.

### SUMMARY

Applicants have recognized that accuracy in bracket placement is an essential component in the practice of straightwire orthodontics. Incorrect bracket placement, for example, may lead to marginal ridge discrepancies, undesirable tooth movement, additional stress on the periodontal ligament, increased potential for root resorption, poorer esthetics, and subpar occlusal relationships. With previous studies on indirect bonding (IDB) indicating statistically significant differences in bracket position, Applicants have recognized that it is important to also consider whether a statistical significance represents clinical significance. Accurate bracket placement may be affected by a multitude of factors. These may include tooth shape, malformation, material of transfer tray, bonding agent, clinical environment, patient management, and technique sensitivity, for example. With an increasing number of adult patients receiving orthodontic treatment, attrition is becoming a more common clinical finding in the orthodontic practice. One study, for example, investigated the effect of cusp height differences on bracket placement with IDB performed via computer-aided design/computer-aided manufacturing (CAD/CAM). Maxillary casts were selected without attrition or distinctive cusp tips, but with mild crowding (<3 mm). Models were adjusted to represent normal attrition patterns on posterior teeth, and those with maximum cusp heights. After bracket placement, individual IDB jigs were manufactured using a 3D printing process. Software was then used to superimpose intended and actual bracket positions, and to measure the differences of the best fit in occlusal, buccal, and mesiodistal views. This study found a greater frequency of errors over 0.5 mm and 1 torque in the experimental group with increased cusp heights, concluding that clinically significant errors should be anticipated in IDB systems based on cusp heights. Another study, by Skidmore et al., evaluated the effect on treatment time of the bracket placement technique. On average, one month of additional treatment time was found in patients with bracket placement completed by sight estimation versus those with brackets measured with a height gage, further highlighting the importance of accurate bracket placement.

Many studies utilize standards set by the American Board of Orthodontics (ABO) when discussing accuracy and what it means to be statistically significant versus clinically significant. It is understood that statistical significance may not necessarily represent clinical significance. Some have selected the standards put forth by the Cast Radiograph Evaluation (CR Eval) of 0.5 mm to indicate clinical significance, while others have set a stricter level of clinical significance at 0.13 mm. The 0.13 mm level of clinical significance was determined as a bracket placement discrepancy in opposite directions on adjacent teeth would produce a tooth position discrepancy greater than 0.25 mm. Others have set significance at 0.5 mm for linear measurements in mesiodistal, vertical, and buccolingual dimensions, and 1 for angulation, torque, and rotational errors. Angles less than 2 have been reported as acceptable because that degree of change in crown tip has been shown to produce a 0.5 mm difference in marginal ridge height for average-sized molars. The clinical limit for significance is most often placed at 2 as a result of studies on the threshold of perception of asymmetry in laypersons.

There are many advantages to the use of IDB, including increased patient comfort, decreased chairside time and staff needs, improved control of in-out movements, increased ease of overcorrection, and overall reduction in treatment duration. Decreased patient chair time correlates to decreased stress on the clinician's body, an added benefit to the technique. Studies have shown anywhere from 20 to 30 minutes of reduced total time spent for bonding with IDB versus direct bonding (DB) appointments. One such study, for example, analyzed the amount of time spent for direct and indirect bonding techniques. Although the study showed an increase in overall time spent with IDB when considering additional lab time required, a significantly shorter amount of chair time was required for IDB compared to traditional DB protocols. Reduction in chair time improves patient compliance and limits the potential for contamination by saliva, a common problem encountered with direct bonding. The ability to visualize an entire arch or the mouth without the hindrance of soft tissues and limited space allows for ease of modification of bracket placement and overcorrection of rotations, both of which directly impact success of treatment. Studies on retention have shown that the type of early reorganization of periodontal fibers observed in IDB treatment contributes to a decreased risk of relapse and improved post-treatment stability.

Although there are many advantages to IDB, Applicants have recognized that several drawbacks do exist. First, for example, there is a learning curve involved, especially with the modern, fully digital workflow. As with any learning curve, this technique may initially increase average bonding time, if lab and design time are included in the process. Regardless of clinician experience with IDB, there is additional lab and computer time involved in the process when compared to DB techniques, also increasing cost. Second, for example, some tooth shapes and sizes are not appropriate for IDB, such as those with shorter clinical crowns.

Another disadvantage of the IDB technique relates to excess cement and its removal, for example. There are two stages within the bonding procedure that can influence the potential formation of white spot lesions and periodontal health. First, in preparation for IDB, acid etch is applied to the tooth surface in the region to be bonded. This introduces localized enamel demineralization to allow for the bond between enamel and the resin cement that is applied to the bracket base. One study evaluated plaque accumulation and development of white spot lesions between groups that underwent selective enamel etching using what is known as a “Duran mask” as part of the IDB protocol. The Duran mask can reveal the area that needs to be acid etched where the bracket will be indirectly bonded, thus limiting the area that is demineralized as part of the bonding procedure. Results of this study showed reduced plaque accumulation and decreased evidence of white spot lesion formation. In addition to the acid etch technique, the amount of resin applied to the bracket base must be very exact to avoid excess cement accumulation around the bonded bracket. With traditional IDB trays there is no accessibility to the resin prior to its curing or setting. Excess cement is removed after setting with a carbide finishing bur and scaler, thus negating any chair time that was saved in the process. If the excess cement is not adequately removed, an environment may result that can lead to the deterioration of patient's oral hygiene and increase formation of caries or white spot lesions.

Certain examples include methods of producing a bracket guide. One such method includes the steps of: placing a bracket model on a tooth object of a dentition model; generating a bracket guide foundation volume such that the generating exposes at least a portion of the bracket model; and producing a physical bracket guide based, at least in part, on the bracket guide foundation volume. In some examples, the step of generating the bracket guide foundation volume includes generating a gingival surface of the bracket guide foundation volume, and generating an occlusal surface of the bracket guide foundation volume. The method can also include the step of producing a manifold dentition model. This step of producing of the manifold dentition model can include rectifying one or more non-manifold features. In certain examples, the step of generating of the gingival surface is based, at least in part, on the dentition model. The gingival surface can be situated between a peak occlusal point of the tooth object and a base of the dentition model. The step of generating the occlusal surface can be based, at least in part, on the dentition model. The occlusal surface can be situated between the gingival surface and the peak occlusal point of the tooth object. In certain examples, the gingival surface can lie between the base of the dentition model and a gumline of the dentition model. The method can further include a step wherein the generating exposes the at least a portion of the bracket model by virtue of the generating the bracket guide foundation volume comprising removing a bracket model volume from the bracket guide foundation volume. The bracket model volume is representative of a volume of the bracket model. The method can further include a step of generating an inflated dentition model, wherein the generating of the inflated dentition model at least in part comprises performance of an inflation operation on the dentition model. The method can further include a step of identifying the tooth object; and placing a facial axis marker on a facial surface of the tooth object. The step of placing the facial axis marker can include determining a facial axis of the tooth object; determining a facial axis point for the tooth object using the facial axis; locating a facial axis marker at the facial axis point; and aligning and orientation of the facial axis marker with the facial surface of the tooth object. The step of the placing the facial axis marker can include manually adjusting a position of the facial axis marker. In some examples, the bracket model comprises a bracket model copy and the step of producing the physical bracket guide includes using a three-dimensional printing process.

Certain examples include non-transitory computer-readable storage media, containing program instructions, which, when executed by one or more processors of a computing system, perform the methods described herein. For example, the method performed can include placing a bracket model on a tooth object of a dentition model; generating a bracket guide foundation volume such that the generating exposes at least a portion of the bracket model; and producing a physical bracket guide based, at least in part, on the bracket guide foundation volume. The method performed further can include generating a bracket guide using the bracket guide foundation volume, wherein generating the bracket guide produces a bracket guide volume, the physical bracket guide is produced based, at least in part, on the bracket guide volume, and the bracket guide volume comprises the bracket guide foundation volume. The method performed further can include generating the bracket guide foundation volume that includes defining a bracket guide foundation volume. Defining the bracket guide foundation volume can include generating a gingival surface of the bracket guide foundation volume, and generating an occlusal surface of the bracket guide foundation volume. The gingival surface can be generated based, at least in part, on the dentition model. The gingival surface can be situated between a peak occlusal point of the tooth object and a base of the dentition model. The occlusal surface can be generated based, at least in part, on the dentition model. The occlusal surface can be situated between the gingival surface and the peak occlusal point of the tooth object. The method performed can further include producing a manifold dentition model. Producing of the manifold dentition model can include rectifying one or more non-manifold features, wherein the bracket model is a bracket model copy, and the physical bracket guide is produced using a three-dimensional printing process. The gingival surface can lie between the base of the dentition model and a gumline of the dentition model. The method performed can further the step of generating exposes the at least the portion of the bracket model by virtue of generating the bracket guide foundation volume. This step involves removing a bracket model volume from the bracket guide foundation volume, wherein the bracket model volume is representative of a volume of the bracket model. The method performed can further include the step of generating an inflated dentition model at least in part comprising performance of an inflation operation on the dentition model. The method performed can further include the step of identifying the tooth object; and placing a facial axis marker on a facial surface of the tooth object. The step of placing the facial axis marker can further include determining a facial axis of the tooth object; determining a facial axis point for the tooth object using the facial axis; locating a facial axis marker at the facial axis point; and aligning and orientation of the facial axis marker with the facial surface of the tooth object. The step of placing the facial axis marker can further include manually adjusting a position of the facial axis marker.

Certain examples include computing systems with one or more processors; and computer-readable storage media coupled to the one or more processors. The computer-readable storage media contains program instructions, which, when executed by the one or more processors, perform the methods described herein. For example, the method performed can include placing a bracket model on a tooth object of a dentition model, generating a bracket guide foundation volume such that the generating exposes at least a portion of the bracket model, and producing a physical bracket guide based, at least in part, on the bracket guide foundation volume. The method performed further can include generating a bracket guide using the bracket guide foundation volume, wherein the generating the bracket guide produces a bracket guide volume, the physical bracket guide is produced based, at least in part, on the bracket guide volume, and the bracket guide volume comprises the bracket guide foundation volume. The method performed further can include the generating the bracket guide foundation volume. This step of defining the bracket guide foundation volume can include generating a gingival surface of the bracket guide foundation volume, and generating an occlusal surface of the bracket guide foundation volume. The gingival surface can be generated based, at least in part, on the dentition model. The gingival surface can be situated between a peak occlusal point of the tooth object and a base of the dentition model. The occlusal surface can be generated based, at least in part, on the dentition model. The occlusal surface can be situated between the gingival surface and the peak occlusal point of the tooth object. The method performed can include producing a manifold dentition model. Producing of the manifold dentition model can include rectifying one or more non-manifold features. In some examples, the bracket model is a bracket model copy. In some examples, the physical bracket guide is produced using a three-dimensional printing process. In some examples, the gingival surface lies between the base of the dentition model and a gumline of the dentition model. The method performed can include the step of generating that exposes the at least the portion of the bracket model by virtue of the generating the bracket guide foundation volume. Generating the bracket guide foundation volume can include removing a bracket model volume from the bracket guide foundation volume. In some examples, the bracket model volume is representative of a volume of the bracket model. The method performed can include the step of generating that further includes generating an inflated dentition model. In some examples, the step of generating the inflated dentition model at least in part includes performance of an inflation operation on the dentition model. In some examples, the step of generating can include identifying the tooth object; and placing a facial axis marker on a facial surface of the tooth object. Placing the facial axis marker can include determining a facial axis of the tooth object; determining a facial axis point for the tooth object using the facial axis; locating a facial axis marker at the facial axis point; and aligning and orientation of the facial axis marker with the facial surface of the tooth object. Placing the facial axis marker can include manually adjusting a position of the facial axis marker.

In view of the foregoing, and as illustrated in FIGS. 1-43 and as described herein, embodiments of a bracket placement guide according to embodiments of methods and systems such as those described herein may increase accuracy of physical bracket placement, provide greater access to the physical brackets during placement, reduce excess adhesive, provide a more comfortable experience for the patient, or provide other such advantages.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies, generally, the figure in which the reference number first appears. The same reference numbers in different figures indicate similar or identical items.

FIG. 1A is a simplified flow diagram illustrating an example of a bracket guide production process, according to an embodiment of methods and systems such as those disclosed herein.

FIG. 1B is a graphical diagram illustrating an example of a dental mesh, according to an embodiment of methods and systems such as those disclosed herein.

FIG. 1C is a graphical diagram illustrating an example of a manifold dentition model, according to an embodiment of methods and systems such as those disclosed herein.

FIG. 1D is a simplified flow diagram illustrating an example of a bracket guide generation process, according to an embodiment of methods and systems such as those disclosed herein.

FIG. 2 is a simplified flow diagram illustrating an example of a bracket model set placement process, according to an embodiment of methods and systems such as those disclosed herein.

FIG. 3A is a simplified flow diagram illustrating an example of a facial axis marker placement process, according to an embodiment of methods and systems such as those disclosed herein.

FIG. 3B is a graphical diagram illustrating examples of the location of facial axes and facial axis points, according to an embodiment of methods and systems such as those disclosed herein.

FIG. 3C is a graphical diagram illustrating an example of the location of facial axis markers on tooth objects of a dentition model, according to an embodiment of methods and systems such as those disclosed herein.

FIG. 3D is a graphical diagram illustrating an example of the alignment of the facial axis markers' respective orientation on the facial surfaces of the tooth objects, according to an embodiment of methods and systems such as those disclosed herein.

FIG. 4A is a simplified flow diagram illustrating an example of a bracket model copy placement process, according to an embodiment of methods and systems such as those disclosed herein.

FIG. 4B is a graphical diagram illustrating a side view of an example of a bracket model (along an axis parallel to that of an archwire, not shown), according to an embodiment of methods and systems such as those disclosed herein.

FIG. 4C is a graphical diagram illustrating a bottom view of an example of a bracket model, according to an embodiment of methods and systems such as those disclosed herein.

FIG. 4D is a graphical diagram illustrating a facial view of an example of a bracket model, according to an embodiment of methods and systems such as those disclosed herein.

FIG. 4E is a graphical diagram illustrating an example of bracket model copies after having been moved into location with respect to the tooth objects, according to an embodiment of methods and systems such as those disclosed herein.

FIG. 4F is a graphical diagram illustrating an example of bracket model copies after having been moved into location with respect to the tooth objects, in greater detail, according to an embodiment of methods and systems such as those disclosed herein.

FIG. 4G is a graphical diagram illustrating the bracket model copies depicted in FIG. 4F after having been adapted to the tooth objects, according to an embodiment of methods and systems such as those disclosed herein.

FIG. 4H is a graphical diagram illustrating an example of bracket model copies after having been adapted to the tooth objects, according to an embodiment of methods and systems such as those disclosed herein.

FIG. 5 is a simplified flow diagram illustrating an example of a bracket guide foundation generation process, according to an embodiment of methods and systems such as those disclosed herein.

FIG. 6 is a simplified flow diagram illustrating an example of a bracket guide foundation volume definition process, according to an embodiment of methods and systems such as those disclosed herein.

FIG. 7A is a simplified flow diagram illustrating an example of a gingival surface generation process, according to an embodiment of methods and systems such as those disclosed herein.

FIG. 7B is a graphical diagram illustrating an example of a gingival path, according to an embodiment of methods and systems such as those disclosed herein.

FIG. 8 is a simplified flow diagram illustrating an example of an occlusal surface generation process, according to an embodiment of methods and systems such as those disclosed herein.

FIG. 9 is a simplified flow diagram illustrating an example of an element determination process, according to an embodiment of methods and systems such as those disclosed herein.

FIG. 10A is a simplified flow diagram illustrating an example of a bracket base volume generation process, according to an embodiment of methods and systems such as those disclosed herein.

FIG. 10B is a graphical diagram illustrating an example of a bracket model outline, according to an embodiment of methods and systems such as those disclosed herein.

FIG. 11A is a simplified flow diagram illustrating an example of a subtractive operations process, according to an embodiment of methods and systems such as those disclosed herein.

FIG. 11B is a graphical diagram illustrating an example of a bracket guide volume after the subtractive operations process of FIG. 11A has been performed, according to an embodiment of methods and systems such as those disclosed herein.

FIG. 12 is a simplified flow diagram illustrating an example of an additive operations process, according to an embodiment of methods and systems such as those disclosed herein.

FIG. 13A is a simplified flow diagram illustrating an example of a rest generation process, according to an embodiment of methods and systems such as those disclosed herein.

FIG. 13B is a graphical diagram illustrating an example of a posterior bracket guide rest profile, according to an embodiment of methods and systems such as those disclosed herein.

FIG. 13C is a graphical diagram illustrating an example of an anterior bracket guide rest profile, according to an embodiment of methods and systems such as those disclosed herein.

FIG. 13D is a graphical diagram illustrating an example of positioned bracket guide rest profiles, according to an embodiment of methods and systems such as those disclosed herein.

FIG. 13E is a graphical diagram illustrating an example of a positioned posterior bracket guide rest profile, in greater detail, according to an embodiment of methods and systems such as those disclosed herein.

FIG. 13F is a graphical diagram illustrating an example of positioned bracket guide rest volumes after extrusion of the respective bracket guide profiles and their addition to the bracket guide foundation volume, according to an embodiment of methods and systems such as those disclosed herein.

FIG. 14A is a simplified flow diagram illustrating an example of a cut generation process, according to an embodiment of methods and systems such as those disclosed herein.

FIG. 14B is a graphical diagram illustrating an example of cuts and loops generated by the process of FIG. 14A, according to an embodiment of methods and systems such as those disclosed herein.

FIG. 15A is a graphical diagram illustrating an example of a digital representation of a bracket guide with bracket model copies and manifold dentition mesh, according to an embodiment of methods and systems such as those disclosed herein.

FIG. 15B is a graphical diagram illustrating an example of a digital representation of a bracket guide, according to an embodiment of methods and systems such as those disclosed herein.

FIG. 15C is an image illustrating an example of a physical bracket guide, according to an embodiment of methods and systems such as those disclosed herein.

FIG. 16 is a simplified block diagram illustrating an example of a machine learning model generation training architecture, according to an embodiment of methods and systems such as those disclosed herein.

FIG. 17 is a simplified diagram illustrating an example of a ranking system, according to an embodiment of methods and systems such as those disclosed herein.

FIG. 18 is a simplified diagram illustrating an example of a higher-order ranking system, according to an embodiment of methods and systems such as those disclosed herein.

FIG. 19 is a simplified block diagram illustrating an example of a machine learning architecture, according to an embodiment of methods and systems such as those disclosed herein.

FIGS. 20, 21A, 21B, 22A, 22B, 23A-23C, 24A, and 24B are graphical diagrams illustrating examples of various stages of the generation of a digital representation of a bracket guide, according to an embodiment of methods and systems such as those disclosed herein.

FIGS. 25A, 25B, 26A, and 26B are images illustrating examples of physical bracket guides produced using a digital representation of a bracket guide such as that depicted in FIGS. 20, 21A, 21B, 22A, 22B, 23A-23C, 24A, and 24B, according to an embodiment of methods and systems such as those disclosed herein.

FIGS. 27-35, 36A, 36B, 37, 38A, 38B, 39, and 40 are graphical user interface reproductions illustrating examples of various analyses performed in an example implementation of a digital representation of a bracket guide such as that depicted in FIGS. 20, 21A, 21B, 22A, 22B, 23A-23C, 24A, and 24B, according to an embodiment of methods and systems such as those disclosed herein.

FIGS. 41A-41B are images illustrating examples of physical bracket guides produced using a digital representation of a bracket guide such as that depicted in FIGS. 20, 21A, 21B, 22A, 22B, 23A-23C, 24A, and 24B, according to an embodiment of methods and systems such as those disclosed herein.

FIG. 42 is a block diagram depicting a computer system suitable for implementing aspects of systems according to embodiments of systems such as those disclosed herein.

FIG. 43 is a block diagram depicting a network architecture suitable for implementing aspects of systems according to embodiments of systems such as those disclosed herein.

While embodiments such as those presented in the application are susceptible to various modifications and alternative forms, specific embodiments are provided as examples in the drawings and description of example embodiments. The drawings and description of example embodiments are not intended to limit the embodiments to the particular form disclosed. Instead, the intention is to cover modifications, equivalents and alternatives falling within the spirit and scope of embodiments of methods and systems such as those described herein, as defined by the appended claims.

### DETAILED DESCRIPTION

The following is intended to provide a detailed description of examples of methods and systems of the disclosure and should not be taken to be limiting in and of itself. Rather, any number of variations may fall within the scope of the embodiments of methods and systems of the disclosure, which is defined in the claims following the detailed description.

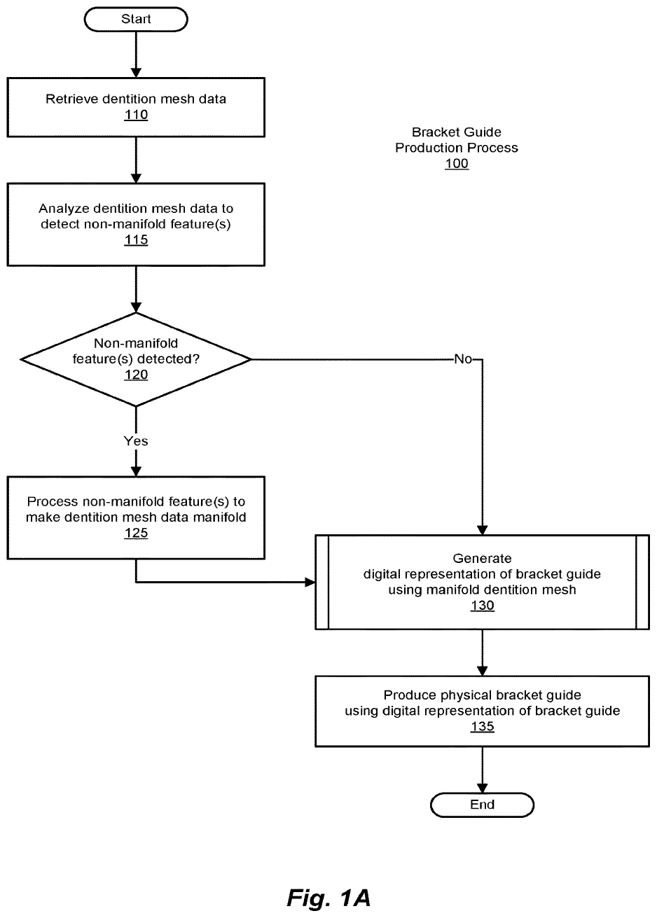

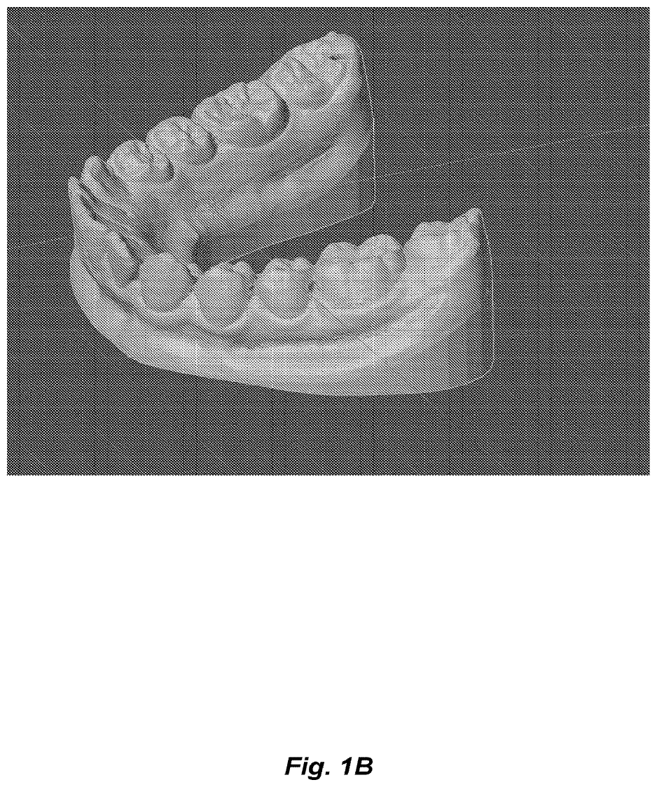

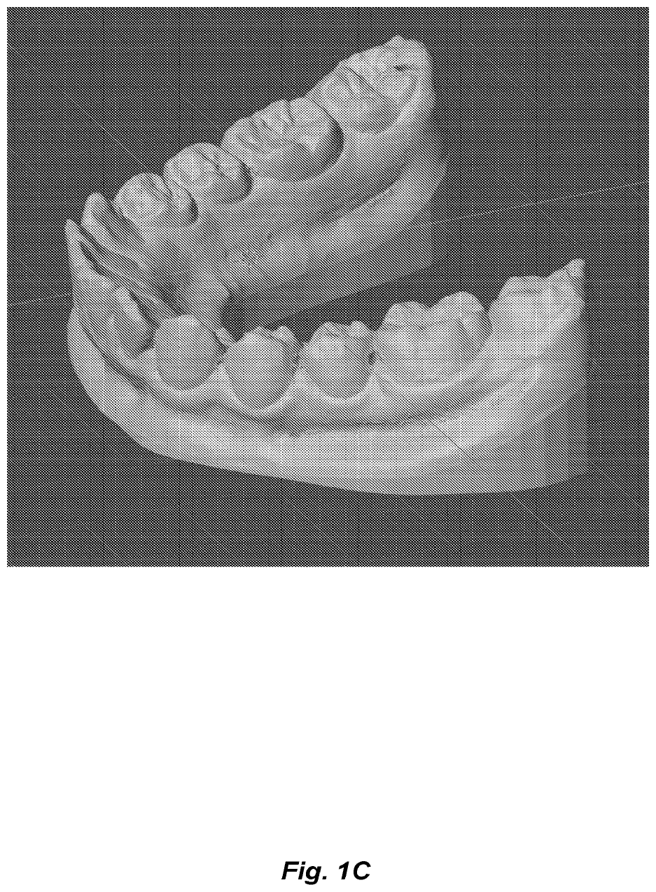

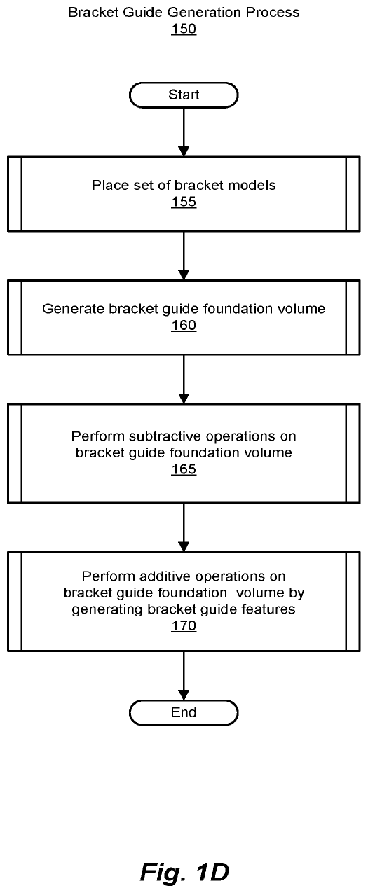

As illustrated in FIGS. 1-43, as described herein, and as will be understood by those skilled in the art upon reading the present disclosure, embodiments of methods and systems, such as those described herein, provide the ability to generate an orthodontic bracket placement guide (or more simply, a “bracket guide”), produce a physical bracket guide by use of the bracket placement guide (in practical terms, its volume), or use such a physical bracket guide in the placement of physical orthodontic brackets (again, more simply, “physical brackets”) in a clinical setting.

In view of the foregoing, and as illustrated in FIGS. 1-43 and as described herein, embodiments of a bracket placement guide according to embodiments of methods and systems such as those described herein may increase accuracy of physical bracket placement, provide greater access to the physical brackets during placement, reduce excess adhesive, provide a more comfortable experience for the patient, and provide other such advantages. In the clinical example discussed subsequently herein, a sample group of 30 unique mandibular dental models exhibiting various degrees of crowding were used. Models have previously been digitized, anonymized, and separated into groups based on the amount of crowding present. Brackets were digitally placed, and bonding guides were designed using a customized plug-in module in open-source Blender software (Blender Foundation, Amsterdam, Netherlands, version 3.0.1) as will be understood by those skilled in the art. Bonding guides and experimental models were printed using HeyGears UltraCraft DS 3D printer (HeyGears™, Guangzhou, China) with HeyGears UltraPrint-Dental Model HP UV 2.0 resin material (where “HP” is high-precision, and “UV” is ultraviolet), as will be understood by those skilled in the art. It is to be appreciated that such materials are presented only as examples, including with regard to the 3D ranking process described. Other additives and/or subtractive production methodologies may be employed in embodiments to equally good effect, and as such, are contemplated by the present disclosure. The bonding procedure was completed on each model using the bracket positioning guide. Bonded models were scanned and digitized using a TRIOS™ Intraoral Scanner (3Shape™, Copenhagen, Denmark) and imported into Geomagic™ Wrap software (3D Systems™, Rockhill, South Carolina) for analysis, as will be understood by those skilled in the art. Digitized experimental models were superimposed using one or more best fit algorithms, as will be understood by those skilled in the art, on the original digital model with the intended bracket placement. Bracket positions were analyzed for linear and angular discrepancies in the x-, y-, and z-axes. Statistical analysis was performed using Wilcoxon signed-rank and Kruskal-Wallis tests, and Dwass-Steel-Critchlow-Fligner pairwise comparisons (α=0.05) to assess for statistically significant differences between the control and experimental bracket positions, as will be understood by those skilled in the art.

In these examples, a total of 402 brackets were analyzed. Statistically significant differences were found between the control and experimental bracket positions in the linear dimension (p<0.05). In contrast, no statistically significant differences were noted in the angular dimension (p>0.05). Arch length discrepancy (ALD) did not significantly impact the bonding accuracy (p>0.05), except in the facial-lingual dimension (p=0.014). In the angular dimension, mean torque discrepancy was predominantly impacted by tooth type, with molars being observed to have the highest mean angular discrepancy. No mean discrepancies in both linear and angular dimensions were of clinical significance.

As described herein and as recognized by Applicants, accurate bracket placement can be achieved with the use of embodiments of a physical bracket guide produced from a bracket guide generated according to embodiments of methods and systems such as those described herein. While the discrepancy is greatest in the facial-lingual dimension and torque, bracket positions are still clinically acceptable, as will be understood by those skilled in the art. Dental crowding and tooth type were not observed to have a clinically significant impact on bonding accuracy. Thus, embodiments of methods and systems such as those described herein are able to address various problems encountered in the placement of physical brackets.

### Bracket Guide Production

Embodiments of the present disclosure can be implemented as software, hardware, or a combination thereof. For purposes of this disclosure, an embodiment of an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be or include a personal computer (for example, desktop or laptop), tablet computer, mobile device (for example, personal digital assistant (PDA) or smart phone), server (for example, blade server or rack server), a network storage device, or any other suitable device and may vary in size, shape, performance, functionality, and price. The IHS also may include random access memory (RAM), one or more processing resources such as a central processing unit (CPU) or hardware or software control logic, read-only memory (ROM), and/or other types of nonvolatile memory. Additional components of the IHS may include one or more disk drives, one or more network ports for communicating with external devices as well as various input and output (I/O) devices, such as a keyboard, a mouse, touchscreen and/or video display. The IHS further may include one or more buses operable to transmit communications between the various hardware components. The present disclosure is further intended to comprehend software for use in three-dimensional, intra-oral scanning devices, whether as resident software, software on associated computing device(s), or otherwise.

FIG. 1A is a simplified flow diagram illustrating an example of a bracket guide production process, according to embodiments of methods and systems such as those disclosed herein. FIG. 1A thus depicts an embodiment of a bracket guide production process 100. Bracket guide production process 100 begins with the retrieval of dentition mesh data (110), as will be understood by those skilled in the art. Such mesh data can be captured using processes such as those described elsewhere herein. As will be appreciated, the capture of such mesh data may include features that result in non-manifold structures. To address this possibility, embodiments of methods and systems such as those described herein can perform analysis of dentition mesh data to detect non-manifold feature(s) (115). Bracket guide production process 100, having performed such analysis, then proceeds with a determination as to whether one or more non-manifold features have been detected (120).

As used herein, a mesh (for example, a dental mesh) is a structure representing a 3D object. Such a mesh includes some number of vertices, which are representations of a point in x-y-z space. Each vertex can be connected to another vertex by a structure referred to as an edge. Multiple contiguous edges can be connected to form a face. In a triangulated mesh, for example, each face is connected to three vertices and three edges.

As also used herein, a non-manifold mesh is a mesh representing a structure which cannot exist in the real world and, therefore, cannot be produced (for example, as by 3D printing). For example, when viewed in a two-dimensional (2D) plane, a mesh in which one face is floating in space relative to other faces (for example, a face does not share an edge with another face or the like) is treated as being non-manifold. As will be appreciated by those skilled in the art, such non-manifold features can be “cured” in a number of ways, in order to produce a manifold structure.

If one or more non-manifold features are detected in bracket guide production process 100, bracket guide production process 100 processes such non-manifold feature(s), in order to make dentition mesh data, manifold (125). Such a dentition mesh, whether originally manifold or processed to be manifold, is referred to herein as a manifold dentition mesh. This manifold dentition mesh can then be used to generate a digital representation of the bracket guide desired (130). A more detailed discussion of such a process is provided in connection with the example process presented in FIG. 1D, subsequently.

Once generated, as will be understood by those skilled in the art, this digital representation can be used to produce a physical bracket guide (135). To this end, it will be appreciated that the digital representation of the bracket guide, in certain embodiments, flows from a volume from which certain features are removed (also referred to herein as being subtracted) and to which certain elements are included (also referred to herein as being added). However, it is to be further appreciated that the removal of a portion of the digital representation and the addition of a space in the digital representation accomplish the same end. The physical guide having been produced, bracket guide generation process 150 concludes, or otherwise looped back to the beginning of the process to produce another or additional bracket guides, for example. As will be appreciated in light of the present disclosure, the iterative process depicted in FIG. 1A merely is illustrative, and meant only to capture concepts related to the production of a single physical bracket guide, and as such, is intended only as an example embodiment. In practice, a number of such physical bracket guides can be created, and in fact, created concurrently (although such production can be performed serially, as in the manner shown (for example, as by a single user)).

It will be appreciated that, in light of the present disclosure, variable identifiers such as “N” or “M” may be used in various instances in various of the figures herein to simply designate the final element of a series of related or similar elements. The repeated use of such variable identifiers is not meant to necessarily imply any sort of correlation between the number of elements in such series. The use of variable identifiers of this sort in no way is intended to (and does not) require that each series of elements have the same number of elements as another series delimited by the same variable identifier. Rather, in each instance of use, variables thus identified may represent the same or a different value than other instances of the same variable identifier.

Further, in light of the present disclosure, it will be appreciated that storage devices such as those described herein can be implemented by any type of computer-readable storage medium, including, but not limited to, internal or external hard disk drives (HDD), optical drives (for example, compact disk read (CD-R), compact disk read/write (CD-RW), digital video disc readable (DVD-R), digital video disc read/write (DVD-RW), and the like), flash memory drives (for example, universal serial bus (USB) memory sticks and the like), tape drives, removable storage in a robot or standalone drive, cloud storage, other remote system storage, and the like. Alternatively, it will also be appreciated that, in light of the present disclosure, such systems can include other components such as routers, firewalls, load balancers, and the like that are not germane to the discussion of the present disclosure and will not be discussed further herein. It also will be appreciated that other configurations are possible.

As will be appreciated in light of the present disclosure, processes according to concepts embodied by systems such as those described herein include one or more operations, which may be performed in any appropriate order. It is appreciated that operations discussed herein may include directly entered commands by a computer system user or by steps executed by application specific hardware modules, but the disclosed embodiments also includes steps executed by software modules, for example, as will be understood by those skilled in the art. The functionality of steps referred to herein may correspond to the functionality of modules or portions of modules.

The operations referred to herein may be modules or portions of modules (for example, software, firmware, or hardware modules). For example, although the described embodiments may include software modules and/or includes manually entered user commands, the various example modules may be application specific hardware modules. The software modules discussed herein also may include script, batch or other executable files, or combinations and/or portions of such files. The software modules further may include a computer program or subroutines thereof encoded on computer-readable storage media, as will be understood by those skilled in the art.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, those skilled in the art will recognize that the operations described in example embodiment are for illustration only. Operations may be combined, or the functionality of the operations may be distributed in additional operations, in accordance with this disclosure.

Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like, as will be understood by those skilled in the art.

Each of the blocks of the flow diagram also may be executed by a module (for example, a software module) or a portion of a module or a computer system user using, for example, a computer system. Thus, in the above-described embodiment of a process or method, the operations thereof and modules therefor may be executed on a computer system configured to execute the operations of the embodiments of the process or the method and/or may be executed from computer-readable storage media. Embodiments of the process or the method also may be embodied in a machine-readable and/or computer-readable storage medium for configuring a computer system to execute the method. Thus, the software modules may be stored within and/or transmitted to a computer system memory to configure the computer system to perform the functions of the module, for example.

Such a computer system normally processes information according to a program (a list of internally stored instructions such as a particular application program and/or an operating system) and produces resultant output information via input/output devices. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, and so on) may sometimes be described as being performed by the parent process. This is intended to include subordinate processes spawned during the operation of the parent process serving as a feedback providing functionality including self-correction, operator alerts (such as for the need for operator decisions), and other such functionality.

Such a computer system typically includes multiple computer processes executing “concurrently.” Often, a computer system includes a single processing unit which is capable of supporting many active processes alternately. Although multiple processes may appear to be executing concurrently, at any given point in time only one process is actually executed by the single processing unit. By rapidly changing the process executing, a computer system gives the appearance of concurrent process execution. The ability of a computer system to multiplex the computer system's resources among multiple processes in various stages of execution is called multitasking. Systems with multiple processing units, which by definition can support true concurrent processing, are called multiprocessing systems. Active processes are often referred to as executing concurrently when such processes are executed in a multitasking and/or a multiprocessing environment. With regard to the servers described in connection with FIG. 1A and the potential of distributed processing, there exists the potential for employing distributed, multiple servers to achieve computational concurrency.

The software modules described herein, for example, may be received by such a computer system, for example, from computer readable storage media. The computer readable storage media may be permanently, removably or remotely coupled to the computer system. The computer readable storage media may non-exclusively include, for example, any number of the following: non-transitory computer-readable storage media such as magnetic storage media including disk and tape storage media, optical storage media such as compact disk (CD) media (for example, CD-ROM, compact disk record (CD-R), or other such media) and digital video disk storage media, nonvolatile memory storage memory including semiconductor-based memory units such as electrically-erasable programmable read-only-memory (EEPROM), erasable programmable read-only memory (EPROM), read-only memory (ROM) or application specific integrated circuits (ASICs); and other such computer-readable storage media. Such computer-readable storage media can also include, for example, volatile storage media including registers, buffers or caches, main memory, random-access memory (RAM), and the like; and other such computer-readable storage media. In a UNIX-based embodiment, the software modules may be embodied in a file, which may be a device, a terminal, a local or remote file, or other such devices. Further, other new and various types of computer-readable storage media may be used to store the software modules discussed herein, as will be understood by those skilled in the art.

Certain examples include non-transitory computer-readable storage media, containing program instructions, which, when executed by one or more processors of a computing system, perform the methods described herein. For example, the method performed can include placing a bracket model on a tooth object of a dentition model; generating a bracket guide foundation volume such that the generating exposes at least a portion of the bracket model; and producing a physical bracket guide based, at least in part, on the bracket guide foundation volume. The method performed further can include generating a bracket guide using the bracket guide foundation volume, wherein generating the bracket guide produces a bracket guide volume, the physical bracket guide is produced based, at least in part, on the bracket guide volume, and the bracket guide volume comprises the bracket guide foundation volume. The method performed further can include generating the bracket guide foundation volume that includes defining a bracket guide foundation volume. Defining the bracket guide foundation volume can include generating a gingival surface of the bracket guide foundation volume, and generating an occlusal surface of the bracket guide foundation volume. The gingival surface can be generated based, at least in part, on the dentition model. The gingival surface can be situated between a peak occlusal point of the tooth object and a base of the dentition model. The occlusal surface can be generated based, at least in part, on the dentition model. The occlusal surface can be situated between the gingival surface and the peak occlusal point of the tooth object. The method performed can further include producing a manifold dentition model. Producing of the manifold dentition model can include rectifying one or more non-manifold features, wherein the bracket model is a bracket model copy, and the physical bracket guide is produced using a three-dimensional printing process. The gingival surface can lie between the base of the dentition model and a gumline of the dentition model. The method performed can further the step of generating exposes the at least the portion of the bracket model by virtue of generating the bracket guide foundation volume. This step involves removing a bracket model volume from the bracket guide foundation volume, wherein the bracket model volume is representative of a volume of the bracket model. The method performed can further include the step of generating an inflated dentition model at least in part comprising performance of an inflation operation on the dentition model. The method performed can further include the step of identifying the tooth object; and placing a facial axis marker on a facial surface of the tooth object. The step of placing the facial axis marker can further include determining a facial axis of the tooth object; determining a facial axis point for the tooth object using the facial axis; locating a facial axis marker at the facial axis point; and aligning and orientation of the facial axis marker with the facial surface of the tooth object. The step of placing the facial axis marker can further include manually adjusting a position of the facial axis marker.

FIG. 1B is a graphical diagram illustrating an example of a dental mesh, according to embodiments of methods and systems such as those disclosed herein. Data representing this dental mesh can be loaded, for example, from a digital file stored on a storage device such as is described elsewhere herein. Such a dental mesh can be used as the basis for producing a physical bracket guide according to embodiments of methods and systems such as those described herein, and as such is referred to herein as a dentition model. As noted, however, such a dental mesh may include one or more non-manifold features, which, in certain embodiments, can prove problematic (for example, with respect to volumetric calculations and other processing, as may be necessary and appropriate to producing a physical bracket guide). As noted, if such is the case, operations such as those described in connection with bracket guide production process 100 can be performed to rectify such issues.

FIG. 1C is a graphical diagram illustrating an example of a manifold dentition model, according to embodiments of methods and systems such as those disclosed herein. Whether in its original form, or as result of the operations just noted, an embodiment of a manifold dentition model such as that depicted in FIG. 1C serves to address the issues that a non-manifold mesh can create, as noted above.

Certain examples include methods of producing a bracket guide. One such method includes the steps of: placing a bracket model on a tooth object of a dentition model; generating a bracket guide foundation volume such that the generating exposes at least a portion of the bracket model; and producing a physical bracket guide based, at least in part, on the bracket guide foundation volume. In some examples, the step of generating the bracket guide foundation volume includes generating a gingival surface of the bracket guide foundation volume, and generating an occlusal surface of the bracket guide foundation volume. The method can also include the step of producing a manifold dentition model. This step of producing of the manifold dentition model can include rectifying one or more non-manifold features. In certain examples, the step of generating of the gingival surface is based, at least in part, on the dentition model. The gingival surface can be situated between a peak occlusal point of the tooth object and a base of the dentition model. The step of generating the occlusal surface can be based, at least in part, on the dentition model. The occlusal surface can be situated between the gingival surface and the peak occlusal point of the tooth object. In certain examples, the gingival surface can lie between the base of the dentition model and a gumline of the dentition model. The method can further include a step wherein the generating exposes the at least a portion of the bracket model by virtue of the generating the bracket guide foundation volume comprising removing a bracket model volume from the bracket guide foundation volume. The bracket model volume is representative of a volume of the bracket model. The method can further include a step of generating an inflated dentition model, wherein the generating of the inflated dentition model at least in part comprises performance of an inflation operation on the dentition model. The method can further include a step of identifying the tooth object; and placing a facial axis marker on a facial surface of the tooth object. The step of placing the facial axis marker can include determining a facial axis of the tooth object; determining a facial axis point for the tooth object using the facial axis; locating a facial axis marker at the facial axis point; and aligning and orientation of the facial axis marker with the facial surface of the tooth object. The step of the placing the facial axis marker can include manually adjusting a position of the facial axis marker. In some examples, the bracket model comprises a bracket model copy and the step of producing the physical bracket guide includes using a three-dimensional printing process.

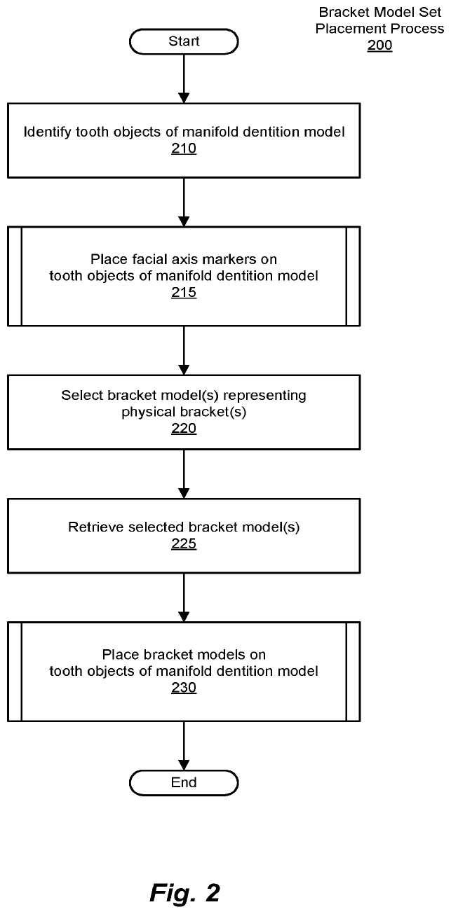

FIG. 1D is a simplified flow diagram illustrating an example of a bracket guide generation process, according to embodiments of methods and systems such as those disclosed herein. Here, a bracket guide generation process 150 generates the aforementioned digital representation of a physical bracket guide. In certain embodiments, bracket guide generation process 150 begins with the placement of a set of bracket models (155). A more detailed discussion of such a bracket model set placement process is provided in connection with the example process presented in FIG. 2, subsequently. Although this need not be the case, and the brackets of the bracket model set placed, for example, as part of the generation of the bracket guide foundation, performing certain of the operations associated with the placement of the bracket model set can provide computational efficiency as a result of certain determinations having been made, the results of such determinations thereby being readily available for subsequent use.

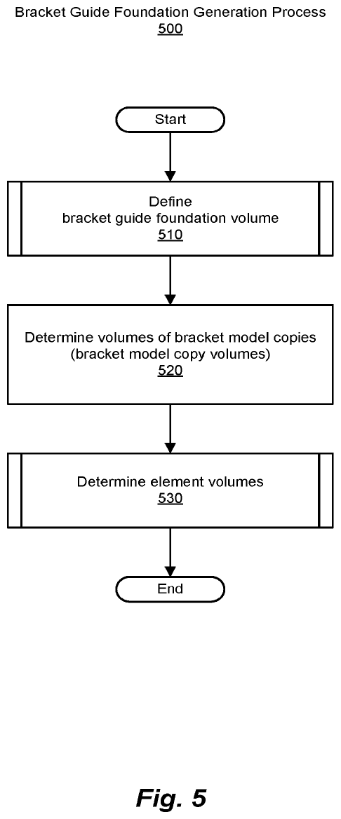

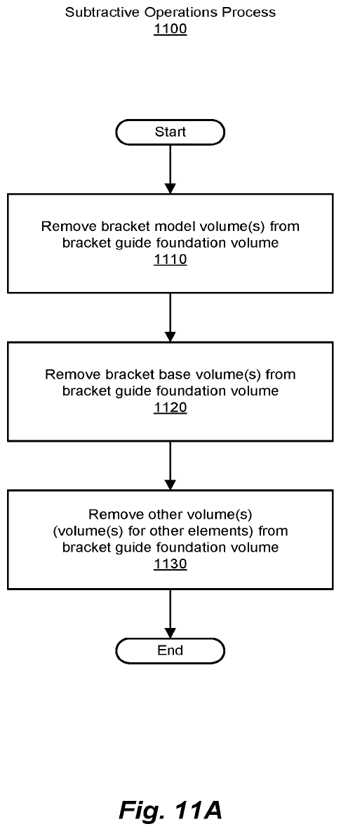

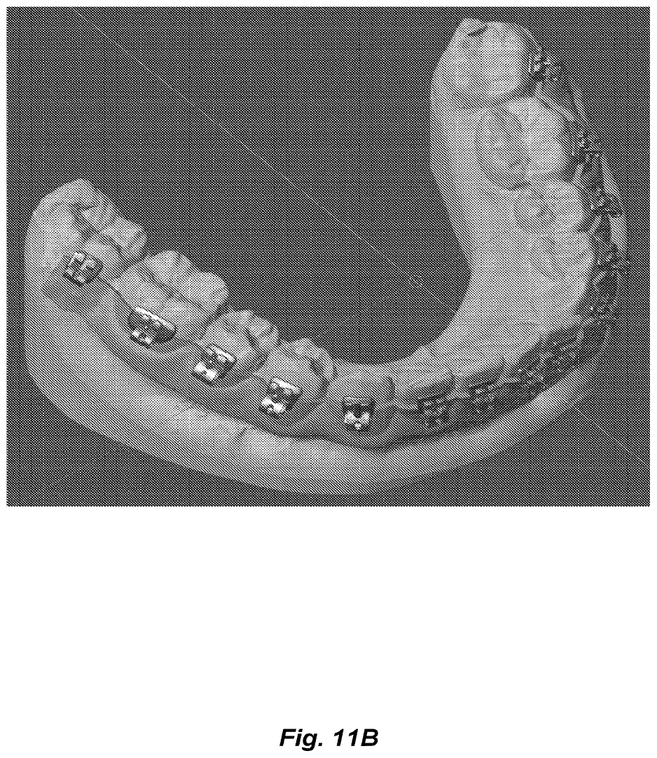

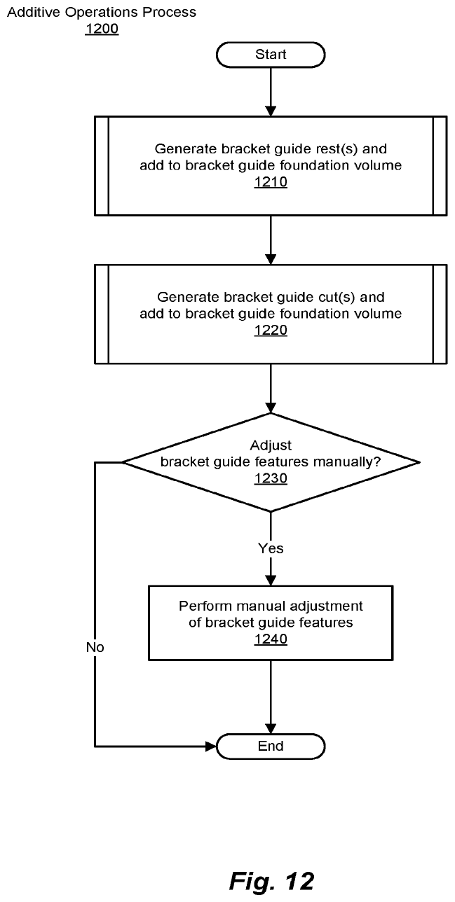

Next, bracket guide generation process 150 generates the bracket guide's bracket guide foundation volume (160). A more detailed discussion of such a bracket guide foundation volume generation process is provided in connection with the example process presented in FIG. 5, subsequently. Once the bracket guide foundation is generated, subtractive operations are performed on the bracket guide foundation volume (165). A more detailed discussion of such subtractive operations is provided in connection with the example process presented in FIG. 11A, subsequently. Similarly, one or more additive operations are performed on bracket guide foundation volume by generating bracket guide features (170). A more detailed discussion of such additive operations is provided in connection with the example process presented in FIG. 12, subsequently. Thus, as noted, by performing subtractive and/or additives operations on the bracket guide foundation volume, a volume for the digital representation of the bracket guide can be produced. As also noted, the subtractive and additive operations contemplated by the present disclosure are relative to the features, elements, and other modifications made to the bracket guide foundation volume, in that such removal and inclusion can comprehend both material and voids, either of which can be removed or included. Bracket guide generation process 150 then concludes, or may be looped or returned to the start process to produce additional bracket guides sequentially (as well as in parallel), as will be understood by those skilled in the art.

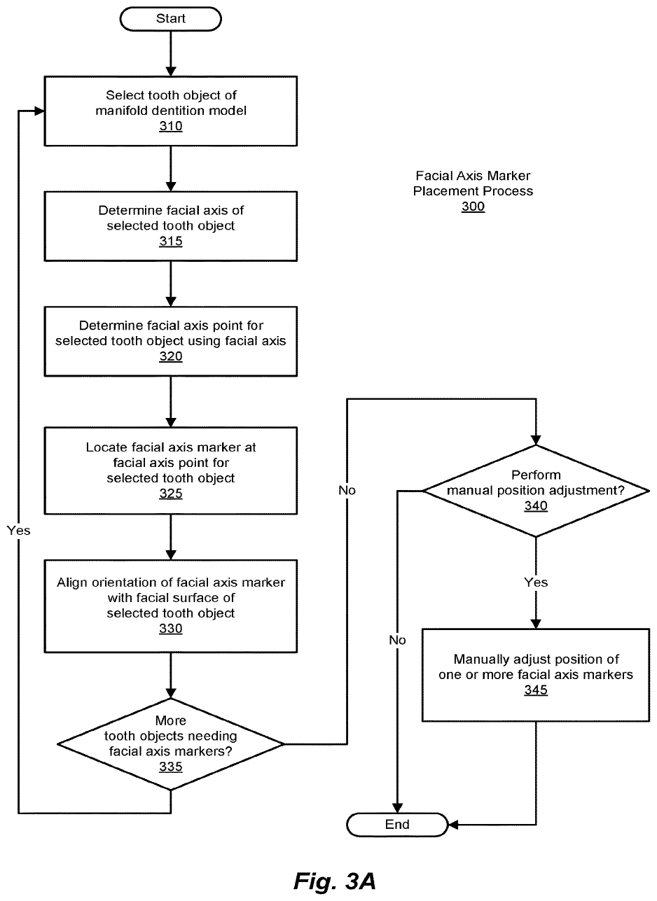

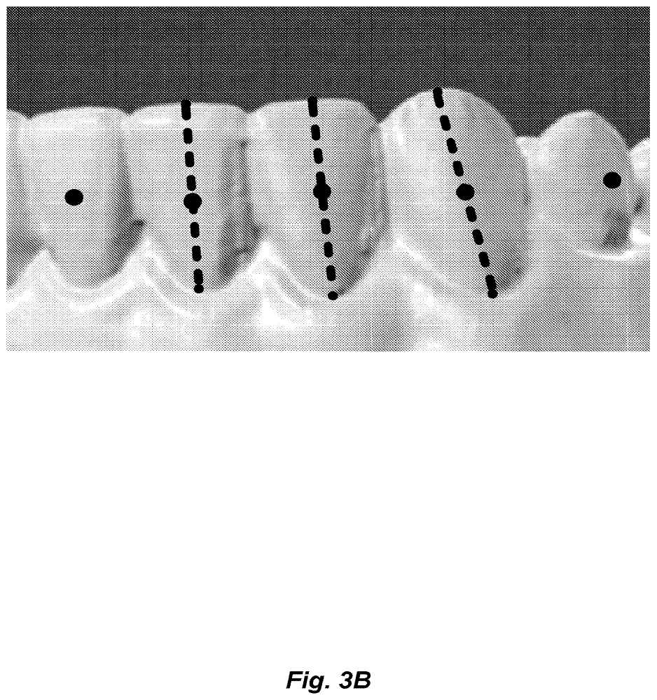

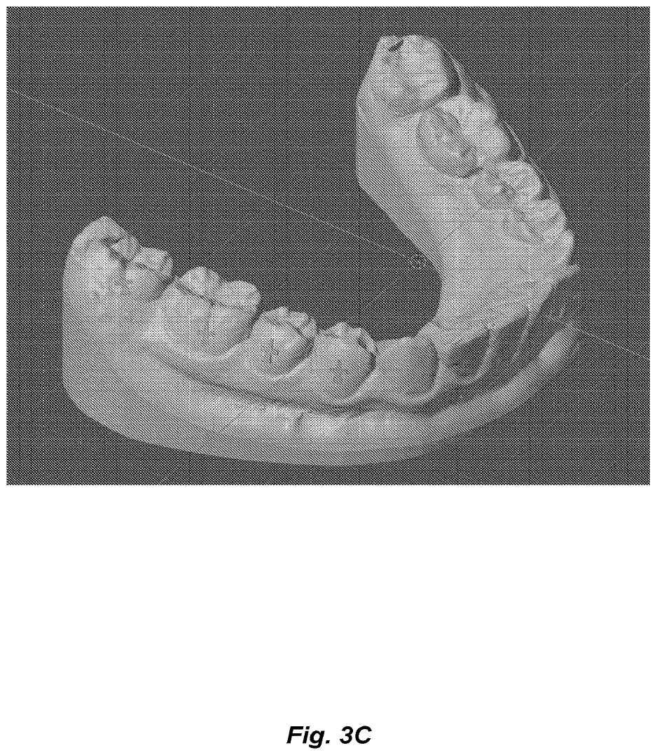

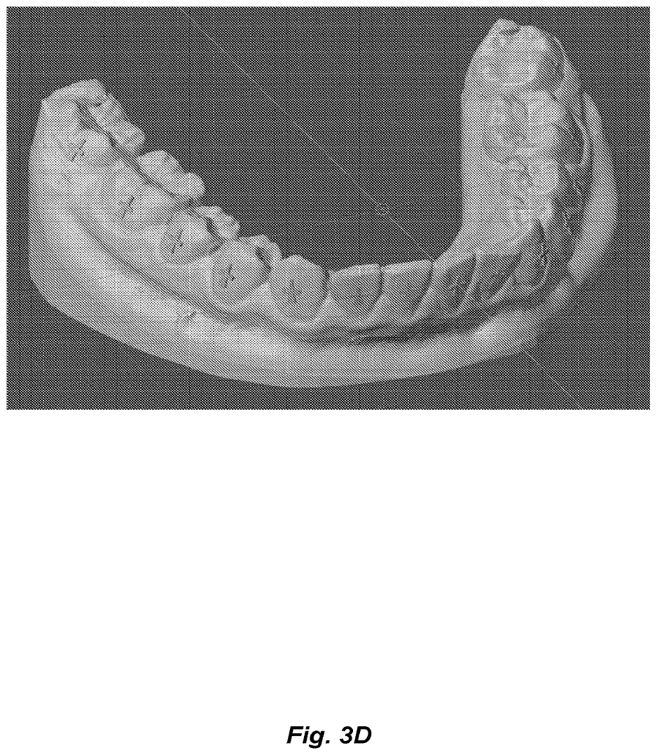

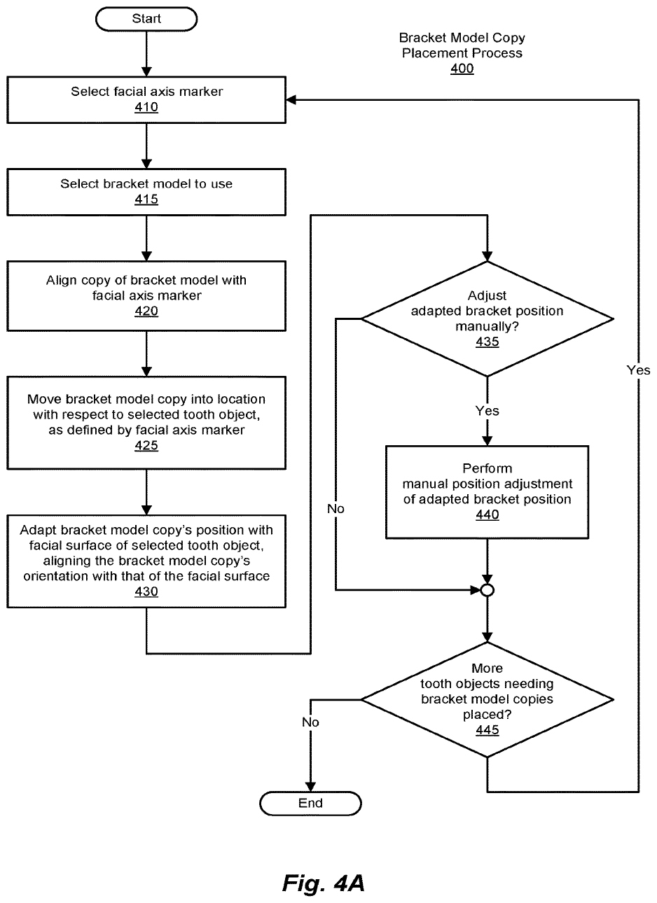

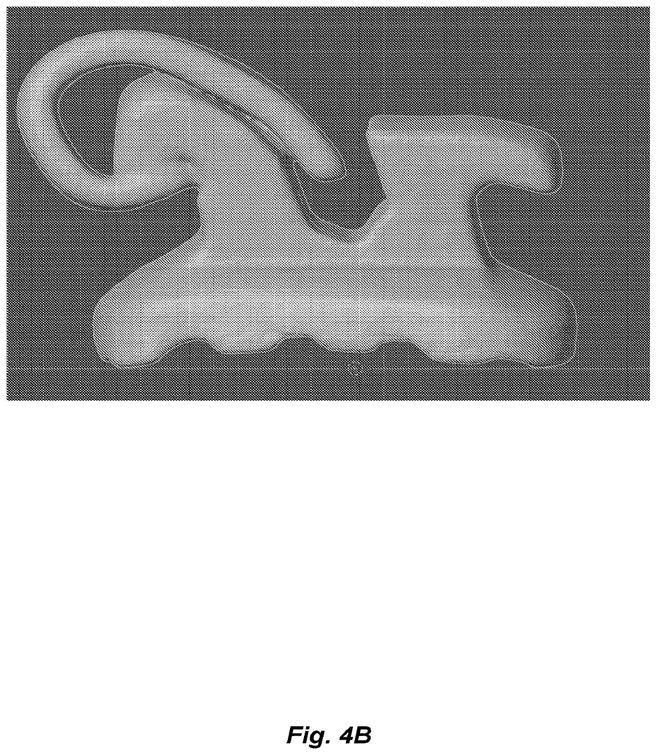

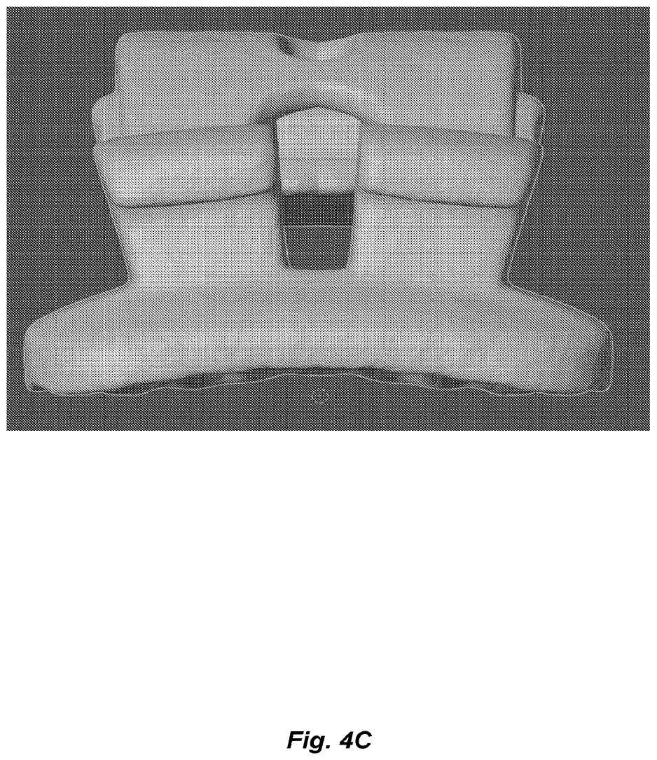

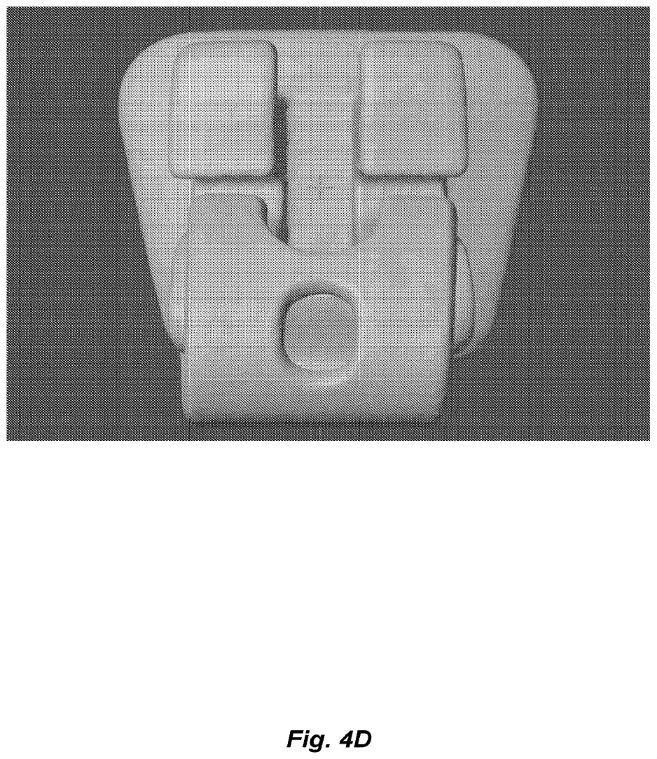

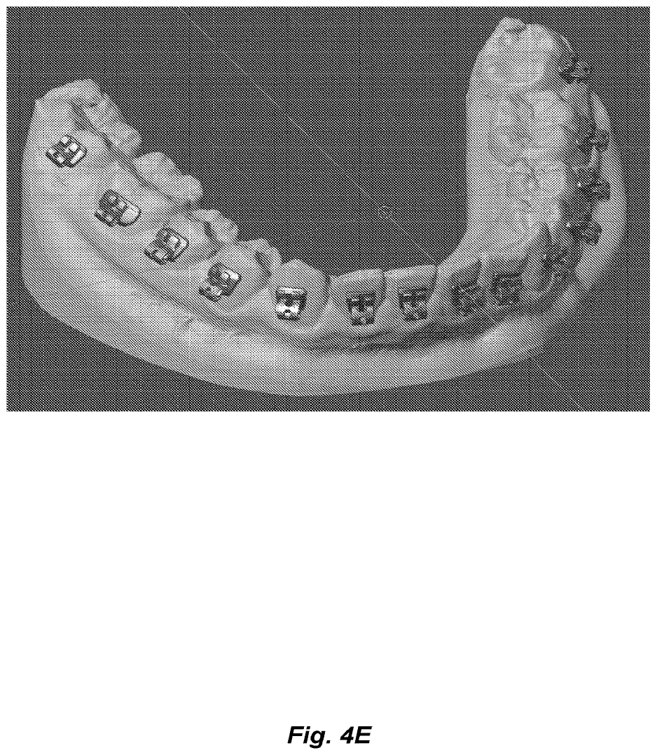

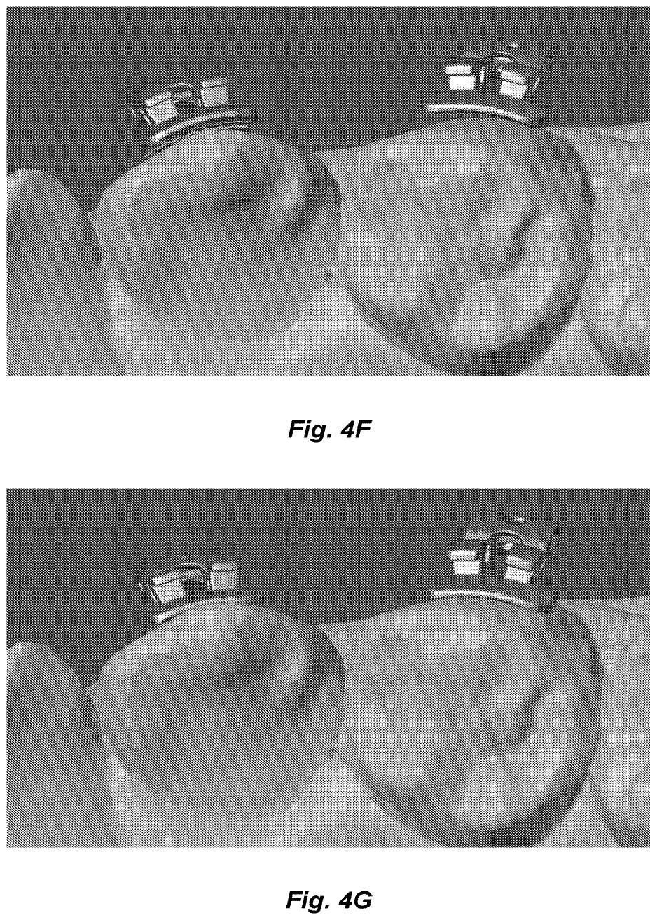

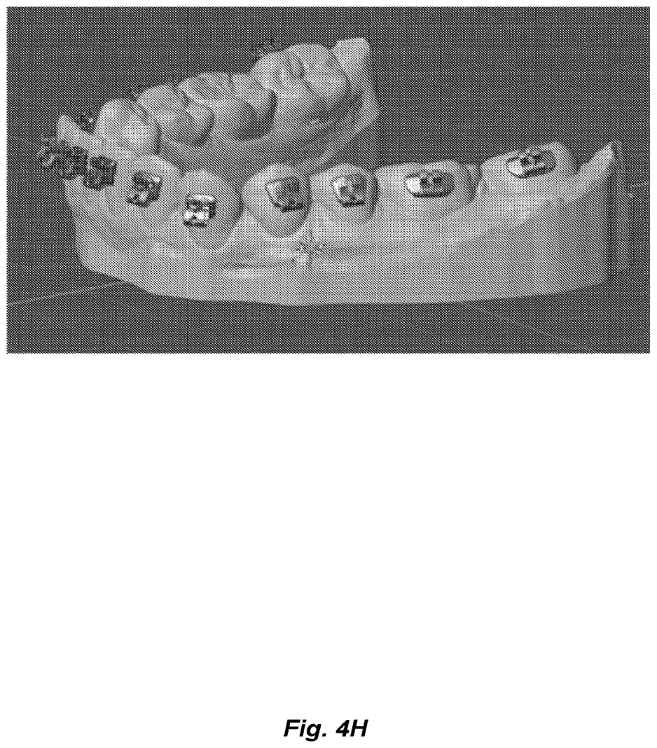

FIG. 2 is a simplified flow diagram illustrating an example of a bracket model set placement process, according to embodiments of methods and systems such as those disclosed herein. That being the case, bracket model sets are placed by a bracket model set placement process 200 such as that depicted in FIG. 2. Bracket model set placement process 200 begins with the identification of one or more tooth objects of the manifold dentition model (210). Facial axis markers are then placed on the tooth objects identified (215). A more detailed discussion of such a facial axis marker placement process is provided in connection with the example process presented in FIG. 3A, subsequently. One or more bracket models representing the desired physical brackets are then selected (220), and copies of the selected bracket model(s) retrieved (225). These bracket model copies are then placed on their respective tooth objects of the manifold dentition model (230). A more detailed discussion of such a bracket model copy placement process is provided in connection with the example process presented in FIG. 4A, subsequently. In placing the set of bracket model copies, it is to be appreciated that the bracket model copies thus placed our positioned at the facial axis marker corresponding thereto. Bracket model set placement process 200 then concludes, or may be looped or returned to the start process to produce additional bracket guides sequentially (as well as in parallel), as will be understood by those skilled in the art.

FIG. 3A is a simplified flow diagram illustrating an example of a facial axis marker placement process, according to embodiments of methods and systems such as those disclosed herein. In order to place the facial axis markers on their respective tooth objects, a facial axis marker placement process 300 is performed. Facial axis marker placement process 300 begins with the selection of one of the tooth objects of the manifold dentition model (310). In turn, the facial axis of selected tooth object is determined (315). Using this facial axis, a facial axis point for the selected tooth object is determined using the facial axis of the tooth object (320). Thus, in certain embodiments, the determination of the facial axis can be automatically initiated based on surface shape of the tooth and compared recognition the bracket (based on the earlier-mentioned dimensionality) and is approximated to the tooth for a primary alignment. In certain such embodiments, such alignment can then be accepted or adjusted by an operator, for example.

As used herein, a facial axis point can be determined using any of a number of advantageous approaches. In certain embodiments, the orthodontic brackets employed have a rectangular groove (slot) cut into them of specific dimension and orientation to accept a rectangular wire (the archwire). Relating the slot and the wire to one another allows a bracket to control each tooth to a specific position (location and orientation). In order to set this position, a grounding feature is desirable-a specific, repeatable location on the tooth at which to place the bracket—this is the facial axis point (FAP). In one embodiment, the facial axis point is determined by designating a line along the height of contour or principal axis on the facial surface of the tooth object in question as the facial axis (or, in the case of physical brackets to be placed on the lingual side of a patient's tooth, the lingual surface, and so, the lingual axis). Such axes can be seen as the dashed lines in FIG. 3B, noted subsequently. Along this facial axis, a point is determined—this point is referred to as the facial axis point. In certain embodiments, this point is taken to be the midpoint of the facial axis (with respect to the height of the contour), which is treated as the facial axis point and appear in FIG. 3B as dots at those points on the tooth objects depicted therein.

It will be appreciated that, in defining a bracket guide foundation volume, methods and systems such as those described herein generate a gingival surface that is situated between a peak occlusal point of the tooth object (a point on the tooth object that is furthest from a base of the dentition model), and an occlusal surface that is situated between the gingival surface and the peak occlusal point of the tooth object. In defining the surfaces in this manner, the physical bracket guide will leave uncovered a portion of the teeth to which the physical brackets are to be affixed, providing access thereto and facilitating the manipulation of such physical brackets during the procedure in question. Further in this regard, by locating the occlusal surface at points within the vertical extent of the placed bracket model copies (in terms of, for example, a world z-axis), a physical bracket guide produced according to embodiments of methods and systems such as those described herein provides access to the physical brackets guided thereby as a result of portions of those physical brackets remaining exposed. In so doing, such a physical bracket guide further facilitates the manipulation of such physical brackets, ease in affixing those physical brackets to the patient's teeth, and removal of excess adhesive during such procedures (for example, particularly before polymerization of the adhesives used in certain such procedures), as well as other such benefits. Advantageously, in so doing, the area to be etched can thus be determined with a precision that minimizes or eliminates unnecessary adjacent area demineralization in preparation for affixing the physical brackets to the patient's teeth.

In making such determinations, this stage of the placement process, by determining the proper position (location and orientation) of the tooth's facial axis and facial axis point, provides improved efficiency in the subsequent placement of the corresponding bracket model copy, with regard to the computational resources involved, the need for manual adjustment, and the accuracy of the resulting placement of the physical bracket guides. In certain embodiments, such features are implemented in software that is compatible with commercially-available modeling packages. This can be accomplished by recording the coordinates (for example, the x, y, z coordinates in Cartesian space). However, as noted, the orientation of the facial axis markers in question may still be poorly oriented with respect to the facial surface of their corresponding tooth objects (for example, as may be the case in which the facial axis marker's orientation is relative to the operator's viewpoint and the view camera's up vector). Through the use of a facial axis marker such as that described herein, the proper positioning of bracket model copies is facilitated.

Next, the facial axis marker is located at the selected tooth object's facial axis point (325). As used herein, the term “position” is intended to convey a combination of “location” (for example, the location of an object along one or more given axes of x-y-z space) and “orientation” (for example, the orientation of an object in, for example, x-y-z space), although other coordinate systems can be employed to equally good effect (for example, cylindrical, spherical, and other coordinate systems). Such location operations are also referred to herein as manipulation.

In view of the foregoing, it will be appreciated that locating the facial axis marker at the selected tooth object's facial axis point may not position the facial axis marker advantageously with respect to the face of the tooth object. That being the case, and operation is performed to align the orientation of facial axis marker with the facial surface of selected tooth object (330). A determination is then made as to whether additional tooth objects remain, for which facial axis markers remain to be placed (335). If further tooth objects are in need of facial axis marker placement, facial axis marker placement process 300 loops to the selection of the next tooth object (310). As with other processes described herein, while the process of placing facial axis markers is depicted as being performed on individual tooth objects, after which manual adjustments are made, such adjustments can be made as the facial axis markers are placed. This and other alternatives are intended to be comprehended by the present disclosure.

In the alternative, a determination can be made as to whether manual position adjustment is needed (or desired) (340). If so, facial axis marker placement process 300 can be implemented to provide for the manual adjustment of one or more facial axis markers positions (345). Once such adjustments have been made (or in the case in which no such adjustments are needed), facial axis marker placement process 300, or may be looped or returned to the start process to produce additional bracket guides sequentially (as well as in parallel), as will be understood by those skilled in the art.

In positioning facial axis markers such as those contemplated by the present disclosure, agreement between such facial axis markers and the facial surfaces of the tooth objects is typically advantageous in positioning the corresponding bracket model copies that are placed using such facial axis markers as guides. Thus, agreement as between the facial axis markers and bracket model copies is similarly advantageous, and can be effected through the implementation of, for example, registration points, compatible orientation in their storage in their respective libraries (or combine storage in a single library), and by way of other such mechanisms.

Further, in certain embodiments, machine learning techniques such as those described subsequently can be used to good effect. This is true of determinations as to the facial axis of the given tooth object (for example, using the contours of the tooth object) and its facial axis point, using the facial axis, whether determined manually, algorithmically, or by the aforementioned machine learning techniques). As noted subsequently in this regard, feedback into the machine learning systems employed can include information regarding the manual adjustments made to the positioning of facial axes, facial axis points, facial axis markers, and bracket model copies, but also adjustments made in the positioning of physical brackets on a patient's teeth. For example, once a set of physical brackets has been placed (and set in place, for example, by polymerization of the adhesive employed), the patient's dentition can be scanned, which can include the placed physical brackets. Information regarding differences between positioning of the physical brackets and the placement of the bracket model copies (using the dentition model for each as a common reference point) can also be used as an input to the machine learning system. In so doing, the machine learning model can be made to account for such differences, and so “learn” ways to place packet model copies that will improve placement of physical brackets, and so improve clinical outcomes. In certain embodiments, this can be done in conjunction with TO tooth and root segmented cone beam computed tomography (CBCT) images that can compare facial axis variance to that of “ideal” root position to any physiologic limitations that would preempt the defined “facial axis location” and modify to best physiologic position, with, for example, a determination being made based on learning via analysis of user interactions, in order to better provide improved placement decisions. Such learning would thus train the machine learning model.

FIG. 3B is a graphical diagram illustrating examples of the location of facial axes and facial axis points, according to embodiments of methods and systems such as those disclosed herein and discussed above.

FIG. 3C is a graphical diagram illustrating an example of the location of facial axis markers on tooth objects of a dentition model, according to embodiments of methods and systems such as those disclosed herein. As noted earlier, the location of facial axis markers at facial axis points for the tooth objects depicted show the facial axis markers being located at the facial axis points of their respective tooth objects, but in so doing, the facial axis markers may not be properly oriented with respect to the facial surface of their respective tooth objects.

FIG. 3D is a graphical diagram illustrating an example of the alignment of the facial axis markers' respective orientation on the facial surfaces of the tooth objects, according to embodiments of methods and systems such as those disclosed herein. Here, the orientation of each of the facial axis markers with respect to the facial surfaces of the various tooth objects has been aligned as necessary to allow appropriate placement of the respective bracket model copy.

FIG. 4A is a simplified flow diagram illustrating an example of a bracket model copy placement process, according to embodiments of methods and systems such as those disclosed herein. A bracket model copy placement process 400 is thus performed to place copies of bracket models on the tooth objects of the manifold dentition model. Bracket model copy placement process 400 begins with the selection of a selected facial axis marker (for example, by selecting the tooth object on which the selected facial axis marker is placed) (410).

The bracket model to be used is then selected (415). A copy of the selected bracket model can be retrieved from a bracket model library (or a copy of a retrieved bracket model made for use in placement). Alternatively (or in conjunction there with), a bracket model can be created as part of this process. In either scenario, as well as in others, physical brackets can also be produced as part of the production process. Such physical brackets can be produced using the same production processes used in creating the physical bracket guide (for example, using the same 3D printing techniques), or can be produced using other techniques appropriate to the manufacturer of such physical brackets (for example, the use of laser sintering of metallic powders, in contrast to the plastic resin processes used to produce the physical bracket guide). In so doing, improve agreement between the physical bracket guide and physical brackets can be achieved, as well as the contact surfaces of the physical brackets customized to their respective tooth object's surfaces.

Bracket models (for example, such as those depicted in FIGS. 4B, 4C, 4D) are digitized representations of the physical brackets thus represented. Such bracket models can be generated by way of the three-dimensional scanning of the physical brackets, and storage of the result in a bracket library. In such a bracket library, each bracket is stored as a bracket model such that its local origin is at the world origin. The local origin is defined such that no part of the bracket is lower than the x-y plane, with the principal axes of the bracket's rectangular slot orthogonal to the world space, and the midpoint of the slot aligned with the world space's z-vector. This definition can be used to properly place the bracket on the facial axis point previously defined.

A copy of the bracket model (the bracket model copy) is thus aligned with the facial axis marker of the selected tooth object (420). As discussed earlier, use of the term “position” is intended to convey a combination of “location” and “orientation,” in the manner noted. The bracket model copy is then moved into location with respect to selected tooth object, as defined by facial axis marker (425), which can be aided by the bracket model and facial axis marker being stored uniformly in relation to one another (for example, as by their being stored in the same orientation). Movement of the bracket model copy into this location can be effected by moving the bracket model copy along a world z-axis, along an axis normal to the tooth object's facial surface and through the facial axis point, along a vector from the centroid of the tooth object through the facial axis point, or along another suitable axis, until the bracket model copy is located in agreement with the facial axis marker. As before, while the bracket model copy will now be located (using the facial axis marker) in a location appropriate to the facial surface of the tooth object, the orientation of the bracket model copy may not provide an appropriate (or even workable) position. That being the case, the bracket model copy's position is then adapted with facial surface of selected tooth object as necessary to align the bracket model copy's orientation with that of the tooth object's facial surface (430). In this regard, it will be appreciated that such adaptation results in an acceptable level of agreement between the bracket model copy's contact surface and the facial (or lingual) surface of the tooth object in question.

In one embodiment, once the facial axis points have been chosen and facial axis markers placed, the bracket model in question is retrieved from the bracket model library and given the same position (location and orientation) of the markers using the facial axis marker's transformation matrix. However, it may be the case that, due to variations in shape of the bracket and that of the individual tooth on which the physical bracket is to sit, one or more collisions between the bracket model and the tooth object may exist (for example, where the bracket passes through the surface of the tooth in its initial placement). In such situations, given that such cannot be the case with solid physical objects, the bracket model copy is moved along its local z-vector (directly away from the (facial or lingual) surface of the tooth object), until no collisions occur between the bracket model copy and the tooth object.

In such an embodiment (and as noted), the bracket model copy may not be appropriately adapted to the surface of the tooth object. In order to improve the “fit” of the contact surface of the bracket model copy to the surface of the tooth object, a physics simulation implemented in the software can be employed to good effect, allowing the bracket model copy's contact surface to “settle” on to the surface of the tooth object. This can be accomplished in a number of ways. In one embodiment, in which the force of gravity is simulated as being the “down” direction (for example, towards the negative along a world z-axis), the manifold dentition model (as well as any existing components already placed thereon, such as facial axis markers and/or bracket model copies) is transformed such that a surface normal vector of the surface of the tooth object in question points in the “up” direction (for example, towards the positive along the world z-axis). The bracket model copy is then allowed to “settle” in the “down” direction of the world z-axis (and so the surface normal vector), onto the surface of the tooth object. Alternatively, a force along such a surface normal vector can be applied to the bracket model copy and question, “pushing” the bracket model copy's contact surface onto the tooth object's surface along a force vector representing the force. In either event, or by other comparable mechanisms, the goal of adapting the bracket model copy to the tooth object is accomplished. Further, it is to be appreciated that such positioning can be accomplished manually, algorithmically, using machine learning techniques such as those described subsequently, and/or by a combination of one or more of these and/or other techniques.

In contrast to the processing described with regard to individual tooth objects in an earlier example, a determination is now made as to whether the adapted bracket position is to be adjusted manually (435). If so, manual position adjustment of adapted bracket position is performed (440). At this juncture, a determination is made as to whether more tooth objects needing bracket model copies to be placed remain (445). Bracket model copy placement process 400 can then conclude, or may loop or return to the start process to produce additional bracket guides sequentially (as well as in parallel), as will be understood by those skilled in the art. In this regard, certain embodiments provide for situations in which, if the surface and bracket are difficult to approximate without producing a potential void in the material, a process such as that described herein can create a composite bracket foundation as an attachment that can be 3D printed and bonded to the tooth prior using the mask. This can server as a guide for placement of the bracket, onto which the intended bracket is then bonded during use of the physical bracket guide.

FIG. 4B is a graphical diagram illustrating a side view of an example of a bracket model (along an axis parallel to that of an archwire, not shown), according to embodiments of methods and systems such as those disclosed herein.

FIG. 4C is a graphical diagram illustrating a bottom view of an example of a bracket model, according to embodiments of methods and systems such as those disclosed herein.

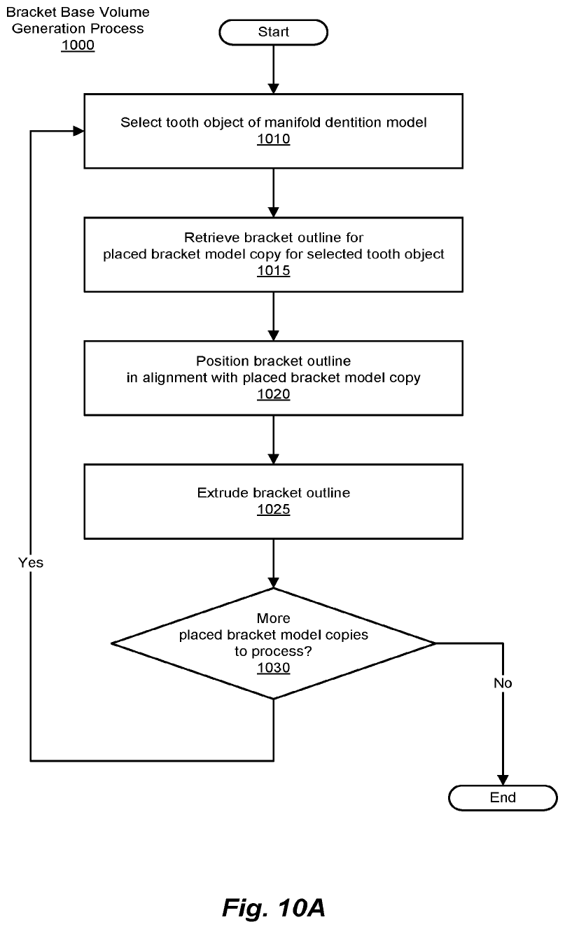

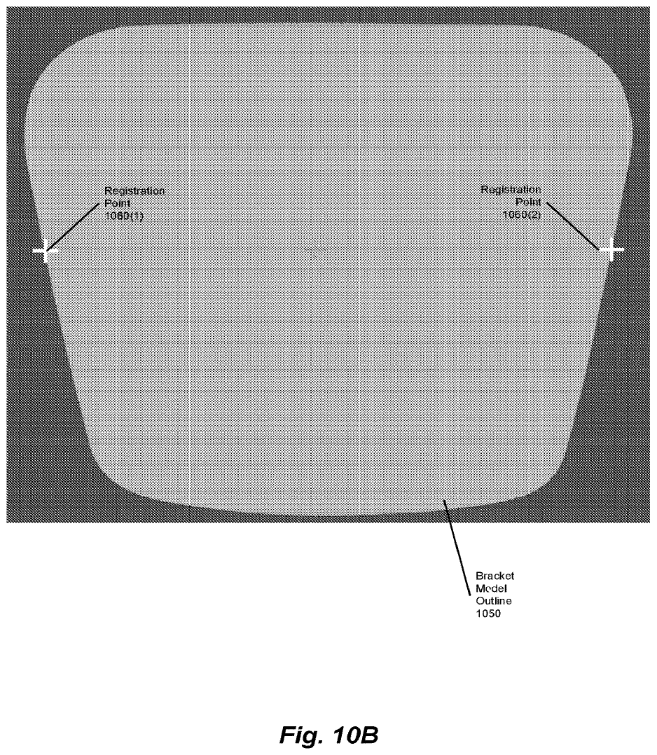

FIG. 4D is a graphical diagram illustrating a facial view of an example of a bracket model, according to embodiments of methods and systems such as those disclosed herein. This view of the bracket model will be seen to agree with the bracket model outline depicted in FIG. 10B, and described subsequently.

FIG. 4E is a graphical diagram illustrating an example of bracket model copies after having been moved into location with respect to the tooth objects, according to embodiments of methods and systems such as those disclosed herein. As noted, while the bracket model copies have been located appropriately through the use of the facial axis markers, their orientation may still be lacking, as is seen in FIGS. 4F and 4G.

FIG. 4F is a graphical diagram illustrating an example of bracket model copies after having been moved into location with respect to the tooth objects, in greater detail, according to embodiments of methods and systems such as those disclosed herein. Here, the position of the bracket model copies depicted can be seen to be poorly adapted to the facial surfaces of the tooth objects in question. By adapting the bracket model copies to the tooth objects' facial surfaces, better agreement between the bracket model copies and the facial surfaces can be achieved. This translates into not only the physical brackets being better affixed to the actual teeth in question, but also goes to the accuracy with which those teeth are manipulated, and ultimately the clinical results produced.

FIG. 4G is a graphical diagram illustrating the bracket model copies depicted in FIG. 4F after having been adapted to the tooth objects, according to embodiments of methods and systems such as those disclosed herein. Seen in FIG. 4G are the results of the aforementioned adaptation of the bracket model copies in question with the facial surfaces of their respective tooth objects. As can be seen in FIG. 4G, the bracket model copies' positions now more closely agree with their respective tooth objects' facial surfaces.

FIG. 4H is a graphical diagram illustrating an example of bracket model copies after having been adapted to the tooth objects, according to embodiments of methods and systems such as those disclosed herein.

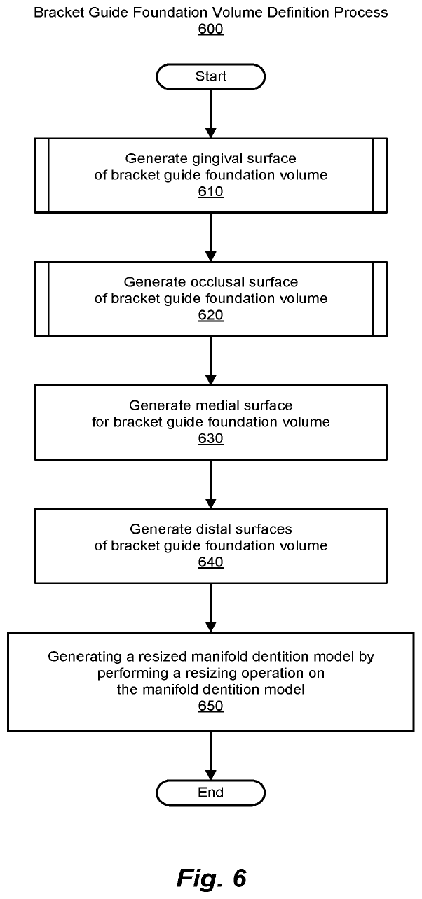

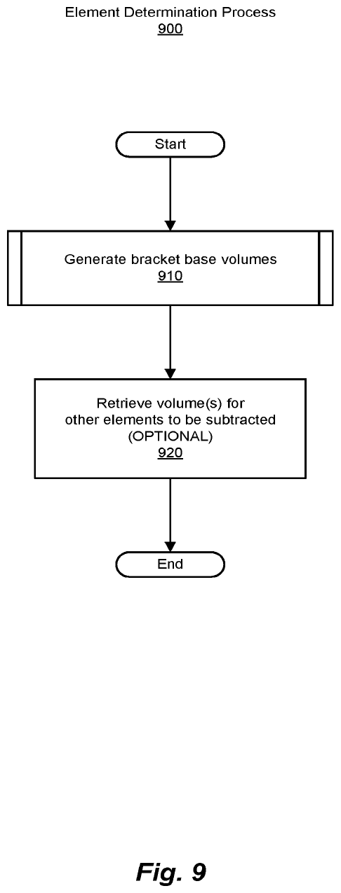

FIG. 5 is a simplified flow diagram illustrating an example of a bracket guide foundation generation process, according to embodiments of methods and systems such as those disclosed herein. FIG. 5 thus depicts a bracket guide foundation generation process 500 that generates a bracket guide foundation volume. Bracket guide foundation generation process 500 begins with the definition of a bracket guide foundation volume (510). A more detailed discussion of such a process is provided in connection with the example process presented in FIG. 6, subsequently. Next, the volume of each bracket model copy (bracket model copy volumes) is determined (520). Element volumes are also determined (530). A more detailed discussion of such a process is provided in connection with the example process presented in FIG. 9, subsequently. Bracket guide foundation generation process 500 can then conclude, or may loop or return to the start process to produce additional bracket guides sequentially (as well as in parallel), as will be understood by those skilled in the art.

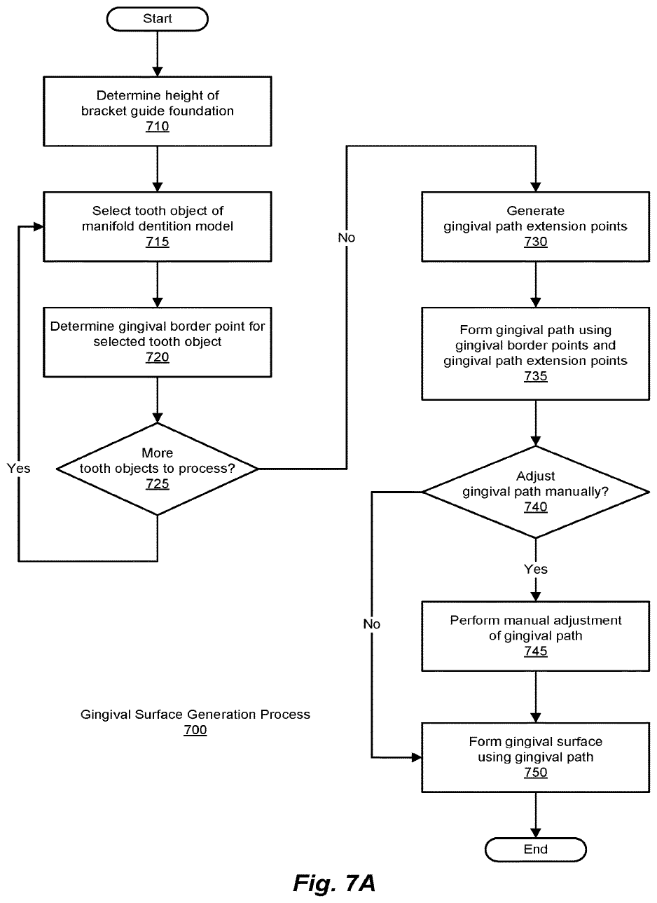

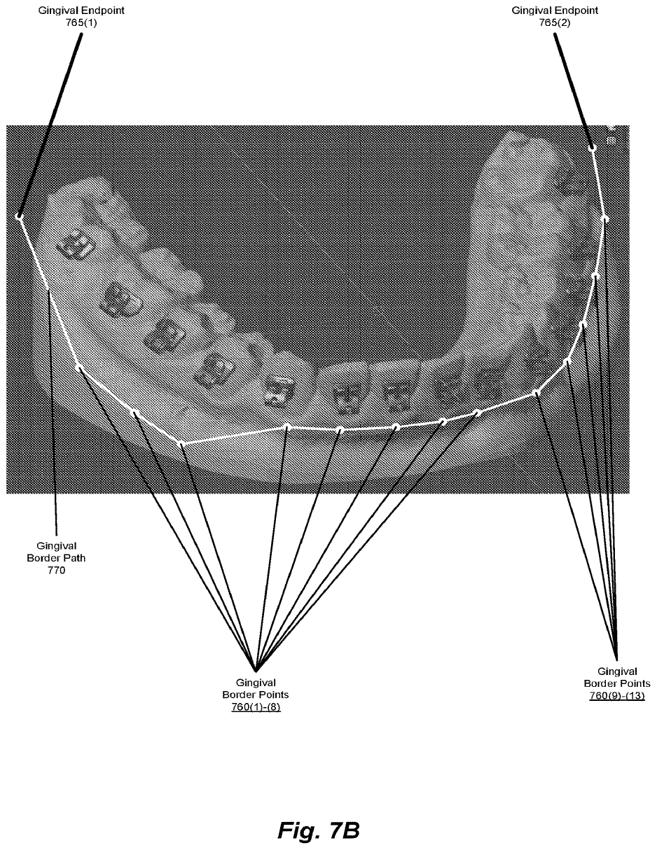

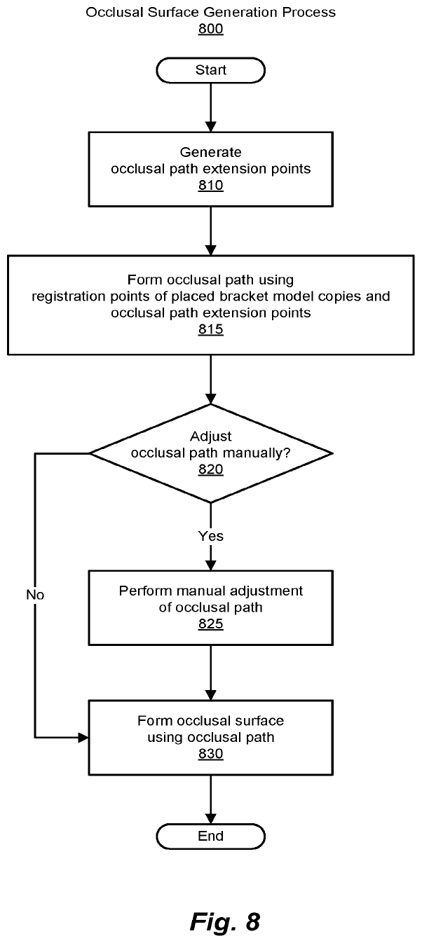

FIG. 6 is a simplified flow diagram illustrating an example of a bracket guide foundation volume definition process, according to embodiments of methods and systems such as those disclosed herein. A bracket guide foundation volume definition process 600 is performed to define the bracket guide foundation volume. Bracket guide foundation volume definition process 600 begins with the generation of a gingival surface of the bracket guide foundation volume (610). A more detailed discussion of such a gingival surface generation process is provided in connection with the example process presented in FIG. 7A, subsequently. The occlusal surface of the bracket guide foundation volume is also generated (620). A more detailed discussion of such an occlusal surface generation process is provided in connection with the example process presented in FIG. 8, subsequently.

The bracket guide foundation volume, in certain embodiments, is also constrained by a medial surface, one or more distal surfaces, and/or and outer surface (for example, such as might be created using the manifold dentition model). To this end, as depicted in FIG. 6, bracket guide foundation volume definition process 600 also includes operations to generate a medial surface (630), distal surfaces (640) (which can be generated by way of a surface at the extension points, a volume of appropriate size having a center of a face centered at each of the extension points, or some other comparable mechanism), and perform a resizing operation on the manifold dentition model to create a resized manifold dentition model (650), for the bracket guide foundation volume. Bracket guide foundation volume definition process 600 can then conclude, or may loop or return to the start process to produce additional bracket guides sequentially (as well as in parallel), as will be understood by those skilled in the art.

It should be noted here that the creation of an inflated dentition model accomplished by way of resizing the manifold dentition model creates the outer surface of the bracket guide foundation volume (and so, in a direction distal to the tooth object). This can be accomplished in a number of ways. For example, the manifold dentition model can be “inflated” (in other words, be the subject of an inflation operation, in which the mesh of the manifold dentition model is expanded in a direction normal to its surface by a certain amount (for example, 0.75 mm), and in so doing, create an inflated dentition model. In noting this, it is to be appreciated that, while much of the discussion herein is directed to placement of brackets on the facial side of a patient's teeth, such an inflation operation also can expand the manifold dentition model lingually, in order to provide a bracket guide for bracket placement to the “inside” of such a patient's teeth. It should also be appreciated that such inflation operations comprehend expansion of a structure (in this case, the manifold dental model) outward, from a normal to the surface. In contrast, extrusion is along a vector such as the Z-axis, a normal to a surface, a vector between a tooth objects centroid and facial axis point, and the like.

Further in this regard, such inflation can include the bracket model copies, such that the bracket model copies and their bracket base volumes (discussed subsequently) become “part” of the manifold dentition model, and the entire volume inflated. In so doing, such an approach provides an example of a bracket guide foundation volume that can be “filled” by a “liquid” material that is “flowed” into the volume using virtual reality techniques (and another reason for the dentition model to be manifold, among others). In such embodiments, a surface can be added to the process to “uncover” a portion (or all) of the bracket model copies, to permit physical access when using the physical bracket guide produced.

FIG. 7A is a simplified flow diagram illustrating an example of a gingival surface generation process, according to embodiments of methods and systems such as those disclosed herein. A gingival surface generation process 700 to generate a gingival surface. Gingival surface generation process 700 begins with a determination as to the height of bracket guide foundation (710). The bracket guide foundation height can be predefined (and retrieved during this process), or determined dynamically, based on an analysis of the manifold dentition model. Definition of the gingival border path begins with the selection of one of the tooth objects of manifold dentition model (715). A gingival border point is then determined for selected tooth object (720). The location of such gingival border points can be determined in a number of ways, including locating such gingival border points:
1) at a set distance below each tooth object's facial axis point.
2) by determining a planar section of the manifold dental model at each facial axis point, such that the normal vector of the facial axis point lies in that plane. That section is then rotated so that the facial point normal is parallel to the world z-axis and translated to the origin. Then a peak finding algorithm is used to find the height of contour along that profile section, which represents the gingival border point at that tooth object.
3) through the same initial operations as in (2), but rather than a peak finding algorithm, creating a number of circles of increasing radii (a disk) centered about the facial axis point. The point at which the disk intersects with the manifold dental model, a point is placed representing the gingival border point for the tooth object in question.
4) by identifying the gingival crest above (in terms of the world z-axis) the mucogingival junction

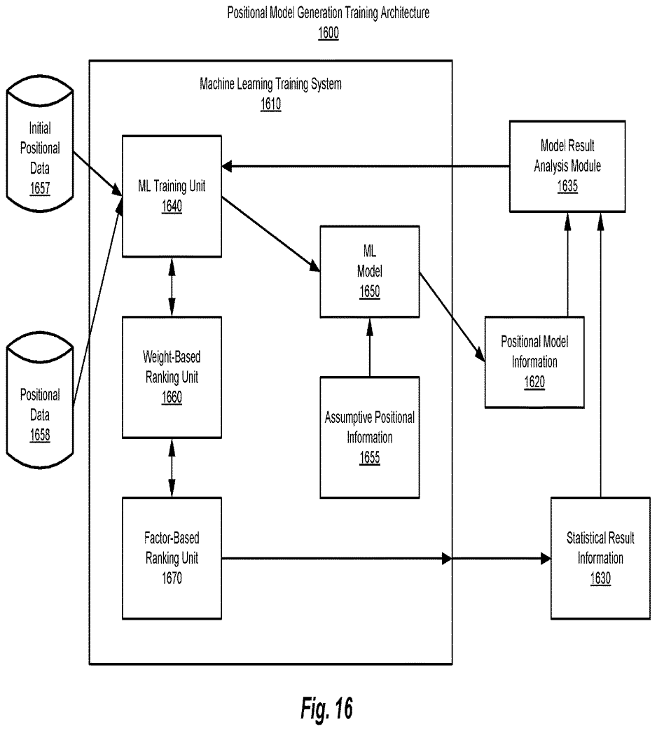

As will be further appreciated, techniques such as those described above are amenable to improvement through the application of machine learning paradigms such as those described in connection with FIGS. 16-19, subsequently. For example, determinations as to advantageous positioning of the bracket model copies for purposes of ease in the affixing of physical brackets can be used as a constraint in the training of the given machine learning model, as can ease with which such physical brackets can be removed, the clinical results provided by such positioning, the selection of the bracket model(s) used, cost of treatment, identification of appropriate facial axis points, facial axis marker placement, and other such aspects of the bracket models selected and their placement. Further in this regard, another consideration as to such height is the “manufacturability” of the resulting bracket guide. Depending on the process used to produce the bracket guide, a minimum height (and so, vertical thickness) may need to be considered, to avoid breakage during production and/or use.

In one implementation, software created to perform this process determines placement of a point directly below (from the perspective of the world z-axis) each bracket model copy, which can be accomplished in a fashion to similar that described in connection with the placement of the bracket model copies. Once the gingival border points have been placed, the two gingival path extension points can be determined arithmetically, for example. In such a scenario, a vector between the second and the first gingival border points is generated, and a point is placed beyond the first gingival border point along that vector (for example, 10 mm beyond the first gingival border point). Similarly, a vector between the second-to-last and last points is generated, and a point is found beyond the last point (for example, 10 mm beyond that point). In such an embodiment, the two gingival path extension points ensure that the area necessary is included to form the border of the guide.

This process continues while more tooth objects to process (725), looping to the selection of the next tooth object (715), until, in the embodiment depicted in FIG. 7A, no further tooth objects remain (725). At this juncture, gingival path extension points are generated, extending the gingival path past the first and last gingival border points (730). The gingival path is then formed using the gingival border points and the gingival path extension points (735), as is depicted in FIG. 7B, described subsequently. A determination can be made as to whether the gingival path is to be adjusted manually (740). If so, manual adjustment of the gingival path can be performed (745). The gingival path having been formed can now be used in the formation of the gingival surface (750). Gingival surface generation process 700 can then conclude, or may loop or return to the start process to produce additional bracket guides sequentially (as well as in parallel), as will be understood by those skilled in the art.

FIG. 7B is a graphical diagram illustrating an example of a gingival path, according to embodiments of methods and systems such as those disclosed herein. As referenced in the discussion of FIG. 7A, a number of gingival border points are defined/determined, for example, on a per-tooth-object basis. Examples of such gingival border points are depicted in FIG. 7B as gingival border points 760(1)-(13). Also defined/determined are the gingival endpoints 765(1)-(2). Gingival border points 760(1)-(13) and gingival endpoints 765(1)-(2), taken together, are used to form a gingival border path 770, as discussed in connection with FIG. 7A. As will be appreciated, gingival border path 770 can, in the alternative, follow the gumline (the line separating the gingiva (gum) from the exposed part of each tooth).

FIG. 8 is a simplified flow diagram illustrating an example of an occlusal surface generation process, according to embodiments of methods and systems such as those disclosed herein. In a manner similar to that of the gingival surface generation process, an occlusal surface generation process 800 is performed in order to generate the occlusal surface of bracket guide foundation volume. Occlusal surface generation process 800 begins with the generation of occlusal path extension points, in a manner comparable to that described earlier herein with respect to the aforementioned gingival extension points (810), which can extend the occlusal surface generated past the rear-most molars, for example. This having been done, at least in the embodiment depicted, the occlusal path is formed using the registration points of the placed bracket model copies and the occlusal path extension points (for example, one on the mesial and one on the distal, located directly on the axis formed by points 1060, and so centered on the arch wire slots of the bracket model copies) (815). In one implementation, such positioning of the bracket model copy and its base locates the plane of the archwire closer to the center of resistance of the tooth, providing more control over tooth movement. A determination can then be made as to whether the occlusal path generated is to be adjusted manually (820). If so, manual adjustment of occlusal path can be performed (825). The occlusal path thus generated (and, possibly, adjusted) can then be used to form the occlusal surface, making a copy of the path in a manner comparable to creation of the gingival border, with one path to the buccal and one path to the lingual to create the desired surface (830). Occlusal surface generation process 800 can then conclude, or may loop or return to the start process to produce additional bracket guides sequentially (as well as in parallel), as will be understood by those skilled in the art.

FIG. 9 is a simplified flow diagram illustrating an example of an element determination process, according to embodiments of methods and systems such as those disclosed herein. It will be appreciated that the terms used to describe aspects of the physical bracket guide being produced (for example, “features” and “elements”) are used herein simply for convenience, to distinguish between those aspects that are discussed in terms of addition to and subtraction from the bracket guide foundation volume.

FIG. 9 thus depicts an element determination process 900, which can be performed in order to determine element volumes. Element determination process 900 begins with the generation of bracket base volumes (910). A more detailed discussion of such a bracket base volume generation process is provided in connection with the example process presented in FIG. 10A, subsequently. Optionally, other element volumes can be retrieved (920). It will be appreciated, then, that volumes to be subtracted from the bracket guide foundation volume can be generated (for example, from retrieved data and/or dynamically generated data) or simply retrieved during the generation of the digital representation (for example, having already been prepared and made available, for example, through the use of the library). Element determination process 900 can then conclude, or may loop or return to the start process to produce additional bracket guides sequentially (as well as in parallel), as will be understood by those skilled in the art.

FIG. 10A is a simplified flow diagram illustrating an example of a bracket base volume generation process, according to embodiments of methods and systems such as those disclosed herein. As noted in the description of FIG. 9, FIG. 10A depicts a bracket base volume generation process 1000, which, when performed, generates the bracket base volumes that are used to provide space for the physical brackets in the physical bracket guide produced. Bracket base volume generation process 1000 begins with the selection of one of the tooth objects of the manifold dentition model (1010). Next, the bracket outline for placed bracket model copy for selected tooth object is retrieved (1015). This bracket outline is positioned in alignment with placed bracket model copy (1020). As noted earlier, such positioning takes into account the bracket outline's location and orientation. The bracket outline, once positioned, is extruded to form the bracket base volume for the bracket in question (1025). A determination is then made as to whether more placed bracket model copies remain to be processed (1030). Bracket base volume generation process 1000 can then conclude, or may loop or return to the start process to produce additional bracket guides sequentially (as well as in parallel), as will be understood by those skilled in the art.

In so doing, a bracket base volume can be formed. In one embodiment, the two-dimensional projected outline for each of the brackets is saved to a library, such that a bracket model's bracket base is oriented in the same way the bracket models themselves are stored. In such a library, two vertices, one on the mesial and one on the distal are saved directly on the x-axis. These outlines are loaded and transformed to have the same transformation matrix as their respective bracket model copies. As noted, this surface can then be extended (extruded) both above and below the local z-axis and so can be used to create the receptacles for the brackets in the guide.

In one embodiment, such a process thus provides for the alignment of registration points of the bracket outline with those of placed bracket model copy, and then adjusts the angle of the two-dimensional plane defined by bracket outline to bring the normal of the two-dimensional plane parallel with the appropriate axis/vector (for example, the local z-axis, the normal of tooth surface, the vector created by a line connecting the tooth object's and the facial axis point, or the like). Additionally, when performing operations intended to remove material from the bracket guide foundation volume, it is preferable, in certain embodiments, to define/determine dimensions and tolerances of both subtractive and additive aspects such that the region of control for any given physical bracket is sufficient to allow a practitioner to make physical adjustments.

In fact, such a bracket base volume can be extruded in a manner such that a “port” is created in the bracket guide foundation volume. Such a port can be effected by removing the originally-extruded bracket base volume from the bracket guide foundation volume, and then reducing the cross-sectional area (when viewed, for example, in a direction parallel with the tooth surface normal, in the manner of the bracket base outline) distally away from the manifold dentition model's base, to a point at the most distal point of the bracket model copy. Alternatively (using world x-y-z coordinates), removing that portion of the bracket guide foundation volume between a line from the bottom of the bracket model copy to that point at the most distal point of the bracket model copy.

In one embodiment, then, subtractive operations are intended to provide a procedure to remove the parts of the inflated model to produce the desired bracket guide volume. In such an embodiment, such procedures can be implemented as extensions to the open source libraries with functionality appropriate to the execution of Boolean operations. In using such approaches, the manifold nature of the manifold dentition model can be employed to good effect, prevent problems with defining volumes that could arise from non-manifold geometries.

An alternative to such inflation is to simply predefine the outer surface of the bracket guide foundation volume using, for example, a simple geometric shape therefor (for example, a curvilinear round tube (for example, pipe shape), a facial profile that is cubic or rectangular in shape, or the like), although accommodations for the use of such shapes in the processes described herein may be necessitated, in order to maintain the desired access to the physical brackets held by the physical bracket guide (for example, such as larger volumes extracted around portions of the bracket model copies and so on).

FIG. 10B is a graphical diagram illustrating an example of a bracket model outline, according to embodiments of methods and systems such as those disclosed herein. As discussed in connection with FIG. 10A, an example of a bracket model outline is depicted in FIG. 10B (bracket model outline 1050). Bracket model outline 1050 includes one or more registration points, in the manner noted previously. To this end, registration points 1060(1)-(2) (and referred to in the aggregate as registration points 1060) are depicted. While shown as being two points in the locations illustrated, registration points 1060 can be implemented as one or more points on bracket model outline 1050, and in certain embodiments, may admit to certain transformations as between those points and registration points of the corresponding bracket model and/or its copy, and/or be defined in terms relative to one or more of the structures of the bracket model and/or the dentition model. As described elsewhere herein, such registration points may be located, in certain embodiments, at a center point of a bracket slot of the corresponding bracket model, and so the point at which an archwire will be held by the corresponding physical bracket. In such embodiments, such points can be used to form a path such as an occlusal path (and so, an occlusal surface), in order to expose a portion of one or more of the physical brackets being placed using the physical bracket guide (and in so doing, facilitate access to the physical bracket guide in question). As will be appreciated, depending on the physical brackets employed, other mechanisms involved in the procedure, and other factors, such registration points may be located at an upper extent of the bracket slot (and so, archwire), at a lower extent of the bracket slot (and so, archwire), or at other advantageous locations in relation to the archwire and/or bracket model/portions thereof. Typically, when located at the midpoint of the bracket slot (and bracket model copy of the bracket base profile has been positioned as described herein), such location will result in a line between the registration points that will transit the facial axis point of the tooth object in question. In so doing, such placement should result in the greatest degree of control with regard to the forces applied by the physical bracket to the tooth, and so the movement of that tooth.

FIG. 11A is a simplified flow diagram illustrating an example of a subtractive operations process, according to embodiments of methods and systems such as those disclosed herein. Once again, such subtraction and addition are relative terms, so too are the aforementioned terms used to describe such aspects. FIG. 11A thus depicts a subtractive operations process 1100 that, when executed, performs subtractive operations on bracket guide foundation volume. Subtractive operations process 1100 begins with the removal of one or more bracket model volumes from bracket guide foundation volume (1110), which comprehends the removal of the volumes of each of the bracket model copies placed on the tooth objects of the manifold dentition model (such bracket model volumes being representative of the volumes of their respective bracket models). Next, the corresponding bracket base volume for each of those bracket model copies is removed from bracket guide foundation volume (1120). As is noted subsequently, such an operation is facilitated by storing data representing the bracket model based in a manner in which and orientation of the bracket model based same as that of the bracket model to which the bracket model base associated. It will be appreciated that by performing this operation, artifacts of the bracket guide foundation volume between the bracket model copy and the surface of the tooth object remaining are removed. Also removed from bracket guide foundation volume are other volume(s) (volume(s) for the other elements) (1130). Subtractive operations process 1100 can then conclude, or may loop or return to the start process to produce additional bracket guides sequentially (as well as in parallel), as will be understood by those skilled in the art.

FIG. 11B is a graphical diagram illustrating an example of a bracket guide volume after the subtractive operations process of FIG. 11A has been performed, according to embodiments of methods and systems such as those disclosed herein. The bracket guide volume, at this juncture, is the bracket guide foundation volume, having had the subtractive operations performed thereon. In certain embodiments, such a process of volume creation can be used in identifying a defined location as a guide for the placement of a Temporary Anchorage Devices. In such embodiments, rather than a bracket base window outline for the placement of a bracket on the FA of a tooth, the volume is a “U” shaped slot initiating occlusally at approximately the same height as the described guide and proceeding gingivally to the penetration point desired. Such “U” shaped channels occur interproximally to indicate the location between the roots. At this point, CBCT information can be used for positioning, although pan-oral visualization or calibrated periapical x-rays can be employed for positioning.

In one embodiment, then, the registration points for each bracket outline have been combined to create the bracket path noted earlier. The bracket path is then duplicated that path and moved 5 mm in the facial direction, and duplicated and moved 5 mm in the lingual direction. These two paths are combined to create the occlusal surface that demarcates the occlusal border of the bracket guide foundation volume. Using such a method can ensures that the top portion of the guide runs directly through the slot on the bracket, easing placement in the mouth by the dental practitioner, and facilitates the visualization of variations to planned or prescribed placement. The gingival path is similarly duplicated and scaled to 0.75% to form the lingual border and 1.25% to form the buccal border. The distal most points of the lingual border are translated to match the y value of the buccal border and the gingival and buccal borders are connected to form a surface. This surface demarcates the gingival border. A midpoint path (and so, midpoint surface) is generated by taking a point 2 mm lingual to the facial axis point, and connect such points to form a midpoint path. As in the case of the gingival path, the midpoint path is copied and moved 5 mm to form a surface which can be used to perform the midpoint cut. This ensures that the facial section of the gingival guide is completely separated from the lingual section. For the distal surface described herein, two cubes can be generated and scaled to 20 mm by 25 mm and 0.25 mm thick. Each is placed on our extended bracket path points and oriented such that the vector of the last two bracket path points and first two bracket points is parallel to the facial normal of each cube. These determine the distal most boundary of the guide. For the lingual surface of the bracket guide volume, the initial model is used as a tool to determine the boundary of the lingual surface. The volume of the bracket models are also used as objects to remove material from the bracket guide volume. A Boolean Difference routine can then be used to slice the inflated model into multiple pieces. The desired portions can then be selected by choosing a point that's 5 mm below and 3 mm away from a bracket point and casting a ray from that point to the origin. This ray will intersect the inflated model at a certain face. This face is selected, as well as all linked faces, and then that selection inverted and selected vertices deleted. By doing so, the desired portion of the inflated model remains, and becomes the foundation for the bracket guide.

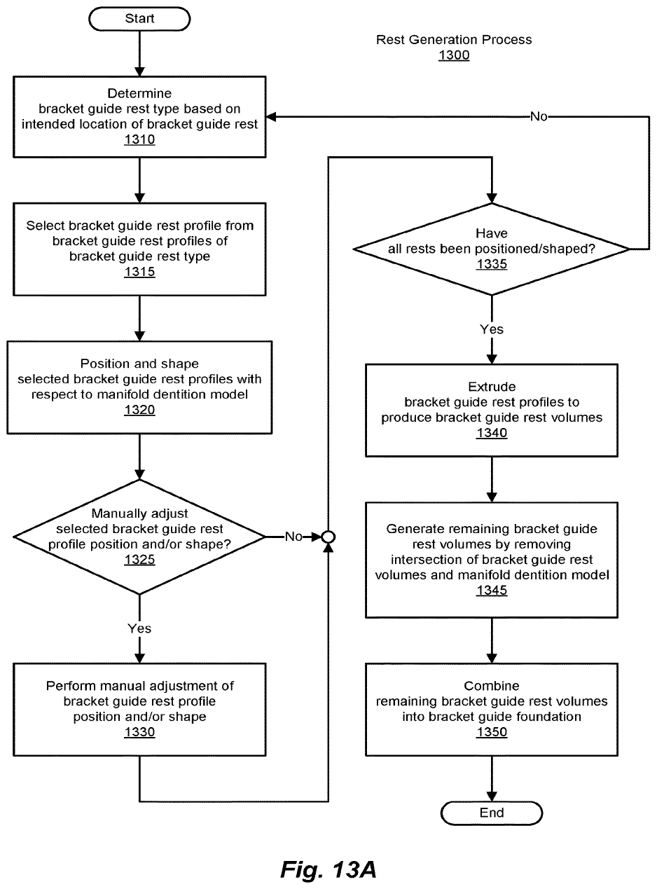

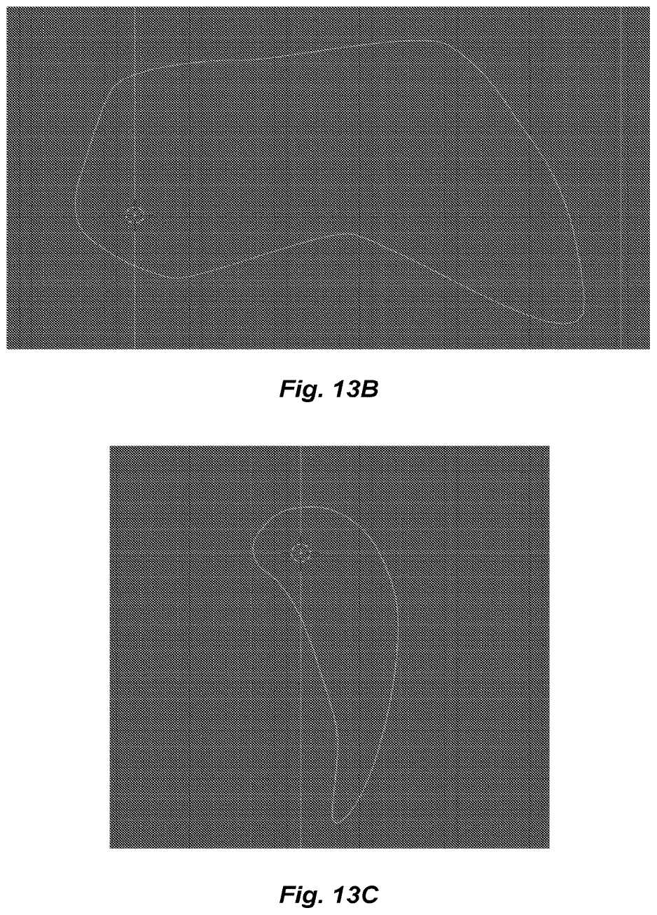

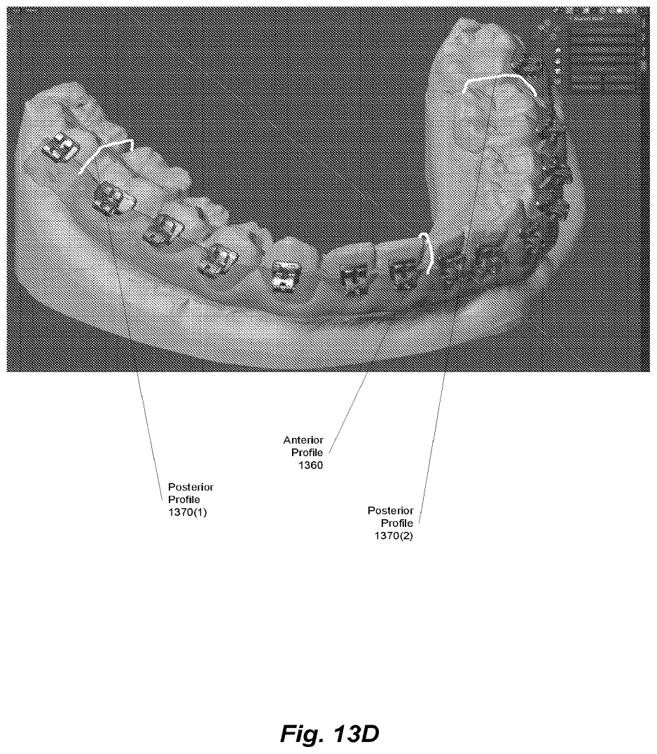

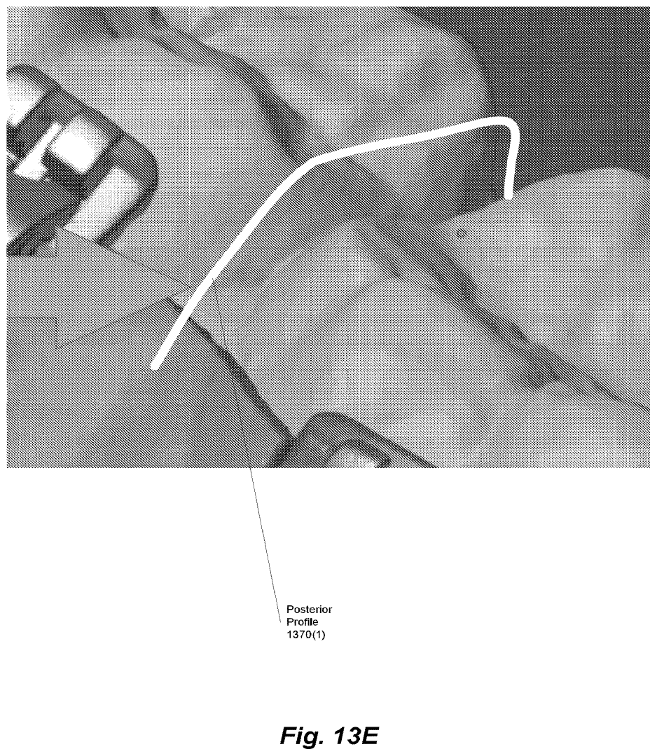

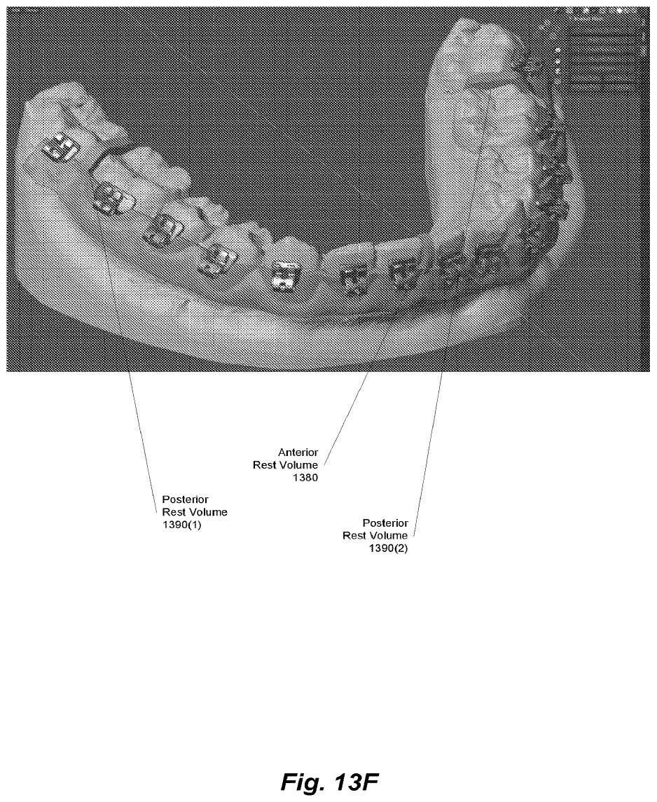

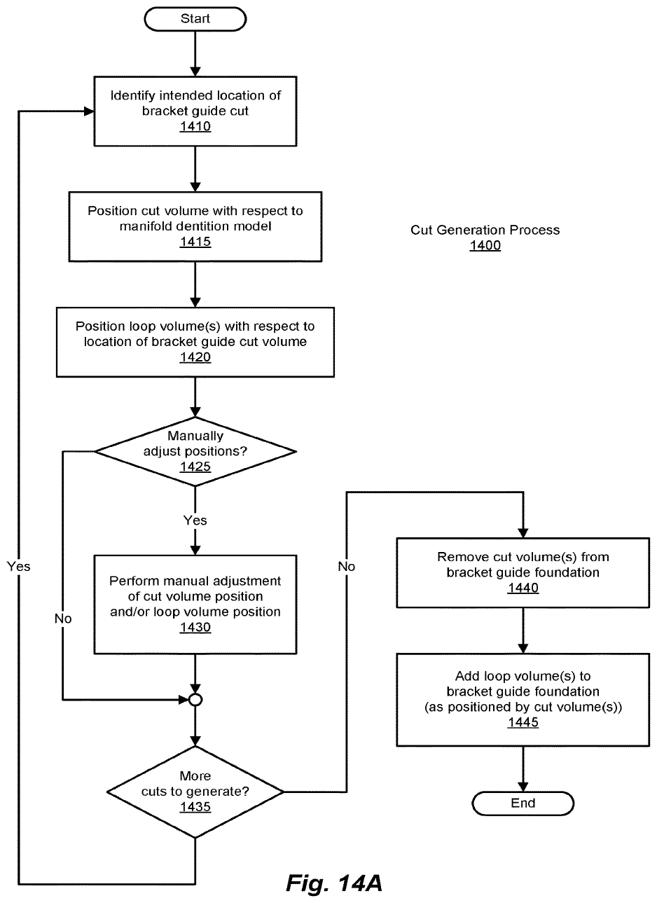

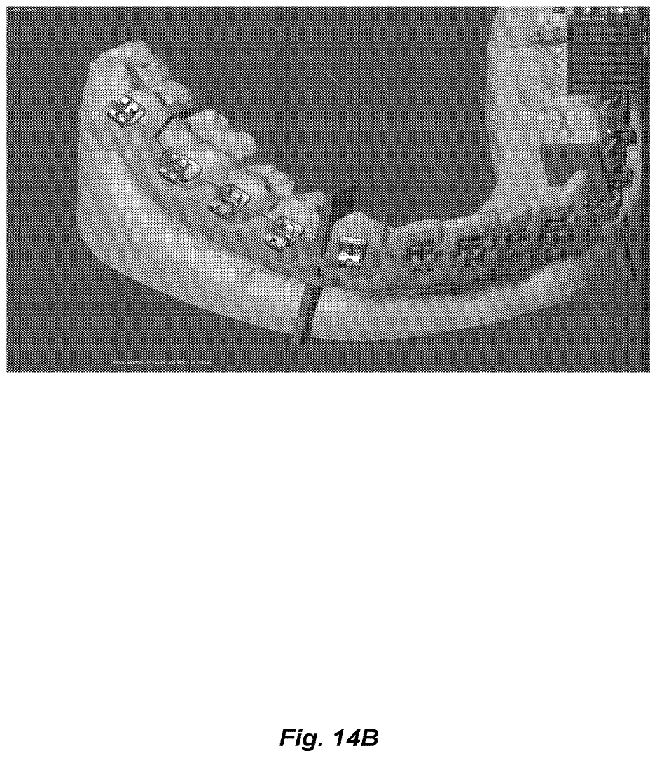

FIG. 12 is a simplified flow diagram illustrating an example of an additive operations process, according to embodiments of methods and systems such as those disclosed herein. FIG. 12 thus depicts an additive operations process 1200 that, when executed, performs additive operations on bracket guide foundation volume by generating bracket guide features. Additive operations process 1200 begins with the generation of one or more bracket guide rests and they are addition to the bracket guide foundation volume (1210). Such bracket guide rests, once added to the bracket guide foundation volume, will result in such structures in the physical bracket guide, and so assist in preventing movement of the physical bracket guide during its use in clinical procedures. A more detailed discussion of such a bracket guide generation process is provided in connection with the example process presented in FIG. 13A, subsequently. Next, one or more bracket guide cuts are generated and their corresponding loops added to bracket guide foundation volume (1220). A more detailed discussion of such a bracket guide cut generation process is provided in connection with the example process presented in FIG. 14A, subsequently. It is to be appreciated that, while the additive operations depicted in FIG. 12 are shown in a particular order, such need not be the case, and so, such additive operations can be performed in any advantageous order. At this juncture, a determination is made as to whether the bracket guide features generated are to be adjusted manually (1230). If so, the generated bracket guide features are manually adjusted (1240). Additive operations process 1200 can then conclude, or may be looped or returned to the start process to produce additional bracket guides sequentially (as well as in parallel), as will be understood by those skilled in the art.

FIG. 13A is a simplified flow diagram illustrating an example of a rest generation process, according to embodiments of methods and systems such as those disclosed herein. FIG. 13A thus depicts a rest generation process 1300 can be performed to generate one or more bracket guide rests. Rest generation process 1300 begins with the determination as to the bracket guide rest type to be used (based, for example, on the intended location of bracket guide rest) (1310). The appropriate bracket guide rest profile is then selected from bracket guide rest profiles of bracket guide rest type (1315). Examples of posterior and anterior bracket guide rest profiles are depicted in FIGS. 13B and 13C, respectively.

The selected bracket guide rest profile is then positioned with respect to manifold dentition model and its shape modified as appropriate (1320). Examples of such positioning for posterior and anterior bracket guide rest profiles are depicted in FIGS. 13D and 13E, respectively.

The position and/or shapes of the resulting bracket guide rest profiles can then be manually adjusted (1325). If such adjustment is desired, the position and shape of one or more of the bracket guide rest profiles (the bracket guide rest profile position and bracket guide rest profile shape) can be manually adjusted (1330). At this juncture, a determination is made as to whether more bracket guide rests are to be placed/shaped (1335). If so, rest generation process 1300 returns to the determination as to the next bracket guide rest type to be used (1310), and rest generation process 1300 continues.

In the alternative, the selected bracket guide rest profiles, having been positioned and shaped (and possibly, the position and shape of one or more of those profiles having been manually adjusted), can now be extruded to produce bracket guide rest volumes for each of the bracket guide rests (1340). Examples of bracket guide rest volumes are depicted in FIG. 13F.

A remaining bracket guide rest volume can then be generated by removing the volume of intersection between each bracket guide rest volume and the manifold dentition model (1345). The remaining bracket guide rest volumes can then be combined into bracket guide foundation (1350). In one embodiment, posterior rest profiles are extruded by 0.075 mm in both directions, while anterior rests are extruded 0.5 mm in each direction. These rest volumes are then added to the foundation (for example, using a Boolean Union function), and the dental model is subtracted from those volumes using, for example, a Boolean Difference function. Rest generation process 1300 can then conclude, or may loop or return to the start process to produce additional bracket guides sequentially (as well as in parallel), as will be understood by those skilled in the art.

FIG. 13B is a graphical diagram illustrating an example of a posterior bracket guide rest profile, according to embodiments of methods and systems such as those disclosed herein.

FIG. 13C is a graphical diagram illustrating an example of an anterior bracket guide rest profile, according to embodiments of methods and systems such as those disclosed herein.

As is shown in FIGS. 13B and 13C, the requisite rest portions are added to the bracket guide foundation volume to prevent gingival movement. These are also referred to as occlusal stops or occlusal rests. Such profiles can be stored, for example, in a library with different profiles for various posterior rests and anterior rests. As noted, points are placed on the manifold dentition model where the rests should be positioned. The type of the rest (for example, anterior or posterior) can be determined automatically by finding the two closest bracket points. If one of those points is on a bracket associated with a second premolar or molar, then the determination made will indicate the need for a posterior rest, and otherwise, an anterior rest can be placed. To determine the rotation to align with the two teeth, the two closest bracket points are determined and their world quaternion found. Then, the average of the two quaternions were found to determine the rotation of the rest. As noted, the position of the bracket guide rest profiles and/or volumes can also be manually adjusted, as may be needed/desired.

Here again, machine learning techniques such as those described subsequently can be employed to good effect. For example, positioning of the various rests can be initially set using such machine learning techniques, where prior results can be used as the basis for decisions made by the machine learning system in advantageously placing rests based on the number of physical brackets to be affixed, characteristics of the patient's dentition (including size of the oral cavity, age of the patient, the number of teeth affected, and other such considerations), the type of clinical procedure being performed, and/or other such characteristics. As will be appreciate in light of the present disclosure, the span and physical nature of the material will have bearing on such processes. In the event of a multi-head additive printer or dual material resin tray system, a call out for a more rigid or flexible can be used based on geometry of undercut and other tooth anatomy variation including crowding, missing teeth, excessive tipping, and other such factors.

FIG. 13D is a graphical diagram illustrating an example of positioned bracket guide rest profiles, according to embodiments of methods and systems such as those disclosed herein. Depicted in FIG. 13D are several bracket guide rest profiles that have been positioned in accordance with rest generation process 1300. These include an anterior bracket guide rest profile (depicted as an anterior profile 1360) and two posterior bracket guide rest profiles (depicted as posterior profiles 1370(1)-(2)).

FIG. 13E is a graphical diagram illustrating an example of a positioned posterior bracket guide rest profile, in greater detail, according to embodiments of methods and systems such as those disclosed herein. FIG. 13E thus depicts the positioning of posterior profile 1370(1).

FIG. 13F is a graphical diagram illustrating an example of positioned bracket guide rest volumes after extrusion of the respective bracket guide profiles and their addition to the bracket guide foundation volume, according to embodiments of methods and systems such as those disclosed herein. Depicted in FIG. 13F, then, are several bracket guide rest volumes that have been extruded in accordance with rest generation process 1300. These include an anterior bracket guide rest volume (depicted as an anterior rest volume 1380) and two posterior bracket guide rest volumes (depicted as posterior rest volumes 1390(1)-(2)).

FIG. 14A is a simplified flow diagram illustrating an example of a cut generation process, according to embodiments of methods and systems such as those disclosed herein. FIG. 14A thus depicts a cut generation process 1400 that, when executed, generates one or more bracket guide cuts. Cut generation process 1400 begins with the identification of the intended location of the given bracket guide cut with respect to the manifold dentition model (1410). This produces a cut volume that can then be positioned with respect to the appropriate position in relation to the manifold dentition model (1415). Also positioned are one or more loop volumes, which will serve to connect the (separate) portions of the bracket guide foundation (1420).

A determination is then made as to whether the position of the cut volume and loop volume(s) are to be manually adjusted (1425). If so, manual adjustment of the cut volume position and/or loop position can be performed (1430). Here again, machine learning techniques such as those described subsequently can be employed to good effect. For example, positioning of the cuts and loops can be initially set using such machine learning techniques, where prior results can be used as the basis for decisions made by the machine learning system in advantageously placing cuts based on the number of physical brackets to be affixed, characteristics of the patient's dentition (including size of the oral cavity, age of the patient, the number of teeth affected, and other such considerations), the type of clinical procedure being performed, the ease with which sections of the physical bracket guide can be removed from the patient's oral cavity (balancing the number of cuts inserted with the need for structural integrity in the physical bracket guide), simultaneous multiple 3D printing media, and/or other such characteristics, in order to address any specific issues encountered with a given patient.

A determination is then made as to whether more cuts remain to be generated (1435). If so, cut generation process 1400 returns to the identification of the intended location of the next bracket guide cut (1410), and cut generation process 1400 proceeds. In the alternative, the cut volume, having been positioned, can be removed from bracket guide foundation (1440). One or more loop volumes are also added to the bracket guide foundation (for example, as positioned in view of their respective cut volumes) (1445). Cut generation process 1400 can then conclude, or may loop or return to the start process to produce additional bracket guides sequentially (as well as in parallel), as will be understood by those skilled in the art.

Advantageously, such an approach provides for a physical bracket guide that can be inserted into a patient's oral cavity as a single piece, and then easily and efficiently sectioned as physical brackets are affixed to that patient's teeth. Further in this regard, such sections can be stored and reused, should one or more physical brackets need to be reapplied, replaced, or the like. Such an approach maintains the accuracy of such application at a level comparable (or even the same) as that enjoyed by the original application provided by the physical bracket guide. Further still, such an approach can also be used to section the physical bracket guide prior to (or during) the clinical procedure, should the patient's anatomy necessitate such an approach.

FIG. 14B is a graphical diagram illustrating an example of cuts and loops generated by the process of FIG. 14A, according to embodiments of methods and systems such as those disclosed herein.

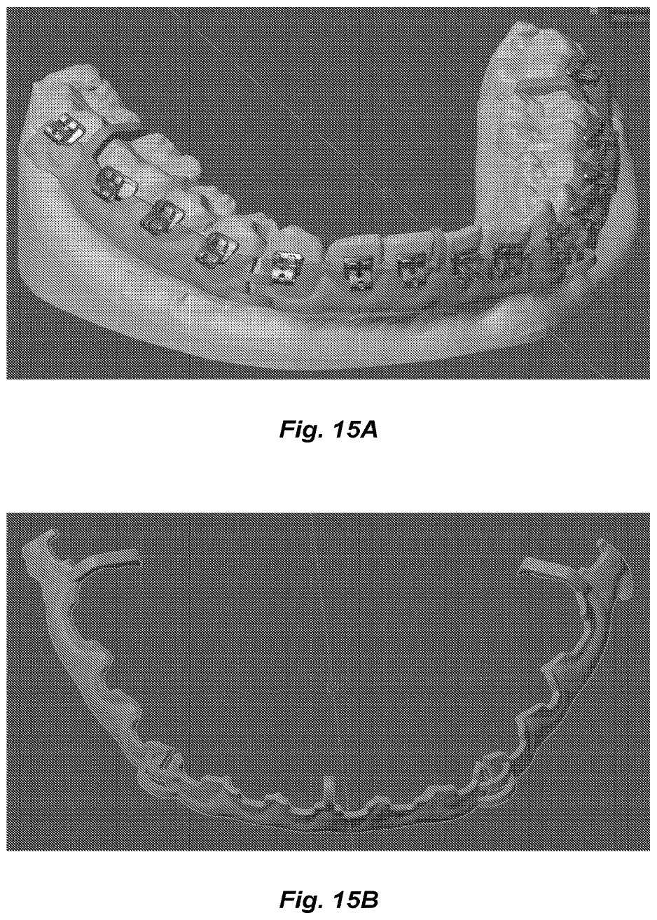

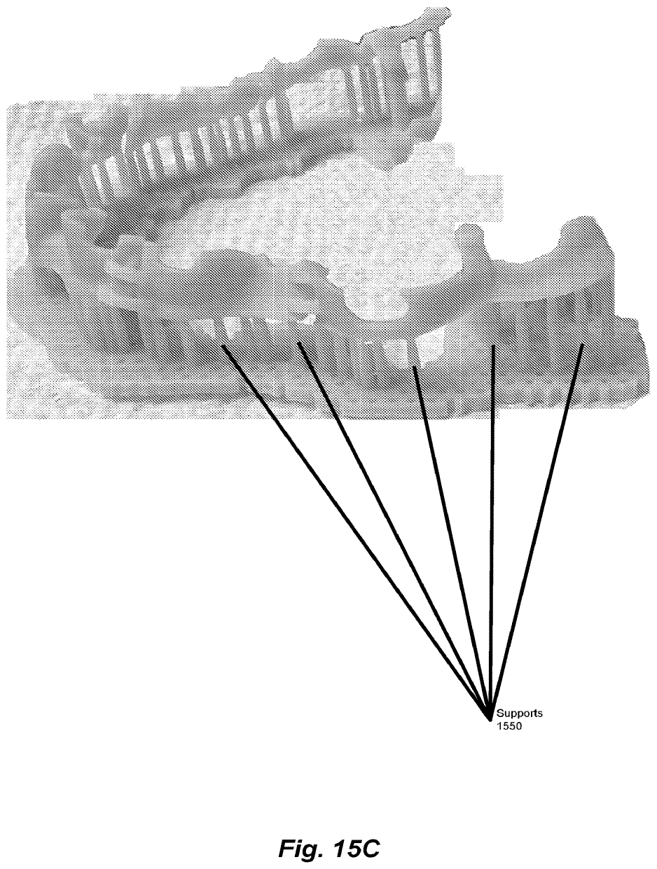

FIG. 15A is a graphical diagram illustrating an example of a digital representation of a bracket guide with bracket model copies and manifold dentition mesh, according to embodiments of methods and systems such as those disclosed herein, with the aforementioned cut volumes removed.

FIG. 15B is a graphical diagram illustrating an example of a digital representation of a bracket guide, according to embodiments of methods and systems such as those disclosed herein.

FIG. 15C is an image illustrating an example of a physical bracket guide, according to embodiments of methods and systems such as those disclosed herein. The physical bracket guide depicted in FIG. 15C is an example of a result of producing the aforementioned digital representation using a three-dimensional (3D) printing process, as noted elsewhere herein. As can be seen, the 3D printing process used in this example positions a number of supports, examples of which are identified as supports 1550.

As will be appreciated, the number and placement of supports such as supports 1550 can have meaningful effects as to manufacturability, cost, and other factors when producing a physical bracket guide in a manner such as that disclosed herein. As will also be appreciated, the physical bracket guide, when produced in this fashion, will need to be separated from such supports. This being the case, a balance between sufficiently supporting the physical bracket guide during production (and the cost of that production) and the amount of work involved in separating the bracket guide from its supports is a consideration. Using machine learning, the number of such guides and their placement can be determined using machine learning techniques such as those described herein. For example, the results of such production can be provided as feedback inputs to such machine learning techniques, to avoid failures in the production of the physical bracket guides, while avoiding the use of more supports than necessary (reducing production costs and simplifying separation of the physical bracket guides from their supports). As noted earlier, this can include the recommendation of a specific material contained in the library of resins or filaments used. These materials can be updated via common update methods as new materials are developed. Such features can also be added to the process described in connection with FIG. 16 (for example, as part of a loop for library lookup of such process features).

FIG. 16 is a simplified block diagram illustrating an example of a positional model generation training architecture, according to embodiments of methods and systems such as those disclosed herein. FIG. 16 thus depicts a positional model generation training architecture 1600, which includes a machine learning training system 1610. Machine learning training system 1610 generates positional model information 1620 and statistical result information 1630. Information from positional model information 1620 and statistical result information 1630 can then be analyzed (for example, as by a model result analysis module 1635 such as that depicted in FIG. 16). Positional model generation training architecture 1600 is thus able to “learn” from the results of the placement of bracket models (for example, as by the efficacy of the placement of physical brackets) and other operations in the generation of bracket guides such as those described herein, and so provide some level predictive capability as to the clinical outcomes that the placement of bracket models and other aspects of the processes described herein can be expected to produce in the placement of physical brackets, while minimizing issues encountered in clinical procedures (for example, misaligned physical brackets, excess adhesive, and other such problems). These and other machine learning analysis operations allow methods and systems such as those described herein to process more positional and other information automatically (without human intervention, nor interpretation thereof, thus needed), thereby resulting in bracket guide generation that is faster, more efficient, and more accurate, than would otherwise be possible in the computerized processing of such information.

In order to generate positional model information 1620 and statistical interaction information 1630, machine learning training system 1610 includes a machine learning (ML) training unit (depicted in FIG. 16 as an ML training unit 1640), which is communicatively coupled to a machine learning model (depicted in FIG. 16 as an ML model 1650) that also can take as input assumptive positional information 1655. In one implementation, ML training unit 1640 is implemented using a multi-layer perceptron (MLP) architecture that employs regularization. As such, ML training unit 1640 can be a feedforward artificial neural network model that maps large sets of input data (for example, information regarding various performance characteristics exhibited by the objects placed, added, subtracted, and so on, in the virtual space in which to the bracket guide is generated) onto a set of appropriate outputs. As will be appreciated in light of the present disclosure, assumptive positional information 1655 can include various (expected) values for various of these positional characteristics. ML training unit 1640 can include multiple layers of nodes in a directed graph, with each layer fully connected to the next. Except for the input nodes, each node in such an architecture acts as a neuron (or processing element) with a nonlinear activation function. As will be further appreciated, MLP techniques can provide salutary effects in the methods and systems such as those described herein due at least in part to the ability of such techniques to solve problems stochastically, which allows approximate solutions to extremely complex problems such as fitness approximations of the positional and other characteristics described herein. Such MLP techniques are well-suited to situations such as those contemplated hereby, at least as a result of the large number of parameters involved in each of the possible factors affecting the positions and other factors in these various circumstances, particularly when interactions between such parameters are considered. That being the case, such solutions can facilitate not only improvements in the prediction of the positioning of the various objects, but also in the efficiency and overall accuracy of the process by which such predictions are reached and implemented.

In the embodiment depicted in FIG. 16, ML training unit 1640 thus receives inputs that include initial positional data 1657 (predefined initial positional information used to “bootstrap” the machine learning process) and positional data 1658 (positional information generated during the use of the ML model). ML training unit 1640 determines the impact of various positional factors on tooth position, and maps information that may affect tooth position as data sets, onto corresponding output sets. Such output sets can include individual parameters, attributes, and other factors that can impact subject behavior, as well as combinations of factors impacting subject behavior. ML training unit 1640 generates a machine learning model (depicted in FIG. 16 as an ML model 1650), and so is communicatively coupled thereto. ML training unit can perform such generation by mapping the aforementioned output sets onto ML model 1650 as an MLP model. In so doing, such mapping of the output sets into the MLP model is dynamic and automatic, and so can be accomplished without human intervention.

That being said, ML model 1650 will typically reflect information such as assumptive positional information 1655, as well as results received from an output of ML training unit 1640. Such information can include information regarding assumptions made with respect to the fit of a bracket model's contact surface with a given tooth contour, the effectiveness of a given bracket model type on clinical outcomes for a given tooth position, the efficacy of certain rest profiles, and other such information reflective of the assumptions made in generating a given bracket guide, as well as the effects of such factors on the generation process itself. One or more constraints may also be set. ML training unit 1640 can then vary one or more configuration parameters, environmental parameters, and/or other parameters to take such constraints into consideration.

ML model 1650 can thus map output sets to generate an MLP model. ML model 1650 will typically include multiple layers of nodes in a directed graph or graphs, with each layer fully connected to the next. This neural network can be used to identify predicted subject behaviors and circumstances that may affect outcomes, and can account not only for the given set of conditions, but also the interactions between such conditions. ML model 1650, having interacted with ML training unit 1640 and having received assumptive positional information 1655, can then be used to produce subject behavior modeling information 1620. As will be appreciated in light of the present disclosure, a determination can be made as to whether subject behavior modeling information 1620 appears to be sufficiently accurate (for example, such that a given threshold for accuracy is met or exceeded). In this manner, a feedback loop of sorts is effected, wherein ML model 1650 can be adjusted based on the sufficiency of positional model information 1620, in order to arrive at a machine learning model that provides the requisite level of confidence in its output.

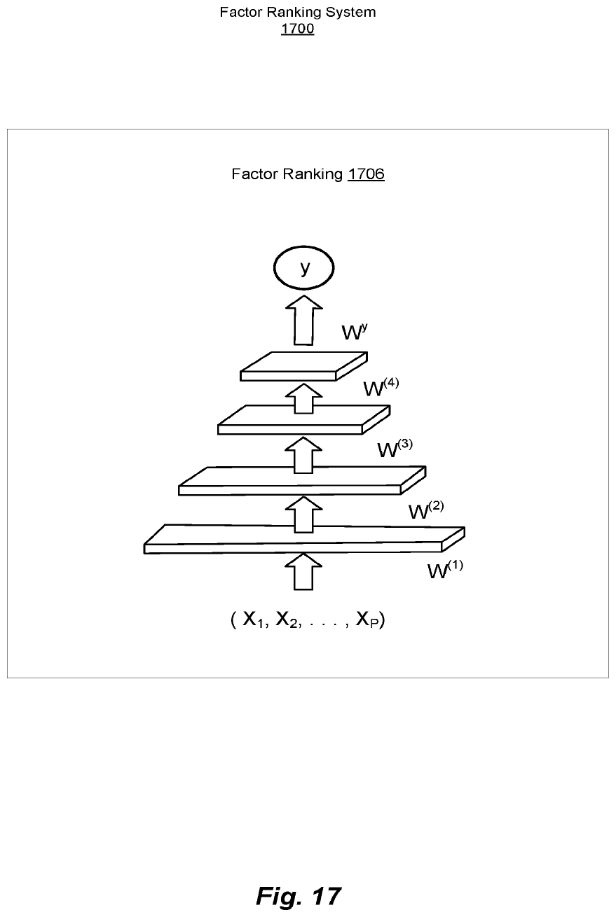

ML training unit 1640 also provides information to a weight-based ranking unit 1660, which uses this information to generate weighting information. Such weight-based ranking is described in further detail in connection with FIG. 17, subsequently. ML training unit 1640 communicates information, such as the impacts on subject behavior that have been determined, to weight-based ranking unit 1660. Weight-based ranking unit 1660 assigns a weight to each parameter based on the parameter's impact on the given characteristic (for example, position) and its effect on patient outcomes. Weight-based ranking unit 1660 can thus assign a weight to each such parameter based on its impact on the physical characteristics of the physical bracket guide produced. Weight-based ranking unit 1660 then compares the effects of such interactions, based on various sets of parameters, and provides these two ML training unit 1640.

Weight-based ranking unit 1660 can, for example, assign a magnitude value of weight based on the impact of a given factor's effect on a given characteristic's expected outcome. A larger weight value is assigned to certain factors (for example, distance between a bracket model's contact surface and the facial surface of the tooth object in question) than other factors (for example, discrepancies in the orientation of that bracket model). The ranking of such factors by weight-based ranking unit 1660 is then performed by interpreting the weights assigned thereto. Weight-based ranking unit 1660 provides these results to a ranking unit 1670.

Ranking unit 1670 ranks the weighted characteristics based on the magnitudes of the weights produced by weight-based ranking unit 1660. Ranking unit 1670 determines a strength for each weighted factor. Thus, a first weighted factor having a larger magnitude than a second weighted factor is assigned a higher order in the ranking. The strengths assigned to the factors produced by ranking unit 1670 can be stored as statistical result information 1630. Statistical result information 1630 thus represents the nature of the various factors as they apply to the given scenario, from statistical perspective.

FIG. 17 is a simplified diagram illustrating an example of a factor ranking system for ranking factors based on weighted factors, according to embodiments of methods and systems such as those disclosed herein. FIG. 17 thus illustrates a factor ranking system 1700 including the ranking factors by interpreting one or more weight components. The ranking of such factors by interpreting weight components assigns weights to each of the attributes or parameters that impact the given subject's behavior, for example. The ranking of such factors using weight components assigns weights to each factor/combination of two or more attributes/parameters that may have a meaningful impact on the ultimate positioning of the patient's teeth. For example, the attributes or parameters can be associated with a given patient in a manner that is more likely to result in acceptable (or better) results. A ranking unit (for example, ranking unit 1670 of FIG. 16) assigns a weight to each such factor for each of the factors. The ranking unit can assign a weight to factors with regard to a given situation (for example, the use of a particular bracket model), but can also consider factors between the attributes, parameters, and other such characteristics of the clinical scenario at hand. Weights are assigned based on the impact of the given attribute(s), parameter(s), factors, and or the like, as well as one or more combinations thereof. Using machine learning systems such as those described herein, the ranking unit is able to rank such attributes, parameters, and their factors based on the assigned weights. The weighted attributes, parameters, factors, and the like, which can be used to rank their impacts on clinical outcomes. A magnitude value can be assigned to the weighted attributes, parameters, and factors, and so the weighted attributes, parameters, and factors can be ranked based on their magnitude values.

For example, as shown in FIG. 17, X₁ can represent the attribute, the parameter, or other factor as an input to the ranking factors by interpreting the weights components shown as part of factor ranking 1706, where I=1, 2, . . . . P. In this example, X₁, X₂, . . . . X_{P} are treated as factors between various combinations of subjects. The variable Y can be treated as the impact on the organizer's and subjects' expected feedback regarding the subgrouping, where Y=1, 2, . . . y. W(1), W(2), . . . . W(y) are thus the weights assigned to the factors according to their impact on this feedback. By assigning the weights to the attributes, parameters, and other factors, changes in such feedback resulting from the effects of various combinations of such attributes, parameters, and other factors can be used by the machine learning system to predict subject behavior for the given factors.

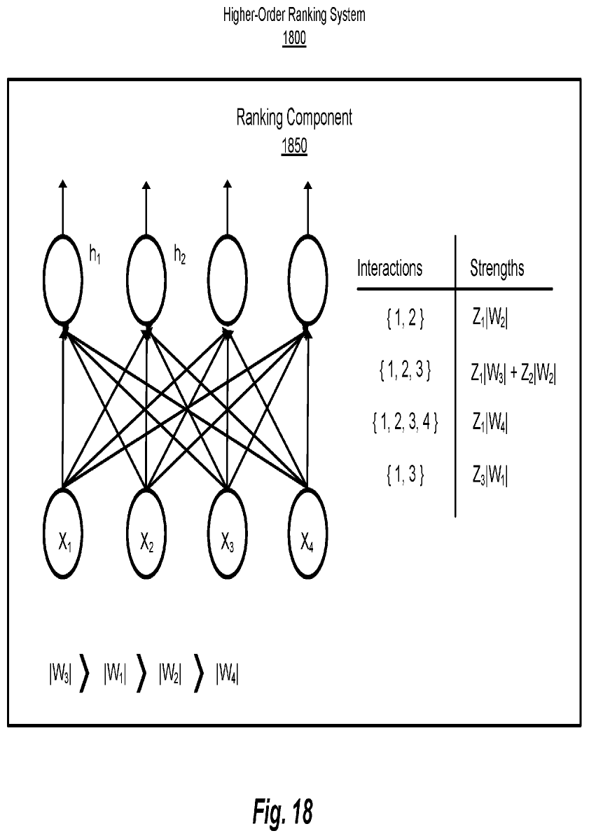

FIG. 18 is a simplified diagram illustrating an example of a higher-order ranking system for ranking attributes, parameters, and other factors, based on their impacts on clinical outcomes, according to embodiments of methods and systems such as those disclosed herein. FIG. 18 thus depicts a higher-order ranking system 1800 that includes a ranking component 1850. Ranking component 1850 ranks the attributes, parameters, and other factors as higher-order interactions based on their strengths (their impacts, individually and in various combinations, on the clinical outcome of the factors under consideration). The attributes, parameters, and other factors are, in this example, treated as the inputs X₁, X₂, X₃, and X₄. For example, the X₁, X₂, X₃, and X₄ inputs can be factors such as the effectiveness of physical bracket placement, excess adhesive encountered, accuracy of placement versus the amount of adjustment available when placing physical brackets, the accuracy of facial axis points, and other such factors. W₁, W₂, W₃, and W₄, in this example, are the weights corresponding to the inputs X₁, X₂, X₃, and X₄. Z, in this example, is a factor applied to the inputs based on the type of the attribute or parameter. Ranking component 1850 ranks the interactions of the inputs X₁, X₂, X₃, and X₄ higher-order interactions (such as h₁, h₂, . . . ) based on the strengths, such as the magnitude value of the impact on the subject behavior.

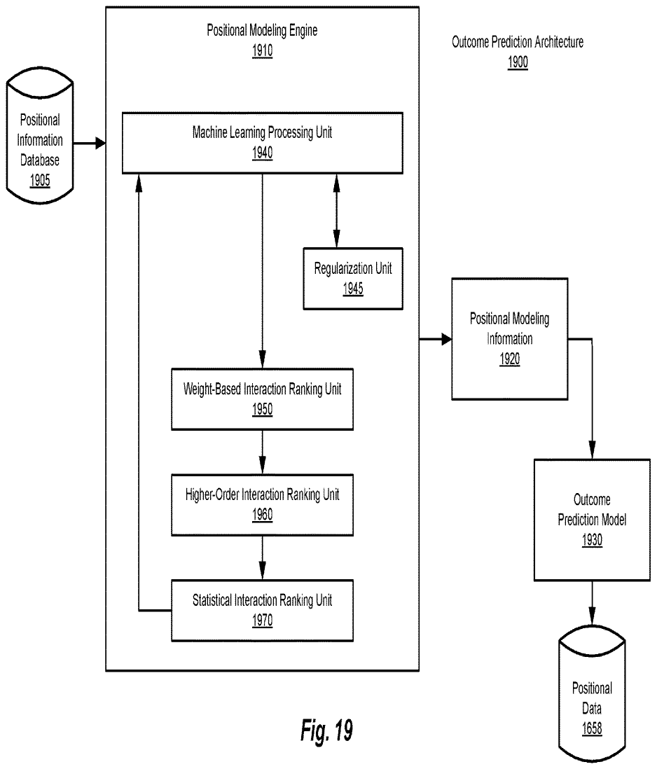

FIG. 19 is a simplified block diagram illustrating an example of an outcome prediction architecture, according to embodiments of methods and systems such as those disclosed herein. FIG. 19 thus depicts an outcome prediction architecture 1900. As will be appreciated in light of the present disclosure and FIG. 19, outcome prediction architecture 1900 can be implemented, for example (and more specifically), as a multi-layer perceptron (MLP) machine learning architecture. Information from a positional information database 1905 provides information such as proposed positions of bracket model copies, volumes of subtractive operations, volumes of additive operations, and the like, to a positional modeling engine 1910. In turn, positional modeling engine 1910 produces positional modeling information 1920 (which can itself be, for example, an MLP model). Results from the processing of positional modeling information 1920 can then be made available as an outcome prediction model 1930. Outcome prediction model 1930 can then be used to inform the placement of bracket model copies and other such items, as well as other such operations, in the generation of a bracket guide such as that described herein, in order to provide outcome predictions, what-if analyses, and other functionality advantageous to users of such systems.

In order to produce the requisite information for ingestion as outcome prediction model 1930, positional modeling engine 1910 includes a machine learning processing unit 1940, which can be implemented, for example, as a multi-layer perceptron (MLP) processing unit. Machine learning processing unit 1940 is coupled to communicate with a regularization unit 1945. Regularization unit 1945, in certain embodiments, implements a process of adding information to that received by machine learning processing unit 1940, in order to address problems with insufficiently defined information (in positional modeling engine 1910, for example, a lack of certain measurements, factors with excessive variability, and the like) and/or to prevent overfitting (the production of an analysis that corresponds too closely or exactly to a particular set of data, and may therefore fail to fit additional data or predict future observations reliably; in positional modeling engine 1910, for example, scenarios in which machine learning model 1920 would otherwise be tied too closely to a given factor such that the model's overdependence on that factor would result in an unacceptably high sensitivity to changes in that factor, as between a given factor that might vary widely as between clinical scenarios (for example, for a given set of conditions, certain characteristics might vary to a relatively large extent, but not be especially determinative with respect to the actual clinical outcomes; thus, a scenario in which such characteristics closely followed outcomes as a matter of happenstance, might otherwise prove problematic to the prediction of outcomes)). For example, an MLP network with large network weights can be a sign of an unstable network, where small changes in the input can lead to large changes in the output. This can be a sign that the network has “over fit” the training dataset, and so is more likely perform poorly when making predictions on new data. A solution to this problem is to update the learning algorithm to encourage the network to keep the weights small. This is called weight regularization and it can be used as a general technique to reduce overfitting of the training dataset and improve the generalization of the model. As will be appreciated in light of the present disclosure, given the potential for wide variability in factors such as organizer and subject goals, subject feedback, subject attributes, and other such factors, the benefits of regularization in applications such as those described herein will be evident.

In support of the generation of subject positional modeling information 1920 (and so, outcome prediction model 1930), ML processing unit 1940 also produces information that is communicated to a weight-based interaction ranking unit 1950. Weight-based interaction ranking unit 1950 generates weight-based interaction ranking information, that is, in turn, provided to a higher-order interaction ranking unit 1960, for purposes and to effect such as those described earlier. In turn, having generated higher-order interaction ranking information, higher-order interaction ranking unit 1960 communicates such information to a statistical interaction ranking unit 1970. In so doing, positional modeling engine 1910 is able to appropriately weight relevant factors, and produce statistical information that allows positional modeling information 1920 to be used more accurately and in a more meaningful fashion when generating a bracket guide according to the present disclosure. In so doing, such positional information can be used in a manner that avoids uncontrolled swings in outcome predictions that might otherwise be produced using positional modeling information 1920. Ultimately, unwanted variations in the outcomes predicted by outcome prediction model 1930 are avoided.

### Implementations of an Orthodontic Bracket Placement Guide

As noted earlier, accurate bracket placement is the foundation for improved treatment outcomes. It was championed particularly for straightwire orthodontics that was introduced in the early 1970s by Dr. Lawrence Andrews. The need for wire bending was theoretically reduced, if not replaced, by brackets with built-in prescriptions that would move teeth into their ideal desired positions in all three planes of space according to Andrews' Six Keys. Techniques that increase the ease of achieving ideal bracket placement not only improve patient outcomes, but can also decrease chair time by decreasing the number of bends required in the wire, bracket repositions, and improve patient comfort and decrease treatment time.

Indirect bonding (IDB) is one such method of increasing accuracy in bracket positioning while concurrently increasing clinical efficiency and improving the patient experience. IDB was first introduced in 1972 by Silverman et al., who described the technique of fabricating a transfer core of compressed plastic fitted over a brackets fixed by cement to a plaster model. Technological advancements alongside refinement of the technique have improved the way IDB is accomplished. With the advent of the fully digital workflow, IDB is gaining traction and popularity in practice as it becomes easier, less time-consuming to perform, and more predictable in outcome.

This example involves a novel system for improved accuracy in bracket placement that takes the advantages indirect bonding offers with digitally planned bracket placement, reduced chair time, a fully digital, in-house workflow, and while providing advantages of direct bonding, such as increased visibility and ease of cement removal.

The null hypotheses of the example were as follows:
1. No significant difference existed between the positions of the digitally planned control brackets and the experimental brackets bonded using the 3D printed guides.
2. Accuracy of bracket placement using the 3D printed guide was not affected by the amount of arch length discrepancy exhibited by the model.
3. Accuracy of bracket placement using the 3D printed guide was not affected by tooth type.

Models were categorized according to arch length discrepancy (ALD) in a previous example and split into three groups on this basis. Each of the three groups included ten unique mandibular models:
Group 1: ALD<3 mm
Group 2: 3 mm≤ALD<6 mm
Group 3: ALD≥6 mm

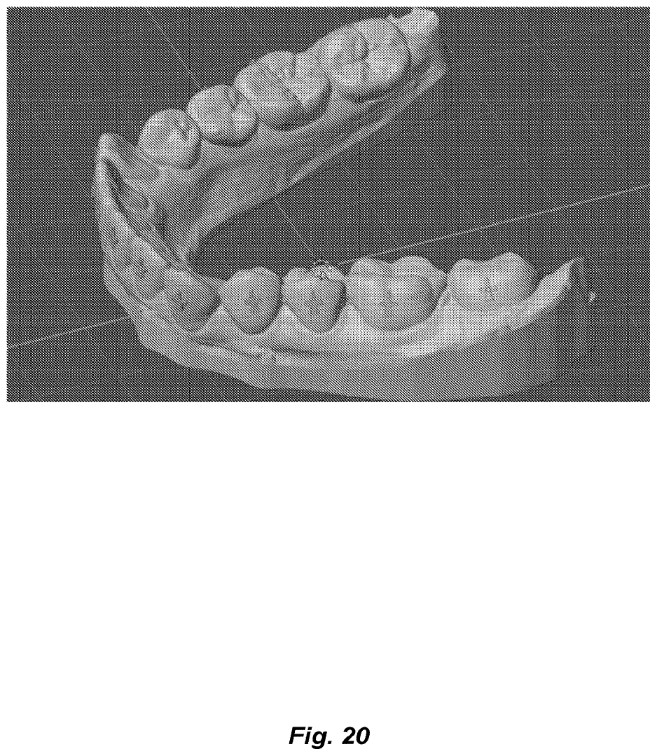

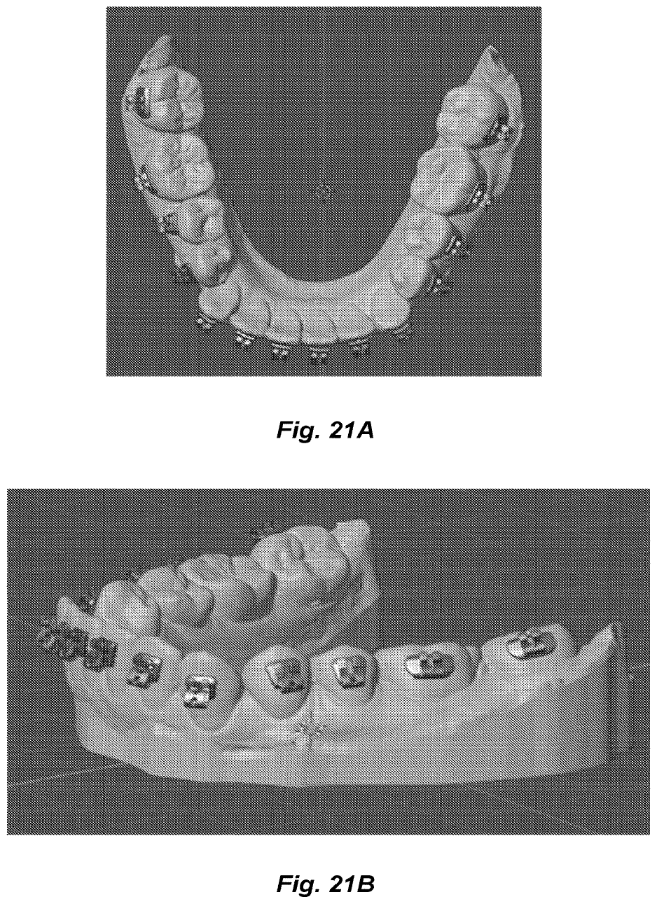

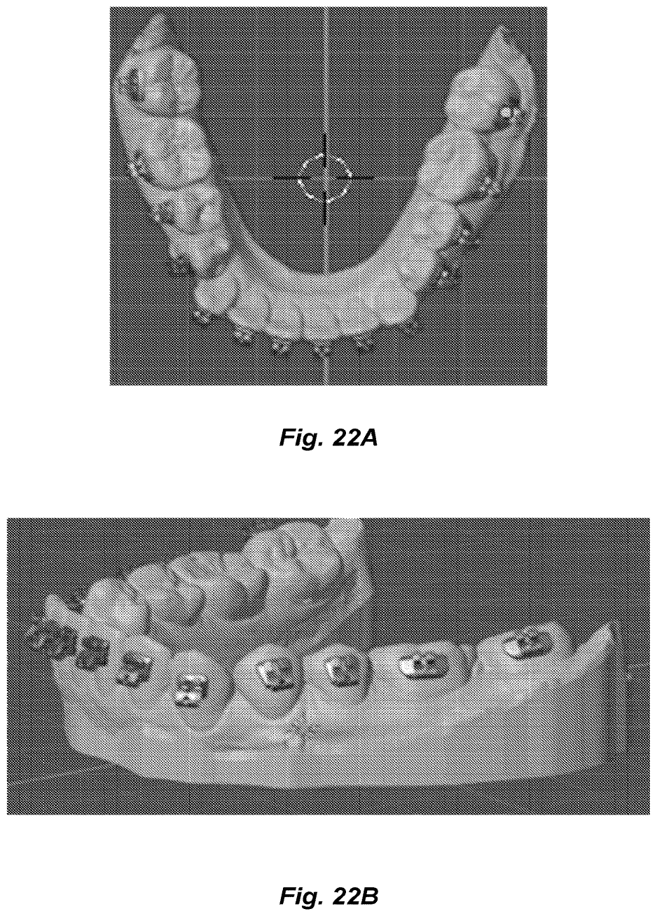

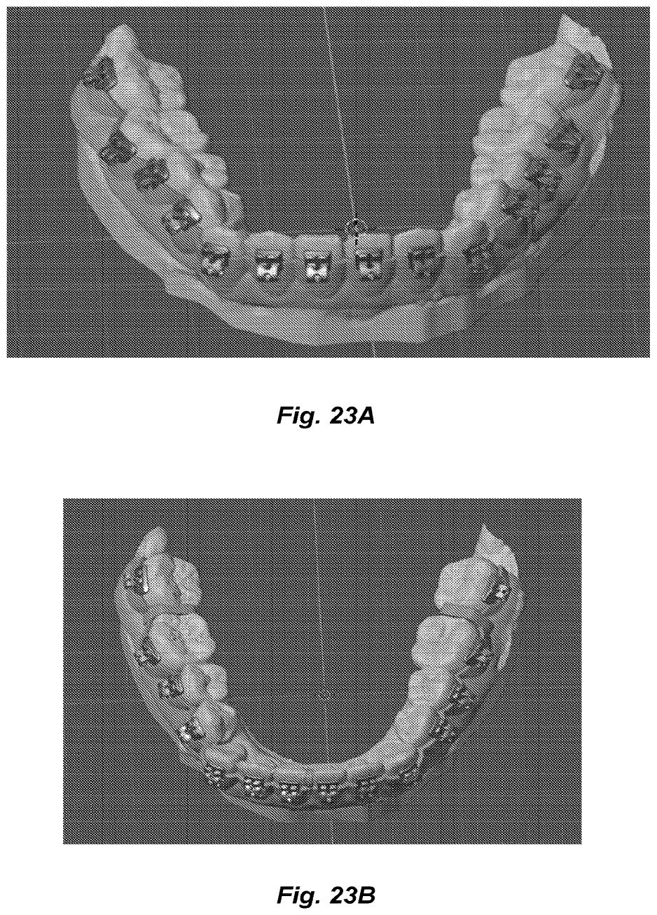

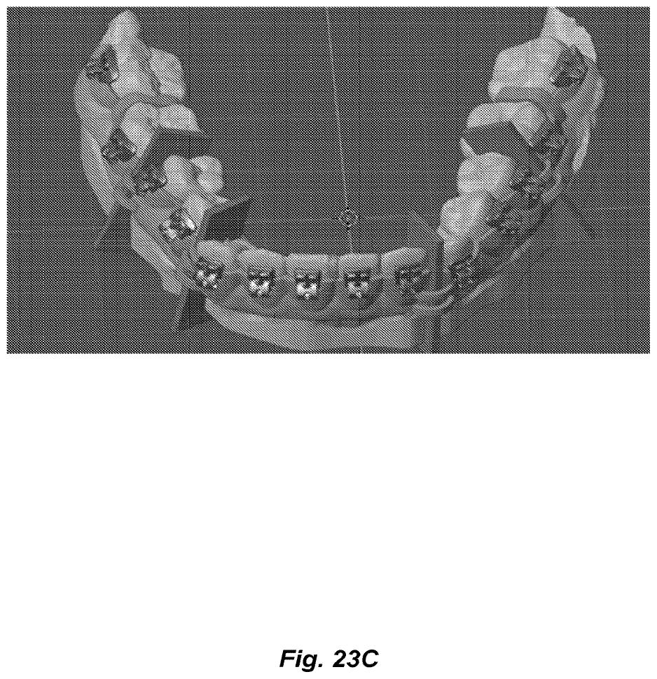

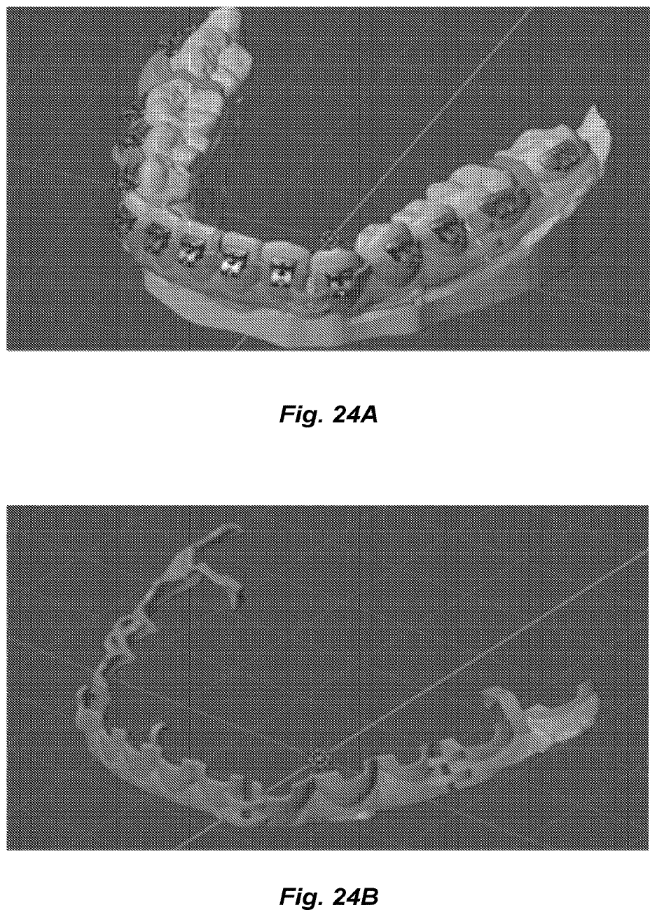

A customized plug-in module was created for use in open-source BLENDER software (Blender Foundation, Amsterdam, Netherlands, version 3.0.1). Each model was imported as an “.still” file (referred to herein as an STL file). The model was selected and the custom plug-in was chosen. Facial axes of each tooth were selected, followed by bracket placement (FIG. 20). Brackets were manipulated in three dimensions to achieve the desired position (FIGS. 21A and 21B). Brackets were then adapted to the surface of each tooth for improved fit according to the software's algorithm (FIGS. 22A and 22B). Fit could be manually checked for any issues with adaptation and if found, models were reverted to the previous step to adjust bracket position. Once brackets were appropriately placed, the gingival margin of the guide was drawn and “Create Mask” was selected, allowing the software to generate the custom guide to fit the model and brackets (FIG. 23A). Guides were checked for adaptation and undercuts in the guide were identified that could create issues with ease of removal after bonding. Occlusal rests were placed and adjusted bilaterally in the posterior on the occlusal embrasure between the first and second molars (FIG. 23B). Anteriorly, a single rest was placed in the canine-to-canine segment in the least crowded area available. Guide break points and cuts were manually placed and adjusted to help prevent undercuts and difficulty in removing the guide after bonding of the brackets (FIG. 23C). A minimum of three cuts were placed on each model, with additional cuts being added in the more crowded models of ALD Groups 2 and 3. Some models had up to five cuts placed, meaning the guide could be removed in six smaller segments with the goal of reducing bond failure due to excessive forces being placed on brackets during guide removal. The final step in the digital processing of the guides was to export the guide file as an STL in preparation for 3D-printing (FIGS. 24A and 24B).

STL files of non-bonded models and guides were imported the appropriate software to prepare for performing the 3D printing process. Models and guides were placed for best fit on the digital build plate prior to being sent to the printer for production. Supports were automatically added and adjusted to the guides, and the files were sent to the printer. Models were printed with a flat base and did not require the addition of supports for proper printing. Models and guides were printed with a 3D-printing unit. Models and guides were washed in an ultrasonic bath containing 100% isopropyl alcohol for three minutes, thoroughly dried with an air syringe, and then washed again for two minutes. Models and guides were again dried with an air syringe, placed in the water bath and cured according to manufacturer specifications for twelve minutes.

Post-curing, models and guides were removed from the water bath, air dried and checked for any printing errors or issues. Supports were carefully removed from the guide using finger pressure or a ligature cutter. Each guide was inspected for rough spots or areas where tissue impingement could occur and prevent full seating of the guide on the model. Interferences and rough spots were carefully removed or smoothed using an electric countertop high speed with an acrylic football bur. Guides were then matched to their corresponding model and fit was evaluated.

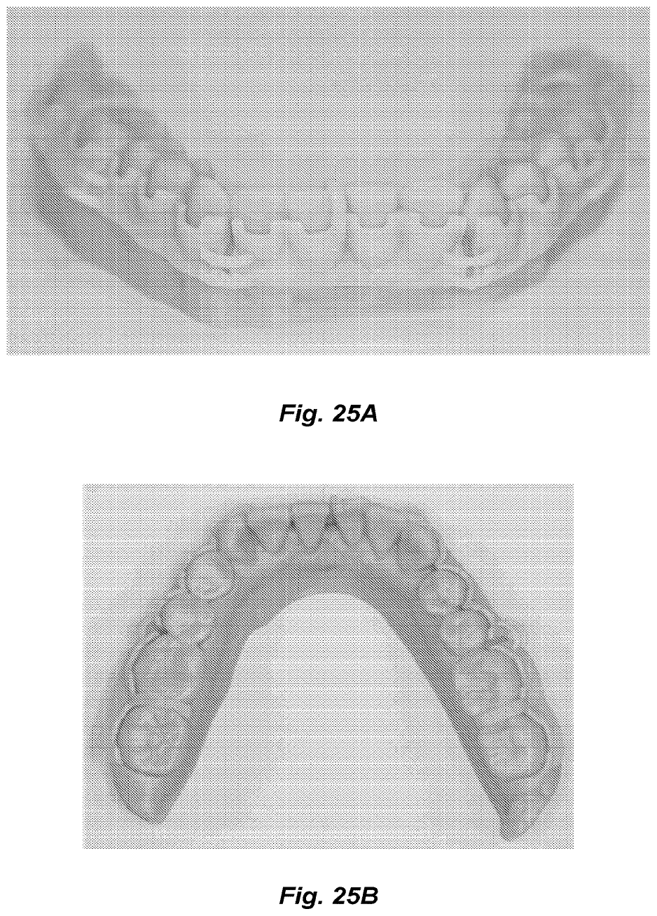

For every model, each tooth was sandblasted for five to ten seconds to roughen the surface for bonding, rinsed, and then allowed to air dry at least 24 hours prior to bonding. The intaglio surface of each guide was sprayed with CRC® Food Grade Silicon Spray (CRC Industries Americas Group, Horsham, PA). Guides were then allowed to dry 24 hours prior to being placed back on the corresponding model (FIGS. 25A and 25B). Adenta Triamond™ (Adenta GmbH, Gilching, Germany) passive self-ligating brackets were placed on bracket cards and the doors were adjusted to their closed position prior to bonding.

Assure Plus All Surface Bonding Resin™ (Reliance Orthodontic Products™, Itasca, IL) was applied to each area to be bonded, lightly air-dried in the incisal or occlusal direction with an air syringe, and light cured for three seconds with a 3M™ Ortholux™ Luminous Curing Light (3M™, Maplewood, MN). Transbond™ XT Light Cure Adhesive Paste (3M™ Unitek, Monrovia, CA) was applied to the bracket and lightly impressed into the grooves with a gloved finger to ensure an even layer of paste was present on the bracket. The bracket was placed from gingival to incisal or occlusal with tissue forceps to extrude any excess adhesive to the incisal or occlusal and allow for ease of removal and to prevent displacement of the guide. Excess Transbond™ was removed with a scaler prior to curing. The bracket was light cured for nine seconds. This process was repeated for each tooth in every model. A total of 420 brackets were bonded. Brackets were placed from lower right second molar (LR7) to lower left second molar (LL7). During the bonding procedure the guide was held in place in the posterior with light finger pressure at the occlusal rests as needed.

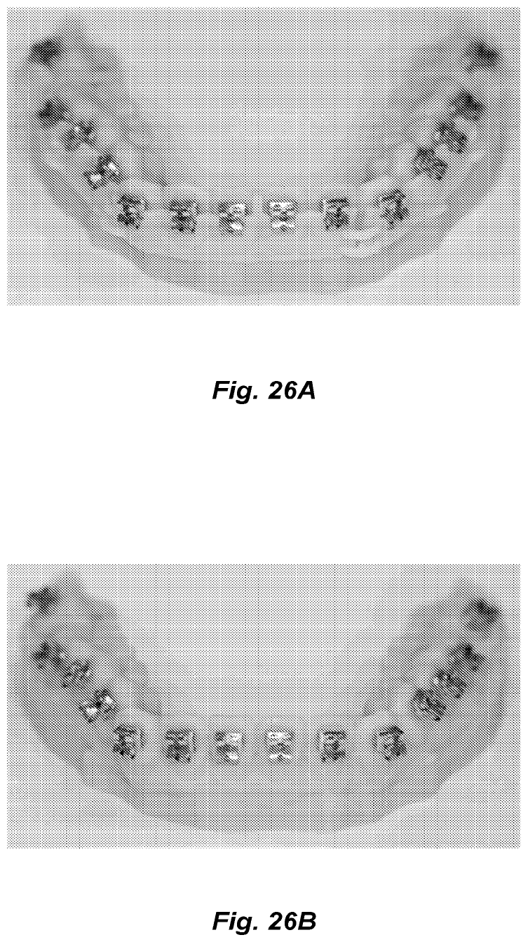

Once all teeth were bonded on a model, the guide was cut at the loops, gingival first, then incisal or occlusal, and from right to left, and the subsequent pieces of the guide were removed from the model (FIGS. 26A and 26B).

Experimental models were sprayed with AESUB White™ 3D Scanning Spray (AESUB™, Dortmund, Germany) to reduce reflectivity of the metal bracket and scanned using the TRIOS™ Intraoral Scanner (3Shape™, Copenhagen, Denmark). Scanning was performed in the same manner for each model beginning with the occlusal surface, followed by the lingual, and finally facial. Scanning of the facial surface started at the occlusal, followed by facial, mesial and distal, and finally the gingival portion of the bracket. Due to limitations of scanning file size, the most images and time were spent scanning the brackets to improve resolution of the brackets. Files were then exported and saved as STLs.

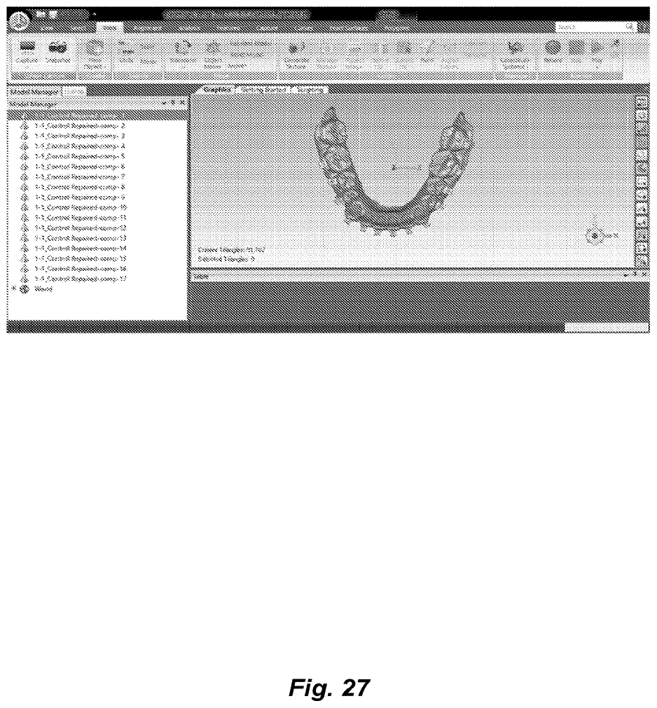

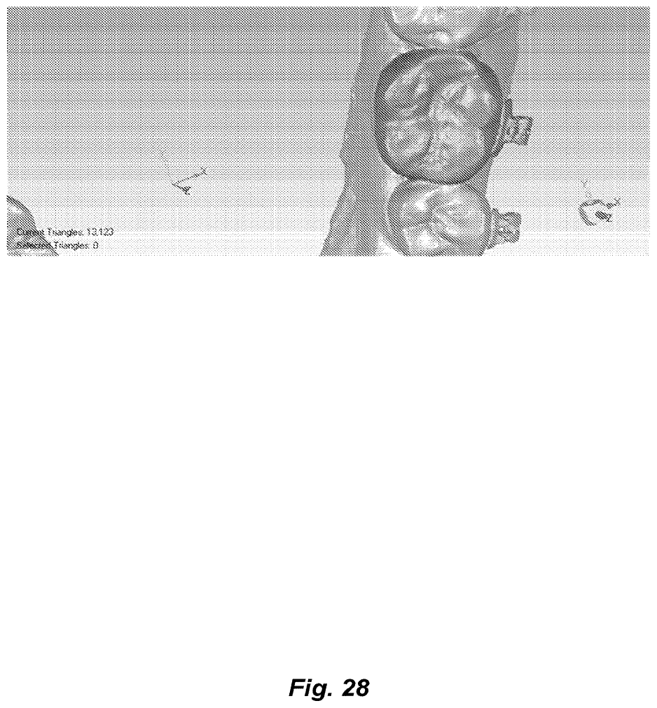

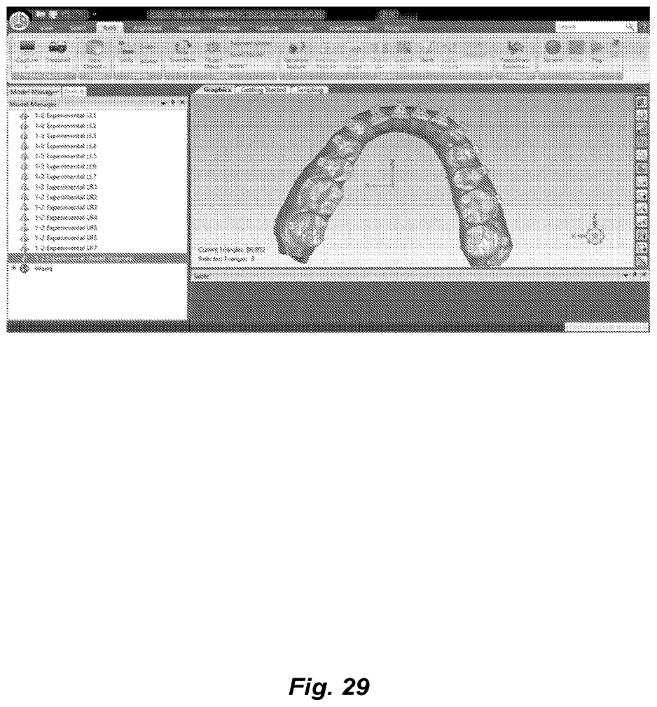

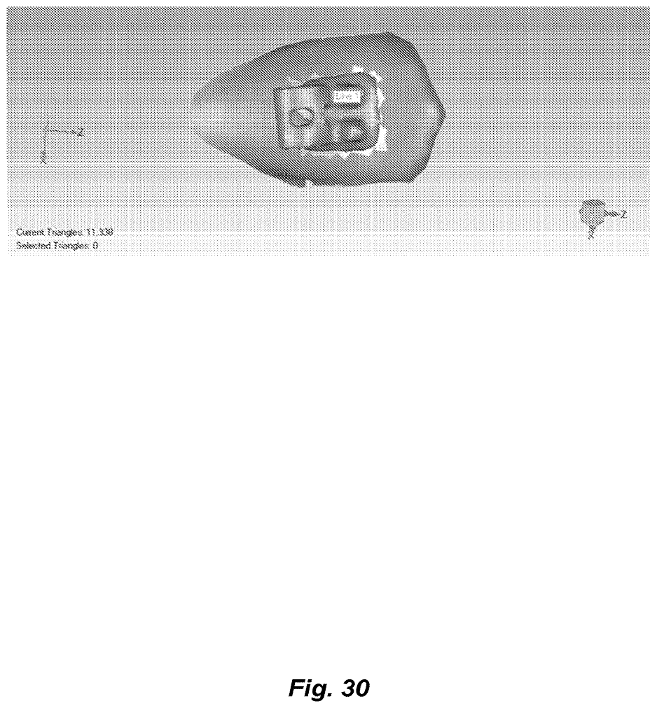

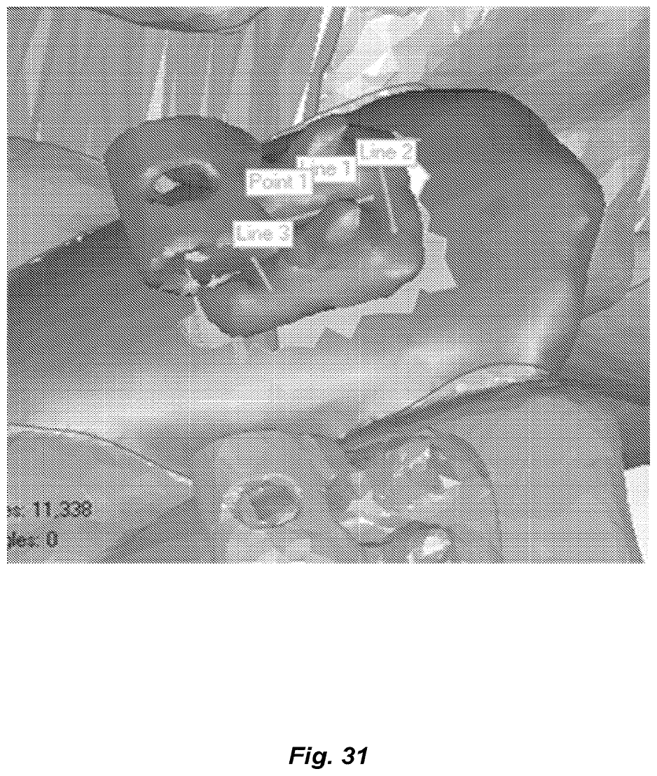

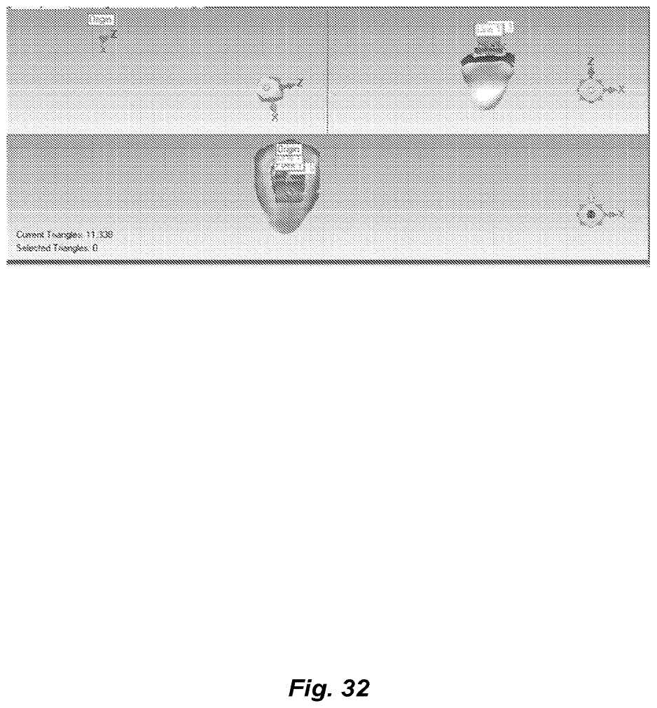

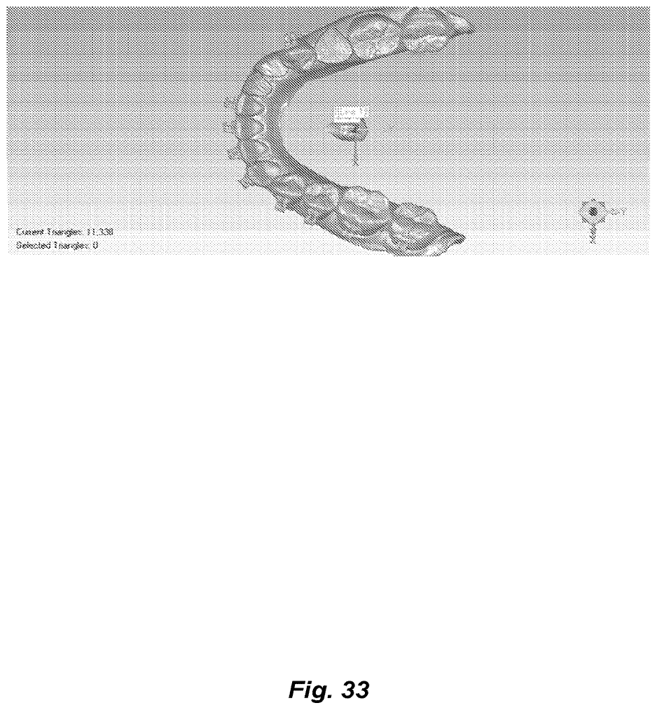

Geomagic™ Wrap software (3D Systems™, Rockhill, South Carolina) was used to compare and analyze experimental brackets that were placed using the 3D-printed guide to the positions of the digitally placed control brackets. Control models were imported to Geomagic™ Wrap software. Due to the extensive number of triangles that Blender software produces when files are exported in the STL format, the “Decimate” feature was used to reduce the number of triangles from 1.2 million to 200,000 to allow the software function properly in the subsequent stages of file manipulation. Once the reduction in file size was complete, the models were broken down into components, so that the teeth could be adequately sectioned from the whole model and paired to the appropriate bracket (FIG. 27). “Trim with Curve” was used to segment each individual tooth, after which the appropriate bracket was matched, and the “Merge” function was used to pair the two into a single working unit (FIG. 28). A fully sectioned control model was thus formed (FIG. 29). Each bracketed control tooth had 3 lines added from the “Features” tab to indicate the x-, y-, and z-axes. A straight edge lined up with the computer screen was utilized to help ensure the points of each line were parallel to the desired axes and stable reference points. Lines were created using a two-point method and were directional in nature. Line 1 was created with points in the gingival to incisal or occlusal direction (FIG. 30). Line 2 was created with points in the mesial to distal direction on the lower left and distal to mesial direction on the lower right. Line 3 was created with points in the lingual to facial direction. This procedure was used to maintain a consistent directionality for analysis of bracket position regardless of location of the tooth on the model. A single point was placed to indicate the origin of each bracketed tooth at a central point between the bracket door and tie wings (FIG. 31). These were then each aligned to the universal coordinate system within the program via the “Align to World” feature (FIG. 32). Line 1 was designated to pair with the y-axis, with positive direction from gingival to incisal/occlusal; Line 2 was paired with the x-axis, with positive direction from left to right when looking directly at the bracket from the facial; Line 3 with the z-axis, with the positive direction from lingual to facial; and Point 1 with the origin centered in the bracket. Arrows indicated the positive direction of each axis. This allowed for consistency in the reference system for analysis (FIG. 33).

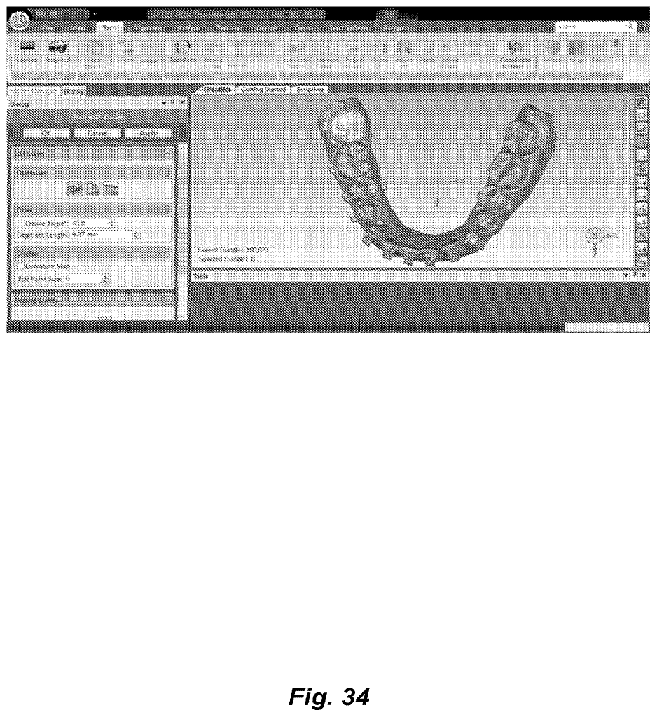

Experimental models were similarly imported into Geomagic™ Wrap software. The STL files created through scanning of the models were appropriately sized for use in the analysis software without further reduction in the number of triangles as was required for the control models. The “Mesh Doctor” function was used to clean up the models and reduce issue with the segmentation of individual teeth. “Trim with Curve” was used to segment each bracketed tooth (FIG. 34). These were then ready for comparison and analysis against the control models.

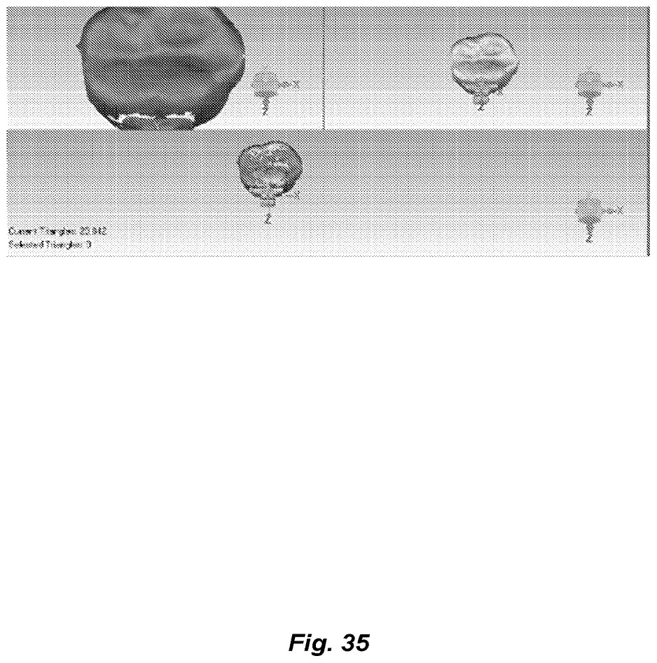

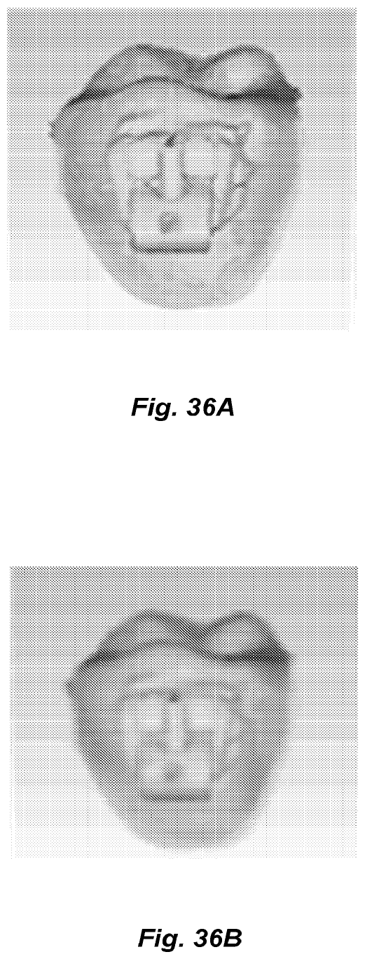

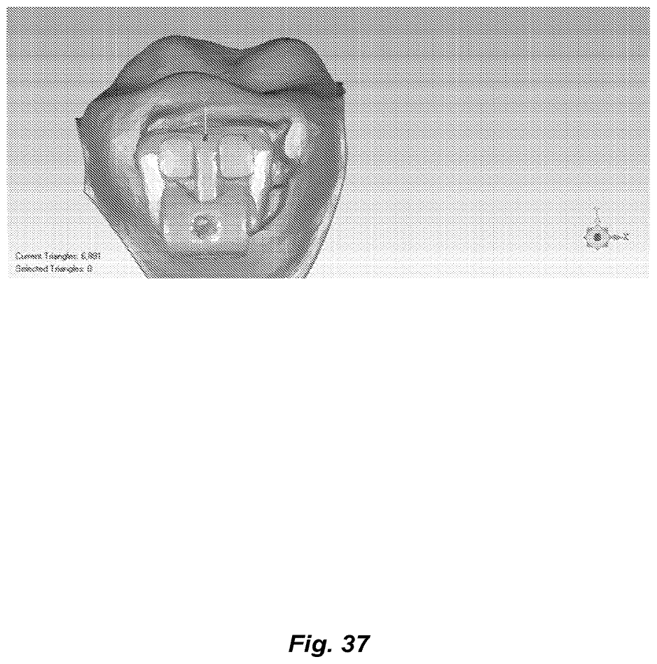

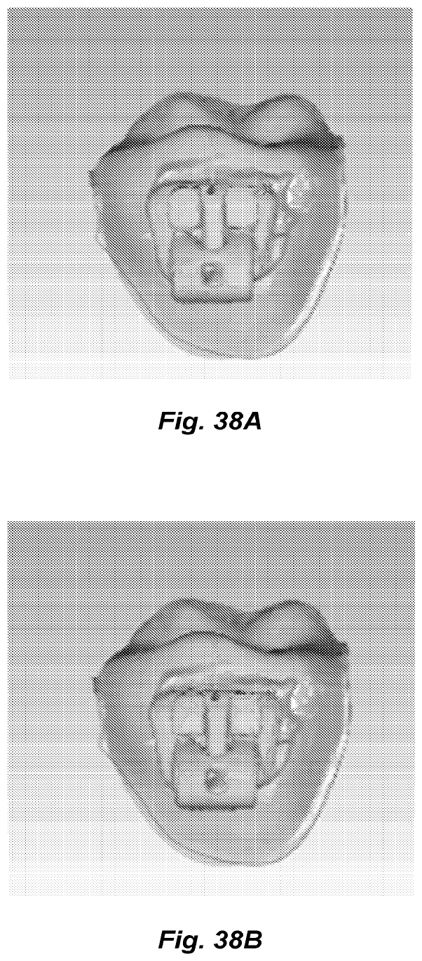

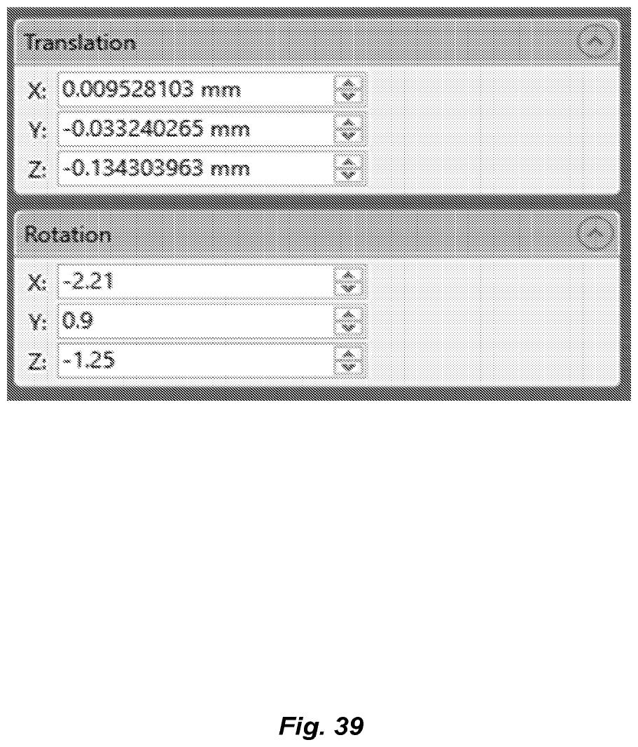

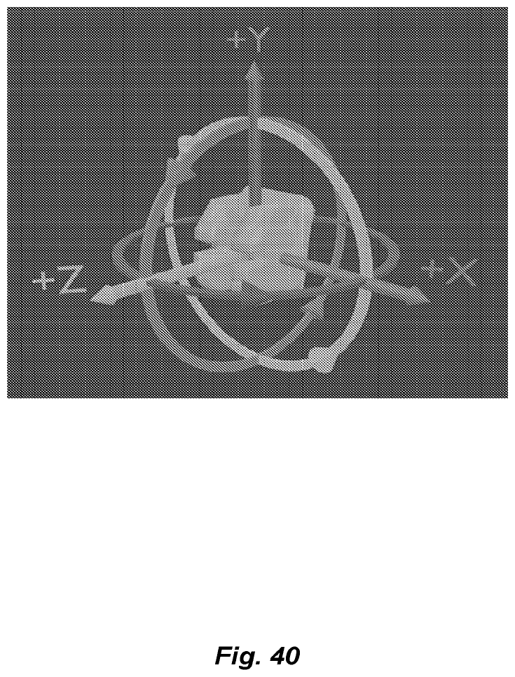

The selected control tooth for analysis was “pinned” and its corresponding experimental tooth were both highlighted. “Manual Registration” was used to align the control and experimental bracketed teeth selecting stable landmarks on tooth structure only (FIG. 35). Easily recognized stable landmarks were found on the occlusal, incisal, or lingual aspects of the teeth. “Global Registration” was then used to finalize the alignment of the pair of bracketed teeth (FIGS. 36A and 36B). “Trim with Curve” was again used to segment the experimental bracket from its tooth (FIG. 37). The resulting bracket file was then put through “Reorient Model” feature to zero out its transformation table. Finally, the bracketed control tooth and the corresponding experimental bracket were selected, and the “Global Registration” feature was chosen (FIGS. 38A and 38B). The “Transformation” option showed the resulting data from the linear and angular movements required to align the experimental bracket to the control bracket in the Transformation Table (FIG. 39). This data was recorded into a spreadsheet according to the clinical interpretation of each linear and angular discrepancy for analysis (FIG. 40). Clinical interpretations of linear (translational) and angular (rotational) movements are shown in Table 1. This procedure was repeated for each tooth. A total of 402 brackets were analyzed.

TABLE 1
Clinical Interpretation of Linear and
Angular Movements in Three Dimensions

| Dimension | Clinical Interpretation |
|---|---|
| X Translation | Mesial-Distal |
| Y Translation | Occlusal-Gingival |
| Z Translation | Facial-Lingual |
| X Rotation | Torque |
| Y Rotation | Rotation |
| Z Rotation | Angulation |

In summary, the following data were collected:
1. Linear (mesial-distal, occlusal-gingival, facial-lingual) bracket discrepancy in the x, y, and z planes in mm
2. Angular (torque, angulation, rotation) discrepancy around the x, y, z axes in degrees

Statistical analysis was performed using jamovi v2.2.5 (the jamovi project, Sydney, Australia). Intra-examiner reliability was evaluated by performing double measurements on ten models three weeks apart and expressed as the intraclass correlation coefficient (ICC). The data is not normally distributed, therefore non-parametric analyses were performed. The Wilcoxon signed-rank test was performed and measurements were evaluated against the standard of 0.5 mm for linear discrepancies and 2° for angular discrepancies. The Kruskal-Wallis test and Dwass-Steel-Critchlow-Fligner Pairwise comparisons were used to evaluate for differences among tooth type (Incisor, Canine, Premolar, and Molar) and ALD groups. Prevalence of clinically acceptable bracket positions and directional bias were also calculated. All testing was performed at a significance level of α<0.05.

A total of 420 brackets were bonded to 30 unique, 3D printed resin models which were selected according to the example's inclusion/exclusion criteria. Eighteen brackets debonded during guide removal, representing a 4% bond failure rate. Therefore, 402 brackets were analyzed and compared for positional discrepancies. ICC was calculated to indicate intra-examiner reliability and confirmed excellent repeatability for bracket discrepancy measurements (0.999, Table 2).

TABLE 2
Intraclass Correlation Coefficient for Linear
and Angulation Measurements in Three Dimensions

| Dimension | Intraclass Correlation |
|---|---|
| X Translation | 0.999 |
| Y Translation | 0.999 |
| Z Translation | 0.999 |
| X Rotation | 0.999 |
| Y Rotation | 0.999 |
| Z Rotation | 0.999 |

The Wilcoxon signed-rank test showed statistically significant differences between planned bracket positions and experimental bracket positions for linear measurements in all dimensions (p<0.001). For angular measurements, no significant difference between planned and experimental bracket positions was demonstrated by the Wilcoxon signed-rank test (p=1.00).

Directional and absolute (ABS) means of linear and angular discrepancy measurements are shown in Table 3. Raw mean data is referred to as “directional”, as the positive or negative denotes a directional trend in each dimension. This directional data was also converted to absolute values to examine the overall magnitude of error in each dimension. These are referred to as “absolute” (ABS).

TABLE 3
Linear and Angular Discrepancy Means

| | Directional | ABS |
|---|---|---|
| Dimension | Mean ± SD | Mean ± SD |
| Mesial-Distal (mm) | −0.0130 ± 0.142 | 0.0604 ± 0.129 |
| Facial-Lingual (mm) | −0.1002 ± 0.195 | 0.1094 ± 0.190 |
| Occlusal-Gingival (mm) | −0.0672 ± 0.142 | 0.0886 ± 0.130 |
| Torque (°) | −0.952 ± 2.59 | 1.78 ± 2.11 |
| Angulation (°) | 0.447 ± 2.19 | 1.52 ± 1.64 |
| Rotation (°) | 0.106 ± 1.74 | 1.13 ± 1.33 |

The prevalence of brackets with linear discrepancies less than 0.5 mm in the sample of 402 brackets was greater than 98%. The prevalence of brackets with clinically acceptable angular discrepancies less than 2° for torque was 71.4%, 77.4% for angulation, and 85.6% for rotation (Table 4).

TABLE 4
Prevalence of Clinically Acceptable Bracket Positions (linear
discrepancy <0.5 mm, angular discrepancy <2°)

| Dimension | % (n = 402) |
|---|---|
| Mesial-Distal | 99 |
| Facial-Lingual | 98 |
| Occlusal-Gingival | 98.8 |
| Torque | 71.4 |
| Angulation | 77.4 |
| Rotation | 85.6 |

The frequency of directional bias in each dimension was also calculated from the mean discrepancy data (Table 5). Positive (“+”) and negative (“−”) experimental bracket positions are clinically correlated to different resulting clinical movement depending on the location of the tooth in the model, right versus left side as all brackets were aligned to the same directionality regardless of sidedness (Table 6).

TABLE 5
Frequency of Directional Bias Expressed as Percentage (n = 402)

| Dimension | + | − |
|---|---|---|
| Mesial-Distal | 39.1 | 60.9 |
| Facial-Lingual | 17.4 | 82.6 |
| Occlusal-Gingival | 20.4 | 79.6 |
| Torque | 33.6 | 66.4 |
| Angulation | 55.7 | 44.3 |
| Rotation | 52.7 | 47.3 |

TABLE 6
Clinical Interpretation of Discrepancies and Resulting Tooth Movement

| | Clinical Interpretation | | | |
|---|---|---|---|---|
| | + | + | − | − |
| | Right Side | Left | Right | Left |
| Mesial-Distal | Distal | Mesial | Mesial | Distal |
| Occlusal-Gingival | Occlusal | Occusal | Gingival | Gingival |
| Facial-Lingual | Facial | Facial | Lingual | Lingual |
| Torque | Lingual Root | Lingual Root | Buccal Root | Buccal Root |
| | Torque/Buccal | Torque/Buccal | Torque/Lingual | Torque/Lingual |
| | Crown Torque | Crown Torque | Crown Torque | Crown Torque |
| Rotation | Mesial-in | Distal-in | Distal-in | Mesial-in |
| Angulation | Mesial Root Tip | Distal Root Tip | Distal Root Tip | Mesial Root Tip |

Comparing absolute mean discrepancies among ALD Groups (Groups 1-3) using the Kruskal-Wallis test, a statistically significant difference was noted among groups in the facial-lingual dimension (p=0.014, Table 7). Dwass-Steel-Critchlow-Fligner pairwise comparisons revealed that the lowest ALD group, Group 1, had a statistically significantly higher facial-lingual mean discrepancy than the highest ALD group, Group 3. No statistically significant differences among any groups were found in the mesial-distal, occlusal-gingival, torque, angulation, and rotation absolute mean discrepancy measurements (p>0.05, Table 7).

TABLE 7
Comparison of Linear and Angular Absolute Mean Bracket Placement Discrepancies
Among ALD Groups Using Kruskal-Wallis and Pairwise Comparison at α = 0.05

| | Group 1 | Group 2 | Group 3 | |
|---|---|---|---|---|
| Dimension | Mean ± SD | Mean ± SD | Mean ± SD | p-value |
| Mesial-Distal (mm) | 0.0586 ± 0.105 | 0.0586 ± 0.143 | 0.0664 ± 0.134 | 0.167 |
| Facial-Lingual (mm) | 0.118 ± 0.182^{a} | 0.103 ± 0.147^{a, b} | 0.107 ± 0.236^{b} | 0.014* |
| Occlusal-Gingival (mm) | 0.0726 ± 0.137 | 0.102 ± 0.126 | 0.0916 ± 0.123 | 0.223 |
| Torque (°) | 1.91 ± 2.17 | 1.72 ± 1.95 | 1.82 ± 2.13 | 0.601 |
| Angulation (°) | 1.52 ± 1.31 | 1.65 ± 1.93 | 1.38 ± 1.62 | 0.079 |
| Rotation (°) | 1.05 ± 1.01 | 1.23 ± 1.74 | 1.12 ± 1.10 | 0.987 |

Group 1: ALD <3 mm; Group 2: 3 ≤ ALD < 6 mm; Group 3: ALD ≥ 6 mm
^{a, b}Letters denote statistically significant differences among groups. Matching letters denote groups with no statistically significant differences.

Comparing absolute linear and angular mean discrepancies among Incisor, Premolar, Canine, and Molar groups using the Kruskal-Wallis test, statistically significant differences were found in the facial-lingual and torque dimensions (Table 8). The Canine group had a statistically significantly higher absolute mean difference in the facial-lingual dimension compared to the incisor group (p=0.011, Table 8). Additionally, the Molar group had a statistically significantly higher absolute mean difference in torque compared to the Premolar group (p=0.013, Table 8).

TABLE 8
Comparison of Linear and Angular Absolute Mean Bracket Placement Discrepancies
Among Tooth Types using Kruskal-Wallis and Pairwise Comparison at α = 0.05

| | Incisor (n = 112) | Canine (n = 59) | Premolar (n = 118) | Molar (n = 113) | |
|---|---|---|---|---|---|
| Dimension | Mean ± SD | Mean ± SD | Mean ± SD | Mean ± SD | p-value |
| Mesial-Distal (mm) | 0.0457 ± 0.0421 | 0.0517 ± 0.103 | 0.0482 ± 0.0731 | 0.0995 ± 0.209 | 0.056 |
| Facial-Lingual (mm) | 0.0727 ± 0.0628^{a} | 0.133 ± 0.157^{b} | 0.103 ± 0.140^{a, b} | 0.140 ± 0.299^{a, b} | 0.011* |
| Occlusal-Gingival (mm) | 0.0685 ± 0.0832 | 0.0706 ± 0.102 | 0.0762 ± 0.0773 | 0.131 ± 0.198 | 0.085 |
| Torque (°) | 1.69 ± 1.83^{a, b} | 1.67 ± 1.35^{a, b} | 1.32 ± 123^{a} | 2.53 ± 2.98^{b} | 0.013* |
| Angulation (°) | 1.40 ± 1.46 | 1.16 ± 0.980 | 1.36 ± 1.49 | 1.38 ± 1.62 | 0.166 |
| Rotation (°) | 0.993 ± 0.966 | 1.19 ± 0.939 | 1.12 ± 1.11 | 1.26 ± 1.90 | 0.227 |

^{a, b}Letters denote statistically significant differences among groups. Matching letters denote groups with no statistically significant differences.

The Wilcoxon signed-rank test showed statistically significant differences between planned (control) bracket positions and actual (experimental) bracket positions for linear measurements in all dimensions (p<0.001). While statistical significance was observed, the prevalence of brackets meeting clinically acceptable standards remained very high. American Board of Orthodontics standards set by the Cast-Radiograph Evaluation instrument state that 0.5 mm of linear variance and 2° of angular variance do not produce clinically significant alterations in tooth position. It is generally accepted that 2° of angular variance produces 0.5 mm of marginal ridge height discrepancy, thereby leading to selection of these thresholds. In this example, it was observed that a minimum of 98% of brackets examined were clinically acceptable in the linear dimensions (Table 4). Examining the angular dimensions, in contrast, 71.4% of brackets were clinically acceptable for torque, 77.4% for angulation, and 85.6% for rotation (Table 4). Overall, the prevalence of clinically acceptable brackets was actually higher than was seen in several previous studies on IDB, and comparable to one example by Schmid, et al.

Considering trends noted in the directionality of bracket discrepancy, this example found a predilection towards brackets that were left on the facial surface of the tooth (distal on teeth from the right side of the model, mesial on the left side), lingualized, and gingival. Based on the digitized adaptation of the brackets in the bracket placement portion of the program, it appears logical that the actual brackets may adapt more closely to the tooth's surface and therefore appear to be more “lingual” in the data, meaning more flush to the tooth's surface as the bracket cannot physically penetrate the facial surface, compared to its digital adaptation. Some imperfections were also noted during the phase of the project involving bracket placement and adaptation in the Blender plug-in used to design the guides, further supporting the possibility that the brackets would naturally adapt better in vitro than digitally. When considering the nearly 80% prevalence of brackets that were more gingival than planned, it may be due to excessive occlusal-gingival force to attempt to fully seat the experimental bracket into their position in the guide thereby causing some over-seating or flexure in the guide itself. In the angular dimensions, angulation and rotation discrepancies were nearly evenly split in directionality (Table 5). Torque, however, was predominantly skewed towards buccal root torque (or lingual crown torque). The more lingual placement of brackets certainly may contribute to this discrepancy as well. As the brackets were bonded in a way to extrude excess cement to the occlusal with the gingival portion of the bracket base contacting the facial height of contour first, it is possible that pressure on the facial could have decreased from gingival to occlusal, leading to a larger amount of cement remaining at the occlusal and further contributing to the lingual crown torque observed in 66.4% of the brackets (Table 5). This directional bias is consistent with previous studies on digital indirect bonding (dIDB) and traditional indirect bonding (IDB). The use of pre-coated brackets may reduce irregularities in cement thickness.

It was also noted during the bonding procedure that the brackets used in this project did not adapt well to the curvature exhibited by the teeth, especially regarding those teeth with curved facial surfaces-canines, premolars, and molars. This could also account for some of the discrepancy observed in both linear and angular dimensions, as well as the bond failure rate of 4% that was observed. Consideration should be given to irregularities in bracket size and shape, and general manufacturing tolerances. Some molar brackets were noted to be slightly irregular in size during the bonding procedure. Attempts were made to eliminate these irregular brackets from the sample and swap out for those appearing more consistent in size and shape prior to bonding, however it does call into question those types of irregularities that may not be caught with the naked eye but can impact the bonding.

It is challenging to directly compare the results of this example to those of previous studies, as the novel 3D-printed guide used in this project is a device with a proprietary design. A single, recent example by Xue, et al. investigated a computer-aided manufacturing-guided bonding device with similar aims as this example. The novel design of the bonding guide theoretically combines the accuracy of dIDB with the benefits of direct bonding, including ease of visualization of proper bracket seating within the device, adjustability of bracket position intraoperatively, and ease of removal of excess cement and of the device itself. The splint used in the Xue et al. example contacted the occlusal portion of every tooth and only two sides of each bracket, the distal and occlusal aspects. The device did not contact the facial aspect of the tooth as the guide used in this example did. Similar to this example, Xue et al. found statistical significance, but not clinical significance with the exception of torque in the angular dimension. Directional biases were present, but due to differences in the method of guide seating and stabilization, it is not indicated to compare the biases found with those of this example.

Effect of Arch Length Discrepancy on Bracket Placement Accuracy. Kruskal-Wallis and pairwise comparisons among the absolute means of ALD groups revealed a statistically significant difference in linear absolute mean discrepancy in the facial-lingual dimension. The least crowded groups, Group 1, had a statistically significantly higher absolute mean discrepancy compared to the most crowded group, Group 3 (p=0.014, Table 7). Group 1 had a mean facial-lingual bracket discrepancy of 0.118±0.182 mm, while Group 3 had a mean bracket discrepancy 0.107±0.236 mm (Table 7). These values are statistically significant; however they do not meet the 0.5 mm threshold of clinically significance. No other statistically significant discrepancies were found in any linear or angular dimension. These findings are consistent with the only known previous example regarding the effects of ALD on bonding accuracy with dIDB. Further research investigating the relationship between T1 dental crowding and bonding accuracy using digital bracket placement are indicated. No studies have been found that investigated the effects of ALD on bracket placement accuracy using a direct bonding guide in the manner this example did.

Statistically significant differences were found among tooth type groups in one linear and one angular dimension (Table 7). While statistically significant differences were noted in the facial-lingual dimension between the incisor and canine, these differences were not of clinical significance. The range among all absolute means in the linear dimension was 0.04 mm to a maximum of 0.14 mm+0.29 mm (Table 7), well below the clinically acceptable standard of 0.5 mm. In the angular dimension, statistically significant differences were noted between premolar and molar torque (Table 7). In contrast to the linear dimensions, some potential clinical significance may be noted in molar torque, as the absolute molar mean was 2.53°+2.98° (Table 7).

While the molar group had the highest levels of discrepancy in torque, measurements in all other angular and linear dimensions were similar. This is in contrast to some previous studies on indirect bonding, but in agreement with the results of Niu et al., who examined bonding accuracy using 3D printed IDB trays. To understand the potential clinical significance of any torque discrepancy, the role of torque and torque expression in bracket systems are further discussed. Torque expression that is achieved in a straight-wire bracket system clinically depends on the amount of torsional play or “slop” that is present in the interaction between wire and bracket. In the preadjusted appliance, archwires never completely fill the slot and are manufactured with slightly rounded or beveled edges to reduce friction in the system and allow for practicalities such as the ability to engage the wire properly. While these factors lead to ease of use and decreased friction in the system, they also allow for unintended movement of the wire within the bracket slot and loss of expression of torque and variability bracket and wire contact. For example, in 0.022″ bracket slots, the largest archwire typically measures 0.021″×0.025″. This size archwire results in less torsional play, ranging from 4.07° to 8.6° compared to the commonly used, but smaller, 0.019″×0.025″ archwire which exhibited torsional play ranging from 10.7° to 16.9° depending on appliance and wire manufacturer. Being that the mean discrepancy in molar torque in this example was 2.53°+2.98° (Table 7), considerably less than that observed in standard bracket and wire interactions, it may be considered not of clinical significance. This example used a bracket and wire system with a new bracket and slot design referred to as “wedgewise” with different geometry than traditionally used edgewise or straight-wire appliances, of which torsional play or “slop” has not been studied.

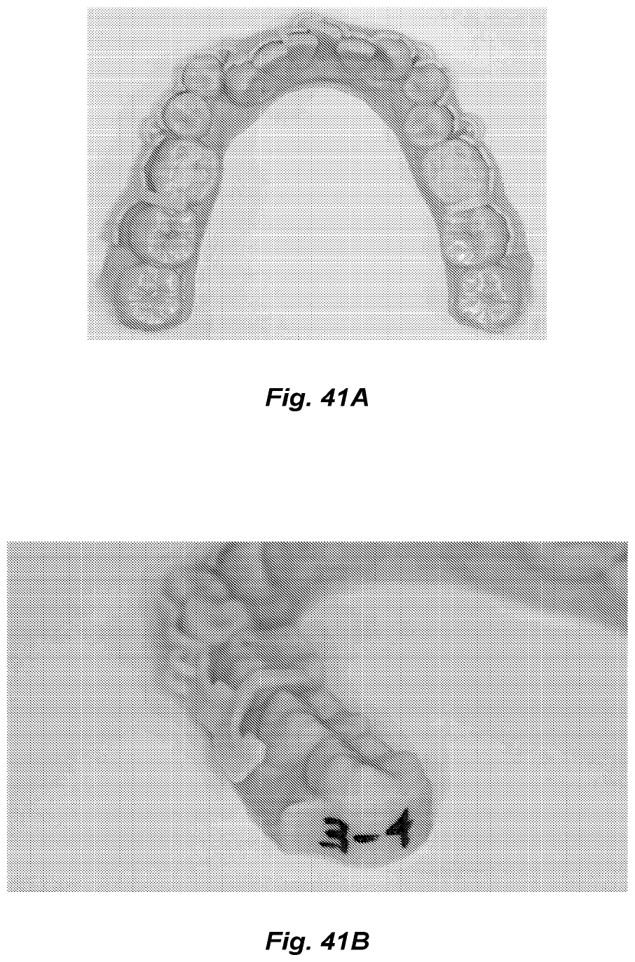

Additionally, it should be noted that some repeated issues with guide fit and adaptation were recorded during this project, an example of which is seen in FIGS. 41A and 41B. The first issue affected only a small number of teeth, most commonly in the molar region, where the guide slot was slightly too small for the bracket to properly seat. The second issue was poor posterior adaptation or bowing out of the guide, which affected 36% of models to varying degrees. While attempts were made to replicate the same occlusal pressure on each guide and occlusal rest during bracket placement and bonding, some error in the posterior buccal segments may be accounted for due to fit or adaptation issues with the guides. It should also be noted that poor posterior adaptation did not appear to impact the accuracy of the anterior segments statistically or clinically. The lack of clinical significance in mean discrepancies may be observed as an indicator that adequate occlusal pressure on rests during bracket placement may be enough to offset any issues with posterior adaptation.

Statistically significant differences were found between digitally planned and experimental bracket positions in the linear dimensions. No statistically significant differences were found in the angular dimensions. In linear dimensions, more than 98% of brackets examined were clinically acceptable. In angular dimensions, 85.6% of brackets were clinically acceptable in rotation, 77.4% for angulation, and 71.4% for torque. Dental crowding had no significant impact on bracket placement accuracy using the novel bonding guide. Finally, tooth type had no significant clinical impact on the accuracy of bracket placement using the novel bonding guide design when torsional play was taken into consideration. This novel bonding technique generally produced high positional accuracy.

As shown above, the systems described herein can be implemented using a variety of computer systems and networks. The following illustrates an example configuration of a computing device such as those described herein. The computing device may include one or more processors, a random access memory (RAM), communication interfaces, a display device, other input/output (I/O) devices (for example, keyboard, trackball, and the like), and one or more mass storage devices (for example, optical drive (for example, CD, DVD, or the like), disk drive, solid state disk drive, non-volatile memory express (NVME) drive, or the like), configured to communicate with each other, such as via one or more system buses or other suitable connections. While a single system bus 514 is illustrated for ease of understanding, it should be understood that the system buses 514 may include multiple buses, such as a memory device bus, a storage device bus (for example, serial advanced technology attachment (SATA) and the like), data buses (for example, universal serial bus (USB) and the like), video signal buses (for example, THUNDERBOLT, digital video interactive (DVI), high definition multimedia interface (HDMI), and the like), power buses, and so on.

Such CPUs are hardware devices that may include a single processing unit or a number of processing units, all of which may include single or multiple computing units or multiple cores. Such a CPU may include a graphics processing unit (GPU) that is integrated into the CPU or the GPU may be a separate processor device. The CPU may be implemented as one or more microprocessors, microcomputers, microcontrollers, digital signal processors, central processing units, graphics processing units, state machines, logic circuitries, and/or any devices that manipulate signals based on operational instructions. Among other capabilities, the CPU may be configured to fetch and execute computer-readable instructions stored in a memory, mass storage device, or other computer-readable storage media.

Memory and mass storage devices are examples of computer storage media (for example, memory storage devices) for storing instructions that can be executed by the processors 502 to perform the various functions described herein. For example, memory can include both volatile memory and non-volatile memory (for example, RAM, ROM, or the like) devices. Further, mass storage devices may include hard disk drives, solid-state drives, removable media, including external and removable drives, memory cards, flash memory, floppy disks, optical disks (for example, CD, DVD, and the like), a storage array, a network attached storage, a storage area network, or the like. Both memory and mass storage devices may be collectively referred to as memory or computer storage media herein and may be any type of non-transitory media capable of storing computer-readable, processor-executable program instructions as computer program code that can be executed by the processors as a particular machine configured for conducting the operations and functions described in the implementations herein.

The computing device may include one or more communication interfaces for exchanging data via a network. The communication interfaces can facilitate communications within a wide variety of networks and protocol types, including wired networks and wireless networks. Communication interfaces can also provide communication with external storage, such as a storage array, network attached storage, storage area network, cloud storage, or the like.

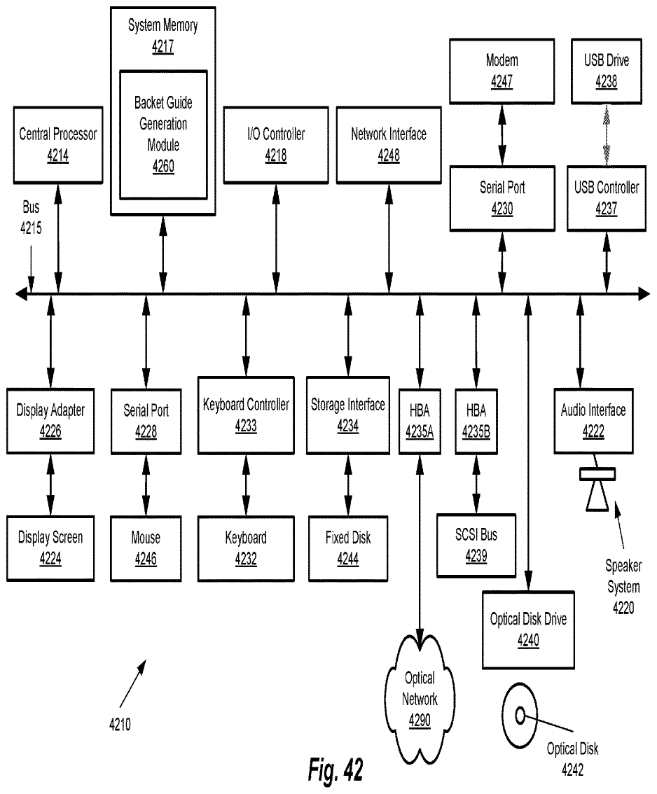

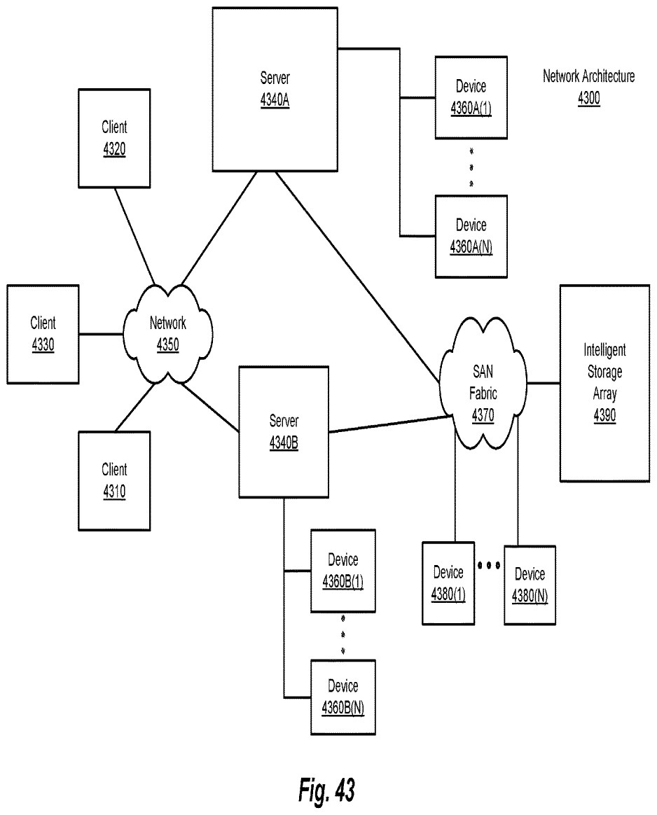

The display device may be used for displaying content (for example, information and images) to users. Other I/O devices may be devices that receive various inputs from a user and provide various outputs to the user, and may include a keyboard, a touchpad, a mouse, a printer, audio input/output devices, virtual- or augmented-reality displays, and so forth. The computer storage media, such as memory 504 and mass storage devices, may be used to store software and data, such as, for example, an operating system, one or more drivers (for example, including a video driver for a display such as display 180), one or more applications, and data. Examples of such computing and network environments are described below with reference to FIGS. 42 and 43.

FIG. 42 depicts a block diagram of a computer system 4210 suitable for implementing aspects of the systems described herein, and so can be viewed as an example of a computing device supporting a microservice production management server, for example. Computer system 4210 includes a bus 4212 which interconnects major subsystems of computer system 4210, such as a central processor 4214, a system memory 4217 (typically RAM, but which may also include ROM, RAM, or the like), an input/output controller 4218, an external audio device, such as a speaker system 4220 via an audio output interface 4222, an external device, such as a display screen 4224 via display adapter 4226 (and so capable of presenting microservice dependency visualization data such as microservice dependency visualization data 225 as visualization 1000 in FIG. 10), serial ports 4228 and 4230, a keyboard 4232 (interfaced with a keyboard controller 4233), a storage interface 4234, a USB controller 4237 operative to receive a USB drive 4238, a host bus adapter (HBA) interface card 4235A operative to connect with an optical network 4290, a host bus adapter (HBA) interface card 4235B operative to connect to a SCSI bus 4239, and an optical disk drive 4240 operative to receive an optical disk 4242. Also included are a mouse 4246 (or other point-and-click device, coupled to bus 4212 via serial port 4228), a modem 4247 (coupled to bus 4212 via serial port 4230), and a network interface 4248 (coupled directly to bus 4212).

Bus 4212 allows data communication between central processor 4214 and system memory 4217, which may include read-only memory (ROM) or flash memory (neither shown), and random access memory (RAM) (not shown), as previously noted. RAM is generally the main memory into which the operating system and application programs are loaded. The ROM or flash memory can contain, among other code, the Basic Input-Output System (BIOS) which controls basic hardware operation such as the interaction with peripheral components. Applications resident with computer system 4210 are generally stored on and accessed from a computer-readable storage medium, such as a hard disk drive (for example, fixed disk 4244), an optical drive (for example, optical drive 4240), a universal serial bus (USB) controller 4237, or other computer-readable storage medium.

Storage interface 4234, as with the other storage interfaces of computer system 4210, can connect to a standard computer-readable medium for storage and/or retrieval of information, such as a fixed disk drive 4244. Fixed disk drive 4244 may be a part of computer system 4210 or may be separate and accessed through other interface systems. Modem 4247 may provide a direct connection to a remote server via a telephone link or to the Internet via an internet service provider (ISP). Network interface 4248 may provide a direct connection to a remote server via a direct network link to the Internet via a POP (point of presence). Network interface 4248 may provide such connection using wireless techniques, including digital cellular telephone connection, Cellular Digital Packet Data (CDPD) connection, digital satellite data connection or the like.

Many other devices or subsystems (not shown) may be connected in a similar manner (for example, document scanners, digital cameras and so on). Conversely, all of the devices shown in FIG. 42 need not be present to practice the systems described herein. The devices and subsystems can be interconnected in different ways from that shown in FIG. 42. The operation of a computer system such as that shown in FIG. 42 is readily known in the art and is not discussed in detail in this application. Code to implement portions of the systems described herein can be stored in computer-readable storage media such as one or more of system memory 4217, fixed disk 4244, optical disk 4242, or USB drive 4238. The operating system provided on computer system 4210 may be WINDOWS, UNIX, LINUX, IOS, or another operating system. To this end, system memory 4217 is depicted in FIG. 42 as executing a bracket guide generation module 4260, in the manner of the methods and systems discussed previously herein, for example.

Moreover, regarding the signals described herein, those skilled in the art will recognize that a signal can be directly transmitted from a first block to a second block, or a signal can be modified (for example, amplified, attenuated, delayed, latched, buffered, inverted, filtered, or otherwise modified) between the blocks. Although the signals of the above-described embodiment are characterized as transmitted from one block to the next, other embodiments may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (for example, there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 43 is a block diagram depicting a network architecture 4300 in which client systems 4310, 4320 and 4330, as well as storage servers 4340A and 4340B (any of which can be implemented using computer system 4310), are coupled to a network 4350. Storage server 4340A is further depicted as having storage devices 4360A(1)-(N) directly attached, and storage server 4340B is depicted with storage devices 4360B(1)-(N) directly attached. Storage servers 4340A and 4340B are also connected to a storage area network (SAN) fabric 4370, although connection to a storage area network is not required for operation. SAN fabric 4370 supports access to storage devices 4380(1)-(N) by storage servers 4340A and 4340B, and so by client systems 4310, 4320 and 4330 via network 4350. An intelligent storage array 4390 is also shown as an example of a specific storage device accessible via SAN fabric 4370.

With reference to computer system 4210, modem 4247, network interface 4248 or some other method can be used to provide connectivity from each of client computer systems 4310, 4320 and 4330 to network 4350. Client systems 4310, 4320 and 4330 are able to access information on storage server 4340A or 4340B using, for example, a web browser or other client software (not shown). Such a client allows client systems 4310, 4320 and 4330 to access data hosted by storage server 4340A or 4340B or one of storage devices 4360A(1)-(N), 4360B(1)-(N), 4380(1)-(N) or intelligent storage array 4390. FIG. 43 depicts the use of a network such as the Internet for exchanging data, but the systems described herein are not limited to the Internet or any particular network-based environment.

The example systems and computing devices described herein are well adapted to attain the advantages mentioned as well as others inherent therein. While such systems have been depicted, described, and are defined by reference to particular descriptions, such references do not imply a limitation on the claims, and no such limitation is to be inferred. The systems described herein are capable of considerable modification, alteration, and equivalents in form and function, as will occur to those ordinarily skilled in the pertinent arts in considering the present disclosure. The depicted and described embodiments are examples only, and are in no way exhaustive of the scope of the claims.

Certain examples include computing systems with one or more processors; and computer-readable storage media coupled to the one or more processors. The computer-readable storage media contains program instructions, which, when executed by the one or more processors, perform the methods described herein. For example, the method performed can include placing a bracket model on a tooth object of a dentition model, generating a bracket guide foundation volume such that the generating exposes at least a portion of the bracket model, and producing a physical bracket guide based, at least in part, on the bracket guide foundation volume. The method performed further can include generating a bracket guide using the bracket guide foundation volume, wherein the generating the bracket guide produces a bracket guide volume, the physical bracket guide is produced based, at least in part, on the bracket guide volume, and the bracket guide volume comprises the bracket guide foundation volume. The method performed further can include the generating the bracket guide foundation volume. This step of defining the bracket guide foundation volume can include generating a gingival surface of the bracket guide foundation volume, and generating an occlusal surface of the bracket guide foundation volume. The gingival surface can be generated based, at least in part, on the dentition model. The gingival surface can be situated between a peak occlusal point of the tooth object and a base of the dentition model. The occlusal surface can be generated based, at least in part, on the dentition model. The occlusal surface can be situated between the gingival surface and the peak occlusal point of the tooth object. The method performed can include producing a manifold dentition model. Producing of the manifold dentition model can include rectifying one or more non-manifold features. In some examples, the bracket model is a bracket model copy. In some examples, the physical bracket guide is produced using a three-dimensional printing process. In some examples, the gingival surface lies between the base of the dentition model and a gumline of the dentition model. The method performed can include the step of generating that exposes the at least the portion of the bracket model by virtue of the generating the bracket guide foundation volume. Generating the bracket guide foundation volume can include removing a bracket model volume from the bracket guide foundation volume. In some examples, the bracket model volume is representative of a volume of the bracket model. The method performed can include the step of generating that further includes generating an inflated dentition model. In some examples, the step of generating the inflated dentition model at least in part includes performance of an inflation operation on the dentition model. In some examples, the step of generating can include identifying the tooth object; and placing a facial axis marker on a facial surface of the tooth object. Placing the facial axis marker can include determining a facial axis of the tooth object; determining a facial axis point for the tooth object using the facial axis; locating a facial axis marker at the facial axis point; and aligning and orientation of the facial axis marker with the facial surface of the tooth object. Placing the facial axis marker can include manually adjusting a position of the facial axis marker.

Such example systems and computing devices are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (for example, fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (for example, CPUs or processors). The program code can be stored in one or more computer-readable memory devices or other computer storage devices. Thus, the processes, components and modules described herein may be implemented by a computer program product.

The foregoing thus describes embodiments including components contained within other components (for example, the various elements shown as components of computer system 4310). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation. As such, the various embodiments of the systems described herein via the use of block diagrams, flowcharts, and examples. It will be understood by those within the art that each block diagram component, flowchart step, operation and/or component illustrated by the use of examples can be implemented (individually and/or collectively) by a wide range of hardware, software, firmware, or any combination thereof.

The systems described herein have been described in the context of fully functional computer systems; however, those skilled in the art will appreciate that the systems described herein are capable of being distributed as a program product in a variety of forms, and that the systems described herein apply equally regardless of the particular type of computer-readable media used to actually conduct the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (for example, RAM, ROM, and flash-type media), optical discs (for example, CD-ROMs, CD-Rs, and DVDs), or other types of memory modules. A storage device used for storing firmware or hardware modules in accordance with an embodiment can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

In light of the foregoing, it will be appreciated that the foregoing descriptions are intended to be illustrative and should not be taken to be limiting. As will be appreciated in light of the present disclosure, other embodiments are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the claims. Variations and modifications of the embodiments disclosed herein can be made based on the description set forth herein, without departing from the scope of the claims, giving full cognizance to equivalents thereto in all respects.

Although the present disclosure has been described in connection with several embodiments, any specific aspect of an embodiment is not intended to be limited to the specific forms set forth herein. On the contrary, it is intended to cover such alternatives, modifications, and equivalents as can be reasonably included within the scope of the various embodiments as defined by the appended claims.

What is claimed is:

1. A method of producing a bracket guide, the method comprising:
placing a bracket model on a tooth object of a dentition model;
generating a bracket guide foundation volume such that the generating exposes at least a portion of the bracket model; and
producing a physical bracket guide based, at least in part, on the bracket guide foundation volume.

2. The method of claim 1, wherein the generating the bracket guide foundation volume comprises:
generating a gingival surface of the bracket guide foundation volume, and
generating an occlusal surface of the bracket guide foundation volume.

3. The method of claim 2, further comprising:
producing a manifold dentition model, the producing of the manifold dentition model comprising rectifying one or more non-manifold features.

4. The method of claim 2, wherein
the generating of the gingival surface is based, at least in part, on the dentition model, the gingival surface is situated between a peak occlusal point of the tooth object and a base of the dentition model, and
the generating of the occlusal surface is based, at least in part, on the dentition model, and
the occlusal surface is situated between the gingival surface and the peak occlusal point of the tooth object.

5. The method of claim 4, wherein
the gingival surface lies between the base of the dentition model and a gumline of the dentition model.

6. The method of claim 1, wherein the generating exposes the at least a portion of the bracket model by virtue of the generating the bracket guide foundation volume comprises:
removing a bracket model volume from the bracket guide foundation volume, the bracket model volume representative of a volume of the bracket model.

7. The method of claim 1, wherein the generating further comprises:
generating an inflated dentition model, the generating of the inflated dentition model at least in part comprising performance of an inflation operation on the dentition model.

8. The method of claim 1, wherein the generating further comprises:
identifying the tooth object; and
placing a facial axis marker on a facial surface of the tooth object.

9. The method of claim 8, wherein the placing the facial axis marker comprises:
determining a facial axis of the tooth object;
determining a facial axis point for the tooth object using the facial axis;
locating a facial axis marker at the facial axis point; and
aligning and orientation of the facial axis marker with the facial surface of the tooth object.

10. The method of claim 9, wherein the placing the facial axis marker further comprises:
manually adjusting a position of the facial axis marker.

11. The method of claim 1, wherein the bracket model comprises a bracket model copy and the producing the physical bracket guide includes using a three-dimensional printing process.

12. A non-transitory computer-readable storage medium, comprising program instructions, which, when executed by one or more processors of a computing system, perform a method comprising:
placing a bracket model on a tooth object of a dentition model;
generating a bracket guide foundation volume such that the generating exposes at least a portion of the bracket model; and
producing a physical bracket guide based, at least in part, on the bracket guide foundation volume.

13. The non-transitory computer-readable storage medium of claim 12, wherein the method further comprises:
generating a bracket guide using the bracket guide foundation volume, wherein
the generating the bracket guide produces a bracket guide volume,
the physical bracket guide is produced based, at least in part, on the bracket guide volume, and
the bracket guide volume comprises the bracket guide foundation volume.

14. The non-transitory computer-readable storage medium of claim 13, wherein the generating the bracket guide foundation volume comprises:
defining a bracket guide foundation volume, wherein
the defining the bracket guide foundation volume comprises
generating a gingival surface of the bracket guide foundation volume, and
generating an occlusal surface of the bracket guide foundation volume,
the gingival surface is generated based, at least in part, on the dentition model,
the gingival surface is situated between a peak occlusal point of the tooth object and a base of the dentition model,
the occlusal surface is generated based, at least in part, on the dentition model, and
the occlusal surface is situated between the gingival surface and the peak occlusal point of the tooth object.

15. The non-transitory computer-readable storage medium of claim 14, wherein the method further comprises:
producing a manifold dentition model, the producing of the manifold dentition model comprises
rectifying one or more non-manifold features, wherein
the bracket model is a bracket model copy, and
the physical bracket guide is produced using a three-dimensional printing process.

16. The non-transitory computer-readable storage medium of claim 15, wherein
the gingival surface lies between the base of the dentition model and a gumline of the dentition model.

17. The non-transitory computer-readable storage medium of claim 13, wherein the generating exposes the at least the portion of the bracket model by virtue of the generating the bracket guide foundation volume comprises:
removing a bracket model volume from the bracket guide foundation volume, the bracket model volume representative of a volume of the bracket model.

18. The non-transitory computer-readable storage medium of claim 13, wherein the generating further comprises:
generating an inflated dentition model, the generating of the inflated dentition model at least in part comprising performance of an inflation operation on the dentition model.

19. The non-transitory computer-readable storage medium of claim 13, wherein the generating further comprises:
identifying the tooth object; and
placing a facial axis marker on a facial surface of the tooth object.

20. The non-transitory computer-readable storage medium of claim 19, wherein the placing the facial axis marker comprises:
determining a facial axis of the tooth object;
determining a facial axis point for the tooth object using the facial axis;
locating a facial axis marker at the facial axis point; and
aligning and orientation of the facial axis marker with the facial surface of the tooth object.

21. The non-transitory computer-readable storage medium of claim 20, wherein the placing the facial axis marker further comprises:
manually adjusting a position of the facial axis marker.

22. The non-transitory computer-readable storage medium of claim 13, wherein the bracket model comprises a bracket model copy and the producing the physical bracket guide includes using a three-dimensional printing process.

23. A computing system comprising:
one or more processors; and
a computer-readable storage medium coupled to the one or more processors, comprising program instructions, which, when executed by the one or more processors, perform a method comprising:
placing a bracket model on a tooth object of a dentition model,
generating a bracket guide foundation volume such that the generating exposes at least a portion of the bracket model, and
producing a physical bracket guide based, at least in part, on the bracket guide foundation volume.

24. The computing system of claim 23, wherein the method further comprises:
generating a bracket guide using the bracket guide foundation volume, wherein
the generating the bracket guide produces a bracket guide volume,
the physical bracket guide is produced based, at least in part, on the bracket guide volume, and
the bracket guide volume comprises the bracket guide foundation volume.

25. The computing system of claim 23, wherein the generating the bracket guide foundation volume comprises:
defining the bracket guide foundation volume, wherein
the defining the bracket guide foundation volume comprises
generating a gingival surface of the bracket guide foundation volume, and
generating an occlusal surface of the bracket guide foundation volume,
the gingival surface is generated based, at least in part, on the dentition model,
the gingival surface is situated between a peak occlusal point of the tooth object and a base of the dentition model,
the occlusal surface is generated based, at least in part, on the dentition model, and
the occlusal surface is situated between the gingival surface and the peak occlusal point of the tooth object.

26. The computing system of claim 25, wherein the method further comprises:
producing a manifold dentition model, the producing of the manifold dentition model comprises rectifying one or more non-manifold features, wherein
the bracket model is a bracket model copy, and
the physical bracket guide is produced using a three-dimensional printing process.

27. The computing system of claim 26, wherein
the gingival surface lies between the base of the dentition model and a gumline of the dentition model.

28. The computing system of claim 24, wherein the generating exposes the at least the portion of the bracket model by virtue of the generating the bracket guide foundation volume comprises:
removing a bracket model volume from the bracket guide foundation volume, the bracket model volume representative of a volume of the bracket model.

29. The computing system of claim 24, wherein the generating further comprises:
generating an inflated dentition model, the generating of the inflated dentition model at least in part comprising performance of an inflation operation on the dentition model.

30. The computing system of claim 24, wherein the generating further comprises:
identifying the tooth object; and
placing a facial axis marker on a facial surface of the tooth object.

31. The computing system of claim 30, wherein the placing the facial axis marker comprises:
determining a facial axis of the tooth object;
determining a facial axis point for the tooth object using the facial axis;
locating a facial axis marker at the facial axis point; and
aligning and orientation of the facial axis marker with the facial surface of the tooth object.

32. The computing system of claim 31, wherein the placing the facial axis marker further comprises:
manually adjusting a position of the facial axis marker.

33. The computing system of claim 23, wherein the bracket model comprises a bracket model copy and the producing the physical bracket guide includes using a three-dimensional printing process.
